(19) United States
(12) Patent Application Publication
(10) Pub. No.: US 2026/0254944 A1
(43) Pub. Date: Aug. 27, 2026

(54) DECODING METHOD, ENCODING METHOD, DECODER, AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/643,125

(22) Filed: Apr. 9, 2026

Related U.S. Application Data
(63) Continuation of application No. PCT/CN2023/123647, filed on Oct. 9, 2023.

(51) Int. Cl. H04N 19/105; H04N 19/503; H04N 19/70

(52) U.S. Cl. CPC H04N 19/105; H04N 19/503; H04N 19/70

(57) ABSTRACT

A decoding method, an encoding method, a decoder, and a storage medium are provided. The decoding method is applied to a decoder and includes the following. A bitstream is parsed to determine first syntax element information of a current decoding unit in a current picture, where the first syntax element information indicates a type of the current decoding unit, and reference information of reference pictures corresponding to different types of decoding units are different. Prediction is performed on a current node based on the type of the current decoding unit indicated by the first syntax element information, to obtain an attribute prediction value of the current node.

### CROSS REFERENCE TO RELATED APPLICATION(S)

This application is a continuation of International Application No. PCT/CN2023/123647, filed Oct. 9, 2023, the entire disclosure of which is incorporated herein by reference.

### TECHNICAL FIELD

Embodiments of the disclosure relate to the field of point cloud compression technology, and in particular to a decoding method, an encoding method, a decoder, and a storage medium.

### BACKGROUND

In a geometry-based point cloud compression (G-PCC) coding framework or a video-based point cloud compression (V-PCC) coding framework provided in the moving picture experts group (MPEG), geometry information and attribute information of the point cloud are encoded separately.

Currently, encoding of the attribute information mainly aims at encoding of colour information. During encoding of the colour information, there are mainly two transform methods. One is a distance-based lifting transform (LT) which relies on level of detail (LOD) partitioning, and the other is a directly performed region adaptive hierarchical transform (RAHT).

However, in related solutions for RAHT attribute inter prediction coding, there is still a need to further improve accuracy of inter attribute prediction.

### SUMMARY

In a first aspect, a decoding method is provided in embodiments of the disclosure. The method is applied to a decoder, and the method includes the following. A bitstream is parsed to determine first syntax element information of a current decoding unit in a current picture, where the first syntax element information indicates a type of the current decoding unit, and reference information of reference pictures corresponding to different types of decoding units are different. Prediction is performed on a current node based on the type of the current decoding unit indicated by the first syntax element information, to obtain an attribute prediction value of the current node.

In a second aspect, an encoding method is provided in embodiments of the disclosure. The method is applied to an encoder, and the method includes the following. At least one reference list is determined based on index information of encoded pictures. Pre-estimation is performed based on the at least one reference list to determine a type of a current encoding unit in a current picture, and the type of the current encoding unit is indicated by first syntax element information. Prediction is performed on a current node based on the type of the current encoding unit, to obtain an attribute prediction value of the current node.

In a third aspect, a decoder is provided in embodiments of the disclosure. The decoder includes a decoding part and a first prediction part. The decoding part is configured to parse a bitstream to determine first syntax element information of a current decoding unit in a current picture, where the first syntax element information indicates a type of the current decoding unit, and reference information of reference pictures corresponding to different types of decoding units are different. The first prediction part is configured to perform prediction on a current node based on the type of the current decoding unit indicated by the first syntax element information, to obtain an attribute prediction value of the current node.

In a fourth aspect, a computer-readable storage medium is provided in embodiments of the disclosure. The computer-readable storage medium stores a computer program and a bitstream. When executed by a processor, the computer program causes the processor to perform the encoding method in the second aspect.

### BRIEF DESCRIPTION OF THE DRAWINGS

FIG. 1A is a schematic diagram of an exemplary three-dimensional (3D) point cloud picture provided in embodiments of the disclosure.

FIG. 1B is a partial enlarged view of an exemplary 3D point cloud picture provided in embodiments of the disclosure.

FIG. 2A is a schematic diagram illustrating exemplary six viewing angles of a point cloud picture provided in embodiments of the disclosure.

FIG. 2B is a schematic diagram of an exemplary data storage format of a point cloud picture provided in embodiments of the disclosure.

FIG. 3 is a schematic diagram of an exemplary network architecture of point cloud coding provided in embodiments of the disclosure.

FIG. 4A is a schematic diagram of an exemplary framework of a G-PCC encoder provided in embodiments of the disclosure.

FIG. 4B is a schematic diagram of an exemplary framework of a G-PCC decoder provided in embodiments of the disclosure.

FIG. 5A is a schematic diagram illustrating exemplary low plane positions in a z-axis direction provided in embodiments of the disclosure.

FIG. 5B is a schematic diagram illustrating exemplary high plane positions in a z-axis direction provided in embodiments of the disclosure.

FIG. 6 is a schematic diagram of an exemplary node encoding order provided in embodiments of the disclosure.

FIG. 7A is a schematic diagram of exemplary planar flag information provided in embodiments of the disclosure.

FIG. 7B is another schematic diagram of exemplary planar flag information provided in embodiments of the disclosure.

FIG. 8 is a schematic diagram of exemplary sibling nodes of a current node provided in embodiments of the disclosure.

FIG. 9 is a schematic diagram illustrating an exemplary intersection of a lidar with nodes provided in embodiments of the disclosure.

FIG. 10 is a schematic diagram of an exemplary neighbourhood node at the same partitioning depth and the same coordinate provided in embodiments of the disclosure.

FIG. 11A to FIG. 11C are schematic diagrams each illustrating an exemplary current node at a low plane position of a parent node provided in embodiments of the disclosure.

FIG. 12A to FIG. 12C are schematic diagrams each illustrating an exemplary current node at a high plane position of a parent node provided in embodiments of the disclosure.

FIG. 13 is a schematic diagram illustrating exemplary predictive coding of plane position information of a lidar point cloud provided in embodiments of the disclosure.

FIG. 14 is a schematic diagram illustrating exemplary IDCM coding provided in embodiments of the disclosure.

FIG. 15 is a schematic diagram illustrating exemplary coordinate transform of a point cloud obtained by a rotating lidar provided in embodiments of the disclosure.

FIG. 16 is a schematic diagram illustrating exemplary predictive coding in an x-axis or y-axis direction provided in embodiments of the disclosure.

FIG. 17A is a schematic diagram illustrating an exemplary y-planar angle predicted using a horizontal azimuth angle provided in embodiments of the disclosure.

FIG. 17B is a schematic diagram illustrating an exemplary x-planar angle predicted using a horizontal azimuth angle provided in embodiments of the disclosure.

FIG. 18 is another schematic diagram illustrating exemplary predictive coding in an x-axis or y-axis direction provided in embodiments of the disclosure.

FIG. 19A is a schematic diagram illustrating three vertices in an exemplary sub-block provided in embodiments of the disclosure.

FIG. 19B is a schematic diagram illustrating an exemplary triangle soup (trisoup) fitted using three vertices provided in embodiments of the disclosure.

FIG. 19C is a schematic diagram illustrating exemplary up-sampling of a trisoup provided in embodiments of the disclosure.

FIG. 20 is a schematic diagram illustrating exemplary distance-based LOD construction provided in embodiments of the disclosure.

FIG. 21 is a schematic diagram illustrating an exemplary visualization result of LOD generation provided in embodiments of the disclosure.

FIG. 22 is a schematic flowchart of exemplary attribute prediction coding provided in embodiments of the disclosure.

FIG. 23 is a schematic diagram of exemplary composition of a pyramid structure provided in embodiments of the disclosure.

FIG. 24 is another schematic diagram of exemplary composition of a pyramid structure provided in embodiments of the disclosure.

FIG. 25 is a schematic diagram of an exemplary LOD structure for inter-layer nearest-neighbour search provided in embodiments of the disclosure.

FIG. 26 is a schematic structural diagram illustrating exemplary nearest-neighbour search based on a spatial relationship provided in embodiments of the disclosure.

FIG. 27A is a schematic diagram illustrating an exemplary coplanar spatial relationship provided in embodiments of the disclosure.

FIG. 27B is a schematic diagram illustrating an exemplary coplanar or collinear spatial relationship provided in embodiments of the disclosure.

FIG. 27C is a schematic diagram illustrating an exemplary coplanar, collinear, or concurrent spatial relationship provided in embodiments of the disclosure.

FIG. 28 is a schematic diagram illustrating exemplary inter-layer prediction based on fast search provided in embodiments of the disclosure.

FIG. 29 is a schematic diagram of an exemplary LOD structure for attribute intra-layer nearest-neighbour search provided in embodiments of the disclosure.

FIG. 30 is a schematic diagram illustrating exemplary intra-layer prediction based on fast search provided in embodiments of the disclosure.

FIG. 31 is a schematic structural diagram illustrating exemplary block-based neighbourhood search provided in embodiments of the disclosure.

FIG. 32 is a schematic flowchart of exemplary lifting transform coding provided in embodiments of the disclosure.

FIG. 33 is a schematic structural diagram illustrating exemplary RAHT attribute transform coding provided in embodiments of the disclosure.

FIG. 34 is a schematic diagram illustrating exemplary RAHT transform along x, y, and z directions provided in embodiments of the disclosure.

FIG. 35A is a schematic diagram illustrating exemplary RAHT forward transform provided in embodiments of the disclosure.

FIG. 35B is a schematic diagram illustrating exemplary RAHT inverse transform provided in embodiments of the disclosure.

FIG. 36 is a schematic structural diagram of an exemplary attribute coding block provided in embodiments of the disclosure.

FIG. 37 is a schematic diagram of an exemplary overall process of RAHT attribute prediction transform coding provided in embodiments of the disclosure.

FIG. 38 is a schematic diagram illustrating an exemplary neighbourhood prediction relationship of a current block provided in embodiments of the disclosure.

FIG. 39 is a schematic diagram illustrating exemplary calculation of an attribute transform coefficient provided in embodiments of the disclosure.

FIG. 40 is a schematic flowchart of an encoding method provided in embodiments of the disclosure.

FIG. 41 is a first schematic diagram of an exemplary bidirectional decoding structure provided in embodiments of the disclosure.

FIG. 42 is a second schematic diagram of an exemplary bidirectional decoding structure provided in embodiments of the disclosure.

FIG. 43 is a third schematic diagram of an exemplary bidirectional decoding structure provided in embodiments of the disclosure.

FIG. 44 is a schematic flowchart illustrating implementation of a decoding method provided in embodiments of the disclosure.

FIG. 45 is a schematic diagram of a principle of bidirectional inter attribute prediction provided in embodiments of the disclosure.

FIG. 46 is a schematic diagram of an RAHT encoding layer provided in embodiments of the disclosure.

FIG. 47 is a first schematic structural diagram of a decoder provided in embodiments of the disclosure.

FIG. 48 is a first schematic structural diagram of an encoder provided in embodiments of the disclosure.

FIG. 49 is a second schematic structural diagram of a decoder provided in embodiments of the disclosure.

FIG. 50 is a second schematic structural diagram of an encoder provided in embodiments of the disclosure.

### DETAILED DESCRIPTION

To enable a more detailed understanding of features and technical content in embodiments of the disclosure, embodiments of the disclosure will be described in detail below in conjunction with the accompanying drawings, which are provided for illustrative purposes only and are not intended to limit embodiments of the disclosure.

Unless otherwise defined, all technical and scientific terms used herein have the same meaning as commonly understood by those skilled in the art. The terms used herein are for the purpose of describing embodiments of the disclosure only and are not intended to limit the disclosure.

In the following description, reference to “some embodiments” describes a subset of all possible embodiments, but it will be understood that “some embodiments” may refer to the same or different subsets of all possible embodiments and may be combined with each other without conflict.

It may be further noted that the terms “first/second/third” in embodiments of the disclosure are merely for distinguishing similar objects and do not imply a particular ordering with respect to the objects, and it will be understood that “first/second/third” may, where appropriate, be interchanged in a particular order or sequence such that embodiments of the disclosure described herein can be implemented in an order other than that illustrated or described herein.

Point cloud is a three-dimensional (3D) representation of the surface of an object. The point cloud (data) of the surface of the object can be collected by means of a collection device such as a photo radar, a lidar, a laser scanner, and a multi-view camera.

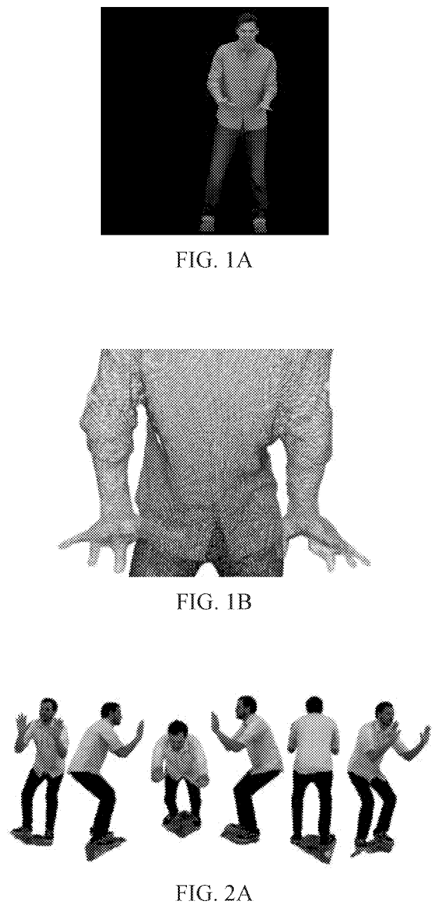

Point cloud is a collection of irregularly-distributed discrete points in space that represent the spatial structure and surface attributes of a 3D object or scene. FIG. 1A illustrates a 3D point cloud picture, and FIG. 1B is a partial enlarged view of a 3D point cloud picture. As can be seen, a surface of the point cloud is composed of densely-distributed points.

Since a two-dimensional picture has information representation at each pixel distributed regularly, position information thereof does not need to be recorded additionally. However, since points in the point cloud are distributed randomly and irregularly in 3D space, a position of each point in the space needs to be recorded, such that the point cloud can be represented completely. Similar to the two-dimensional picture, each position has corresponding attribute information in a collection process, that is, usually a red green blue (RGB) colour value. A colour value reflects a colour of an object. For the point cloud, in addition to colour information, the attribute information corresponding to each point often includes a reflectance value. The reflectance value reflects a surface material of an object. Therefore, point cloud data usually includes geometry information consisting of 3D position information and attribute information consisting of 3D colour information and one-dimensional reflectance information. A point in the point cloud may include both position information and attribute information of the point. For example, the position information of the point may be 3D coordinate information (x, y, z) of the point. The position information of the point may also be referred to as geometry information of the point. For example, the attribute information of the point may include colour information (3D colour information) and/or reflectance (one-dimensional reflectance information r), etc. For example, the colour information may be information on any colour space. For example, the colour information may be RGB information, where R represents red, G represents green, and B represents blue. Another example of the colour information may be luminance-chrominance (YCbCr, YUV) information, where Y represents brightness (Luma), Cb (U) represents blue chrominance, and Cr (V) represents red chrominance.

For a point cloud obtained based on laser measurement, a point in the point cloud may include 3D coordinate information of the point and a reflectance value of the point. For a point cloud obtained based on photogrammetry, a point in the point cloud may include 3D coordinate information of the point and 3D colour information of the point. For a point cloud obtained based on laser measurement and photogrammetry, a point in the point cloud may include the 3D coordinate information of the point, the reflectance value of the point, and the 3D colour information of the point.

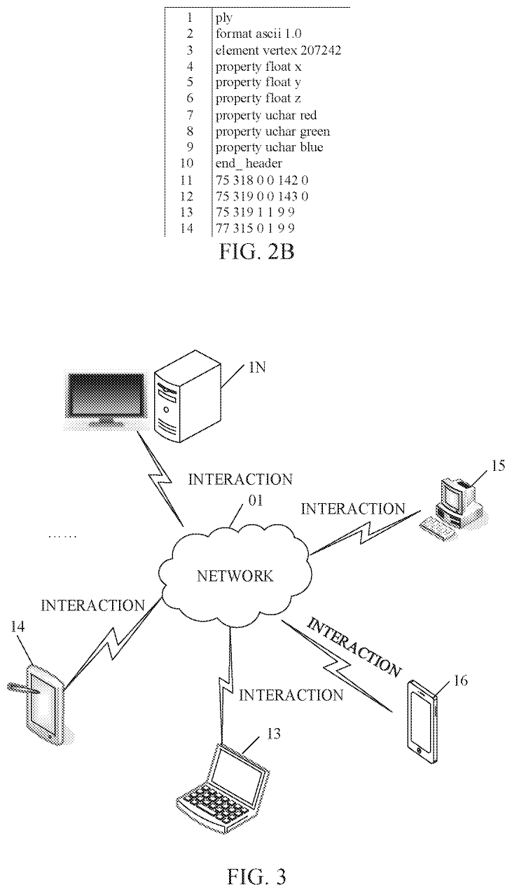

FIG. 2A and FIG. 2B illustrate a point cloud picture and a data storage format of the point cloud picture, respectively. FIG. 2A provides six viewing angles of the point cloud picture. FIG. 2B consists of header information and data. The header information contains a data format, a data representation type, the total point number of the point cloud, and the content represented by the point cloud. For example, the point cloud is in “.ply” format and represented by ASCII codes, with the total point number of 207242. Each point has 3D coordinate information (x, y, z) and 3D colour information (r, g, b).

Point clouds may be classified according to the obtaining manners as:
a static point cloud, i.e., the object is stationary and the point cloud obtaining device is also stationary;
a dynamic point cloud: the object is in motion, but the point cloud obtaining device is stationary; and
a dynamically-obtained point cloud: the point cloud obtaining device is in motion.

For example, point clouds may be classified into two main categories according to usage:
category 1: machine perception point cloud, which may be used in scenarios such as autonomous navigation systems, real-time inspection systems, geographic information systems, visual sorting robots, and rescue and disaster relief robots; and
category 2: human eye perception point cloud, which may be used in scenarios such as digital cultural heritage, free point-of-view broadcasting, 3D immersive communication, and 3D immersive interaction.

The point cloud can represent the spatial structure and surface attributes of the 3D object or scene in a flexible and convenient manner. In addition, since the point cloud is obtained by directly sampling a real object, which can exhibit an extremely realistic effect on the premise of ensuring precision, the point cloud has a wide range of application, including virtual reality games, computer-aided design, geographic information systems, autonomous navigation systems, digital cultural heritage, free point-of-view broadcasting, 3D immersive telepresence, 3D reconstruction of biological tissues and organs, and the like.

The point cloud may be mainly collected in the following ways: computer generation, 3D laser scanning, 3D photogrammetry, and the like. Point cloud of a virtual 3D object or scene may be generated by the computer. Point cloud of a 3D object or scene in a static real world may be obtained through 3D laser scanning, with millions of points obtained every second. Point cloud of a 3D object or scene in a dynamic real world may be obtained through 3D photogrammetry, with tens of millions of points obtained every second. These technologies have reduced the acquisition cost and the time period of point cloud data, and improved the precision of the data. The transformation of the method for acquiring point cloud data makes it possible to acquire a large amount of point cloud data. With an increase in application demand, the processing of massive 3D point cloud data is constrained by storage space and transmission bandwidth.

For example, a point cloud video has a frame rate of 30 frames per second (fps). The number (quantity) of points in each frame of point cloud is 700 thousand. Each point has coordinate information xyz (float) and colour information RGB (uchar). In this case, a 10 s point cloud video has a data volume of approximately 3.15 GB (0.7 million×(4 Byte×3+1 Byte×3)×30 fps×10 s=3.15 GB), where 1 Byte corresponds to 10 bit. For a 1280×720 two-dimensional video with a YUV sampling format of 4:2:0 and a frame rate of 24 fps, the data volume of the 10 s video is approximately 0.33 GB (1280×720×12 bit×24 fps×10 s>0.33 GB). A 10 s two-view 3D video has a data volume of approximately 0.66 GB (0.33×2=0.66 GB). As can be seen, the data volume of the point cloud video is much greater than the data volume of the two-dimensional video and the data volume of the 3D video with the same duration. Therefore, in order to better achieve data management, save storage space of a server, and reduce transmission traffic and transmission time between the server and a client, point cloud compression has become a key issue to promote the development of point cloud industry.

That is to say, since the point cloud is a collection of massive amounts of points, storing the point cloud not only consumes a lot of memory, but is not conducive to transmission. Also, there is no such large bandwidth available to support the transmission of the point cloud directly across the network layer without compression. Therefore, the point cloud needs to be compressed.

Currently, a point cloud coding framework that can compress the point cloud may be a geometry-based point cloud compression (G-PCC) coding framework or a video-based point cloud compression (V-PCC) coding framework provided in the moving picture experts group (MPEG), or may be the audio video standard (AVS)-PCC coding framework provided in the AVS. The G-PCC coding framework may be used for compression of the first-type static point cloud and the third-type dynamically-obtained point cloud, which may be based on test model compression 13 (TMC13). The V-PCC coding framework may be used for compression of the second-type dynamic point cloud, which may be based on test model compression 2 (TMC2). Therefore, the G-PCC coding framework is also known as the point cloud codec TMC13, and the V-PCC coding framework is also known as the point cloud codec TMC2.

A network architecture of a point cloud coding system including a decoding method and an encoding method is provided in embodiments of the disclosure. FIG. 3 is a schematic diagram of a network architecture of point cloud coding provided in embodiments of the disclosure. As illustrated in FIG. 3, the network architecture includes one or more electronic devices 13 to 1 N and a communication network 01. The electronic devices 13 to 1 N can perform video interaction through the communication network 01. The electronic device may be various types of devices having video coding functions during implementation. For example, the electronic device may include a mobile phone, a tablet computer, a personal computer, a personal digital assistant, a navigator, a digital phone, a video phone, a television, a sensing device, a server, etc., which is not limited in embodiments of the disclosure. The decoder or the encoder in embodiments of the disclosure may be the electronic device.

The electronic devices in embodiments of the disclosure have a point cloud coding function, and generally include a point cloud encoder (namely, an encoder) and a point cloud decoder (namely, a decoder).

The following will describe the related art by taking the G-PCC coding framework as an example.

It may be understood that, in a point cloud G-PCC coding framework, point cloud data to-be-encoded is first partitioned into multiple slices through slice partitioning. In each slice, geometry information of the point cloud and attribute information corresponding to each point are encoded separately.

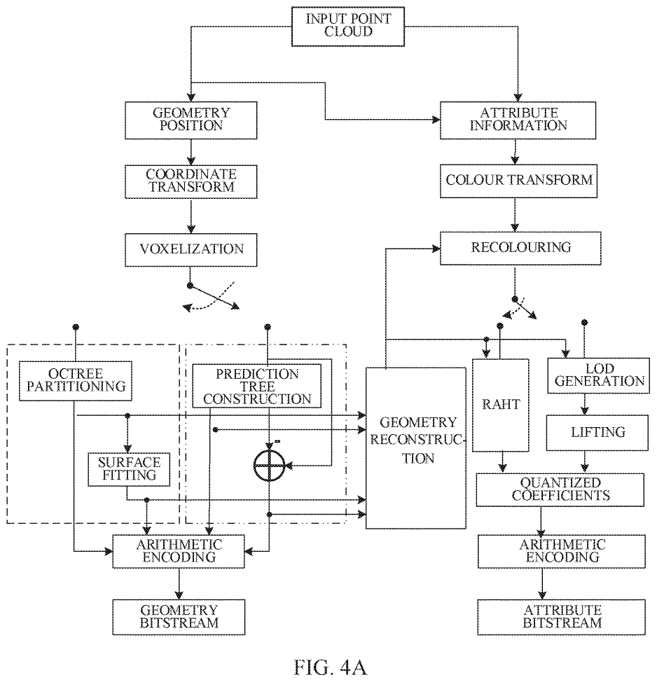

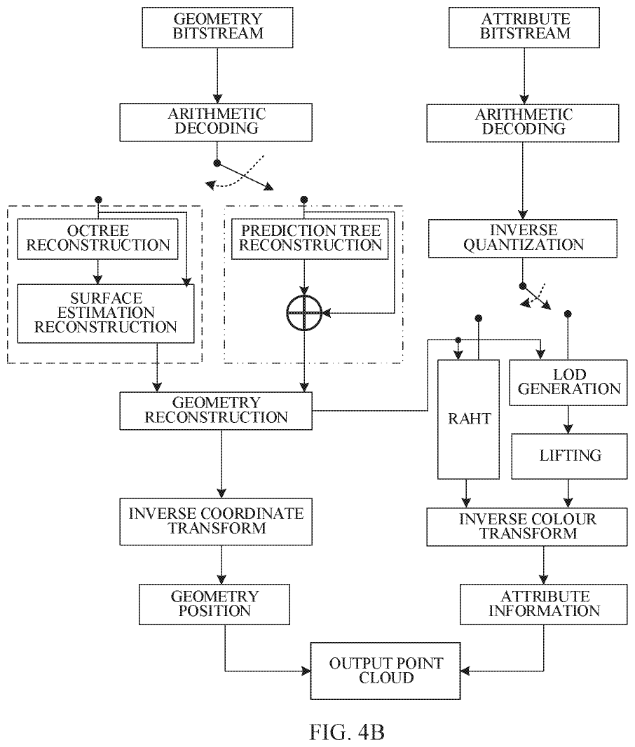

FIG. 4A is a schematic diagram of a framework of a G-PCC encoder. As illustrated in FIG. 4A, during geometry encoding, coordinate transform is performed on geometry information, such that the whole point cloud is contained in a bounding box. This is followed by quantization, which is mainly a scaling process. Due to rounding in the quantization, the geometry information of part of the point cloud is the same, and thus whether to remove duplicate points is determined based on parameters. The process of quantization and removal of the duplicate points is also referred to as voxelization. Next, octree partitioning or prediction tree construction is performed on the bounding box. In this process, arithmetic encoding is performed on points in leaf nodes obtained through partitioning, to generate a binary geometry bitstream, or arithmetic encoding (surface fitting based on vertices) is performed on vertices generated through partitioning, to generate a binary geometry bitstream. During attribute encoding, after the geometry encoding is completed and the geometry information is reconstructed, colour transform needs to be performed first, and colour information (namely, attribute information) is transformed from RGB colour space to YUV colour space. Then, the reconstructed geometry information is used to recolour the point cloud, such that the uncoded attribute information can correspond to the reconstructed geometry information. The attribute encoding is mainly performed on colour information. During encoding of the colour information, there are mainly two transform methods. One is distance-based lifting transform which relies on level of detail (LOD) partitioning, and the other is direct region adaptive hierarchical transform (RAHT), both of which transform the colour information from the spatial domain to the frequency domain to obtain high-frequency coefficients and low-frequency coefficients through transform, and finally quantize and encode the coefficients to generate the binary bitstream. Both methods make the colour information be transformed from the spatial domain to the frequency domain, to obtain a high-frequency coefficient and a low-frequency coefficient through transform. Finally, the coefficients are quantized, and then arithmetic encoding is performed on quantized coefficients to generate a binary attribute bitstream.

FIG. 4B is a schematic diagram of a framework of a G-PCC decoder. As illustrated in FIG. 4B, for an obtained binary bitstream, a geometry bitstream and an attribute bitstream in the binary bitstream are first decoded separately. During decoding of the geometry bitstream, geometry information of the point cloud is obtained through arithmetic decoding-octree reconstruction/prediction tree reconstruction-geometry reconstruction-inverse coordinate transform. During decoding of the attribute bitstream, attribute information of the point cloud is obtained through arithmetic decoding-inverse quantization-LOD partitioning/RAHT-inverse colour transform. Point cloud data to-be-encoded (i.e., output point cloud) is restored based on the geometry information and the attribute information.

It may be noted that as illustrated in FIG. 4A and FIG. 4B, currently, the G-PCC geometry coding may be octree geometry coding (indicated by a dashed box) or predictive geometry coding (indicated by a dash-dotted box).

The octree geometry encoding (OctGeomEnc) includes the following operations. First, coordinate transform is performed on geometry information, such that the whole point cloud is contained in a bounding box. This is followed by quantization, which is mainly a scaling process. Due to rounding in the quantization, some points have the same geometry information. Whether to remove duplicate points is determined based on parameters. The process of quantization and removal of the duplicate points is also referred to as voxelization. Next, tree (for example, octree, quadtree, and binary tree) partitioning is continuously performed on the bounding box in the order of breadth-first search, and an occupancy code of each node is encoded. In the related art, some company has proposed an implicit geometry partitioning method. First, a bounding box (2^{d}^{ₓ}, 2^{d}^{_{y}}, 2^{d}^{_{z}}) of the point cloud is calculated. It is assumed that dₓ>d_{y}>d_{z}, and this bounding box corresponds to a rectangular cuboid. During geometry partitioning, first, binary tree partitioning proceeds based on the x-axis to obtain two child nodes. Then, quadtree partitioning proceeds based on the x and y axes only when a condition dₓ=d_{y}>d_{z} is satisfied, to obtain four child nodes. Finally, when a condition dₓ=d_{y}=d_{z} is satisfied, octree partitioning proceeds until a resulting leaf node is 1×1×1 unit cube. Points in the leaf node are encoded to generate a binary bitstream. During binary tree/quadtree/octree-based partitioning, two parameters K and M are introduced. Parameter K indicates the maximum number of binary tree/quadtree partitions before octree partitioning. Parameter M indicates that a side length of a corresponding minimum block is 2^{M} during binary tree/quadtree partitioning. In addition, K and M need to satisfy the following conditions: assuming dₘₐₓ=max(dₓ,d_{y},d_{z}) and dₘᵢₙ=min(dₓ,d_{y},d_{z}), parameter K satisfies K≥dₘₐₓ−dₘᵢₙ, and parameter M satisfies M≥dₘᵢₙ. The reason why parameters K and M satisfy the above conditions is that during implicit geometry partitioning for G-PCC, the priority of the partitioning method is currently a binary tree, a quadtree, and an octree. Octree partitioning is continuously performed on a node only when the size of a node block does not satisfy conditions for the binary tree/quadtree, until a resulting leaf node reaches the minimum unit of 1×1×1. In an octree-based geometry information encoding mode, correlation between neighbouring points in space can be used for effectively encoding geometry information of the point cloud, and for some relatively flat nodes or nodes with planar characteristics, the encoding efficiency of the geometry information of the point cloud can be further improved through planar coding.

Exemplarily, FIG. 5A and FIG. 5B provide schematic diagrams illustrating plane positions, FIG. 5A is a schematic diagram illustrating low plane positions in a z-axis direction, and FIG. 5B is a schematic diagram illustrating high plane positions in a z-axis direction. As illustrated in FIG. 5A, (a), (a0), (a1), (a2), and (a3) herein all belong to the low plane positions in the z-axis direction. Taking (a) as an example, it can be seen that four occupied child nodes in a current node are all located at low plane positions of the current node in the z-axis direction, and in this case, it can be considered that the current node belongs to a z-plane and is at a low plane in the z-axis direction. Similarly, as illustrated in FIG. 5B, (b), (b0), (b1), (b2), and (b3) herein all belong to the high plane positions in the z-axis direction. Taking (b) as an example, it can be seen that four occupied child nodes in a current node are located at high plane positions of the current node in the z-axis direction, and in this case, it can be considered that the current node belongs to a z-plane and is at a high plane in the z-axis direction.

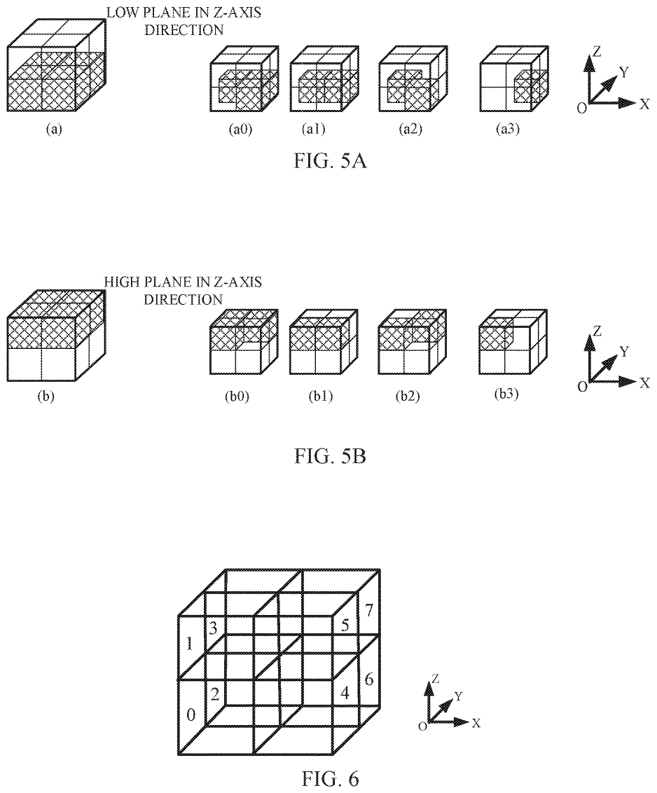

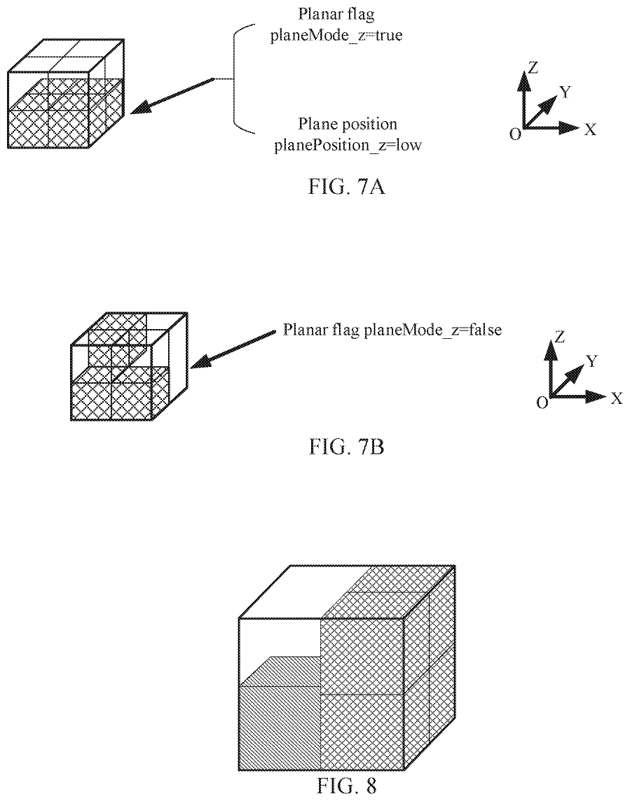

Further, taking (a) in FIG. 5A as an example, the efficiency of octree coding and the efficiency of planar coding are compared. FIG. 6 provides a schematic diagram of a node encoding order, that is, node encoding is performed in the order of 0, 1, 2, 3, 4, 5, 6, and 7 illustrated in FIG. 6. Herein, if an octree coding mode is used for (a) in FIG. 5A, occupancy information of the current node is represented by 11001100. However, if a planar coding mode is used, a flag needs to be first encoded to indicate that the current node is planar in the z-axis direction. Then, if the current node is planar in the z-axis direction, a plane position of the current node also needs to be indicated. Next, only occupancy information of nodes at the low plane in the z-axis direction (i.e., occupancy information of four child nodes 0, 2, 4, and 6) needs to be encoded. Therefore, for encoding the current node based on the planar coding mode, only six bits need to be encoded, and compared with octree coding in the related art, two bits can be reduced. Based on this analysis, the coding efficiency is more significant in planar coding compared with octree coding. Therefore, in a certain dimension, if an occupied node is encoded using the planar coding mode, planar flag information (planarMode) and plane position (PlanePos) information of the current node in this dimension need to be first indicated, and then occupancy information of the current node is encoded based on planar information of the current node. Exemplarily, FIG. 7A is a schematic diagram of planar flag information. As illustrated in FIG. 7A, it indicates a low plane in a z-axis direction; and correspondingly, a value of the planar flag information is true or 1, i.e., planarMode_{_z}=true, and plane position information indicates low, i.e., PlanePosition_{_z}=low. FIG. 7B is another schematic diagram of planar flag information. As illustrated in FIG. 7B, it is not planar in a z-axis direction; and correspondingly, a value of the planar flag information is false or 0, i.e., planarMode_{_z}=false.

It may be noted that, for PlaneMode_{_i}, 0 indicates that the current node is not planar in an i-axis direction, and 1 indicates that the current node is planar in the i-axis direction. If the current node is planar in the i-axis direction, then for PlanePosition_{_i}, 0 indicates that the current node is planar in the i-axis direction and a plane position is low, and 1 indicates that the current node is at a high plane in the i-axis direction. Herein, i represents a coordinate dimension and may be an x-axis direction, a y-axis direction, or a z-axis direction, and thus i=0, 1, 2.

In the G-PCC standard, whether a node satisfies a condition for planar coding is determined, and when the node satisfies the condition for planar coding, predictive coding needs to be performed on planar flag information and plane position information of the node.

In embodiments of the disclosure, in the current G-PCC standard, there are three conditions for determining whether a node is eligible for planar coding, which will be elaborated below one by one.

I. Determining According to a Probability of a Node being Planar in Each Dimension
(1) A local region density (local_node_density) of a current node is determined.
(2) A probability Prob(i) of the current node in each dimension is determined.

When the local region density of the node is less than a threshold Th (for example, Th=3), probabilities Prob(i) of the current node being planar in three coordinate dimensions are compared with thresholds Th0, Th1, and Th2 respectively, where Th0<Th1<Th2 (for example, Th0=0.6, Th1=0.77, Th2=0.88). Herein, Eligibleᵢ (i=0, 1, 2) may indicate whether to enable planar coding in each dimension, and Eligibleᵢ=Prob(i)>=threshold.

It may be noted that, the threshold varies adaptively. For example, when Prob(0)>Prob(1)>Prob(2), Eligibleᵢ is set as follows:

$${Eligible}_{0} = Prob ( 0 ) >= Th 0 ;$$

$${Eligible}_{1} = Prob ( 1 ) >= Th 1 ;$$

$${Eligible}_{2} = Prob ( 2 ) >= Th 2.$$

When Prob(1)>Prob(0)>Prob(2), Eligibleᵢ is set as follows:

$${Eligible}_{0} = Prob ( 0 ) >= Th 1 ;$$

$${Eligible}_{1} = Prob ( 1 ) >= Th 0 ;$$

$${Eligible}_{2} = Prob ( 2 ) >= Th 2.$$

Herein, Prob(i) is updated as follows.

$$Prob ( i ) new = ( L \times Prob ( i ) + δ ( coded node ) ) / L + 1$$

In the above, L=255. In addition, if the coded node is planar, δ(coded node) is 1, and otherwise, δ(coded node) is 0.

Herein, local_node_density is updated as follows.

$$local\_node {\_density}_{n e w} = local\_node \_density + 4 * numSiblings$$

In the above, local_node_density is initialized to 4, and numSiblings is the number of sibling nodes of the node. Exemplarily, FIG. 8 is a schematic diagram of sibling nodes of a current node. As illustrated in FIG. 8, when the current node is a node filled with diagonal lines, and grid-filled nodes are the sibling nodes, the number of sibling nodes of the current node is 5 (including the current node itself).

### II. Determining Whether a Node in a Current Layer is Eligible for Planar Coding According to a Point Cloud Density of the Current Layer

Whether planar coding is performed on the node in the current layer is determined according to a density of points in the current layer. It is assumed that the number of points in a current point cloud to-be-encoded is pointCount, and the number of points that have been reconstructed through inferred direct coding mode (IDCM) coding is numPointCountRecon. In addition, since an octree is encoded in the order of breadth-first search, the number of nodes to-be-encoded in the current layer may be assumed to be nodeCount. In this case, it is determined that whether planar coding is enabled for the current layer is assumed to be planarEligibleKOctreeDepth. Specifically, planarEligibleKOctreeDepth-(pointCount-numPointCountRecon)<nodeCount×1.3.

If (pointCount-numPointCountRecon) is less than nodeCount×1.3, planarEligibleKOctreeDepth is true. If (pointCount-numPointCountRecon) is not less than nodeCount×1.3, planarEligibleKOctreeDepth is false. As such, when planarEligibleKOctreeDepth is true, planar coding is performed on all nodes in the current layer. Otherwise, planar coding is not performed on all the nodes in the current layer, and only octree coding is used.

### III. Determining Whether a Current Node is Eligible for Planar Coding According to a Collection Parameter of a Lidar Point Cloud

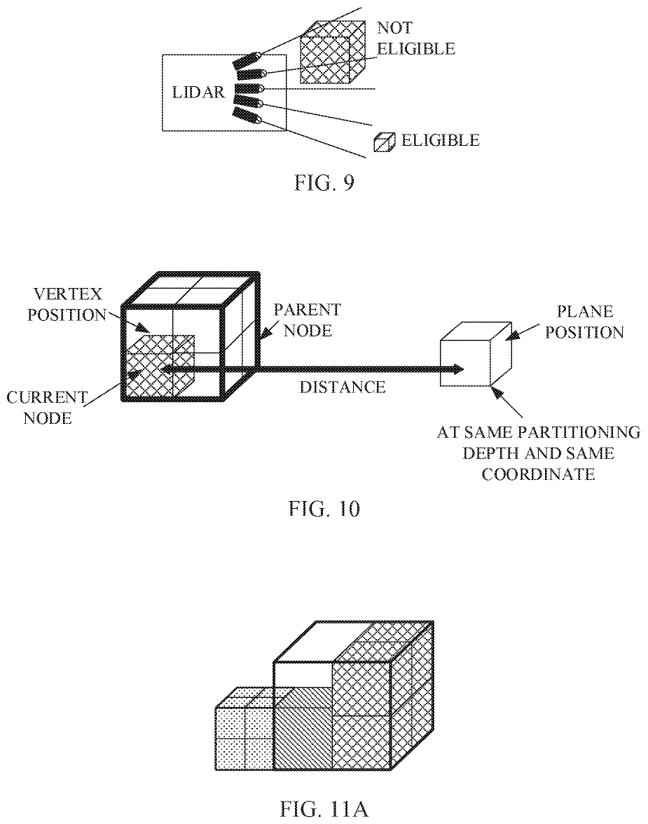

FIG. 9 is a schematic diagram illustrating intersection of a lidar with nodes. As illustrated in FIG. 9, a grid-filled node is crossed by two lasers at the same time, and thus the current node is not planar in a vertical direction of z-axis; and a node filled with diagonal lines is small enough not to be crossed by two lasers at the same time, and thus the node filled with diagonal lines may be planar in the vertical direction of z-axis.

Further, for a node satisfying the condition for planar coding, predictive coding may be performed on planar flag information and plane position information.

### First, Predictive Coding of the Planar Flag Information

Herein, only three context information is used for coding. That is, a planar flag in each coordinate dimension is designed with a separate context.

### Second, Predictive Coding of the Plane Position Information

It may be understood that, for coding of plane position information of a non-lidar point cloud, predictive coding of the plane position information may be as follows.

(a) Plane position information of the current node predicted by occupancy information of a neighbourhood node includes three elements: predicted as low, predicted as high, or unpredictable.

(b) A spatial distance between the current node and a node at the same partitioning depth and the same coordinate as the current node: “near” or “far”.

(c) If the node at the same partitioning depth and the same coordinate as the current node is planar, a plane position of the node is determined.

(d) Coordinate dimensions (i=0, 1, 2).

It may be noted that in embodiments of the disclosure, after the spatial distance between the current node and the node at the same partitioning depth and the same coordinate as the current node is determined, if the spatial distance is less than a preset distance threshold, then it may be determined that the spatial distance is “near”. Alternatively, if the spatial distance is greater than the preset distance threshold, then it may be determined that the spatial distance is “far”.

Exemplarily, FIG. 10 is a schematic diagram of a neighbourhood node at the same partitioning depth and the same coordinate. As illustrated in FIG. 10, a large cube in bold represents a parent node, a grid-filled small cube in the large cube represents a current node, and a vertex position of the current node is illustrated. A white-filled small cube represents the neighbourhood node at the same partitioning depth and the same coordinate, and a distance between the current node and the neighbourhood node is a spatial distance, which may be determined as “near” or “far”. In addition, if the neighbourhood node is planar, a plane position (also referred to as a planar position) of the neighbourhood node is needed.

As such, as illustrated in FIG. 10, if the current node is the grid-filled small cube, then at the same octree-partitioning-depth level and the same vertical coordinate, the neighbourhood node is found to be the white-filled small cube. The distance between the two nodes is determined to be “near” or “far”, and reference is made to the plane position of the neighbourhood node.

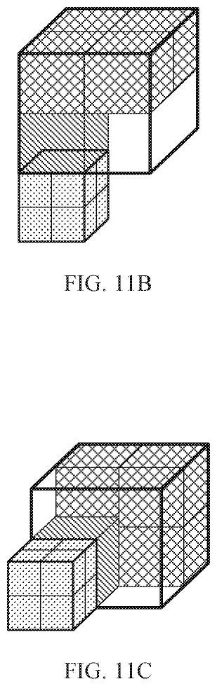

Further, in embodiments of the disclosure, FIG. 11A to FIG. 11C are schematic diagrams each illustrating a current node at a low plane position of a parent node. As illustrated in FIG. 11A to FIG. 11C illustrate three examples in which the current node is located at the low plane position of the parent node. Details are as follows.
1. If any one of child nodes 4 to 7 of a dot-filled node is occupied and all grid-filled nodes are unoccupied, it is strongly likely that there is a plane in the current node (filled with diagonal lines) and the plane position is low.
2. If the child nodes 4 to 7 of the dot-filled node are all unoccupied and any of the grid-filled nodes are occupied, it is strongly likely that there is a plane in the current node (filled with diagonal lines) and the plane position is high.
3. If the child nodes 4 to 7 of the dot-filled node are all empty nodes and the grid-filled nodes are all empty nodes, the plane position is unable to be inferred, and thus the plane position is labelled as unknown.
4. If any one of the child nodes 4 to 7 of the dot-filled node is occupied and any one of the grid-filled nodes is occupied, the plane position is unable to be inferred, and thus the plane position is labelled as unknown.

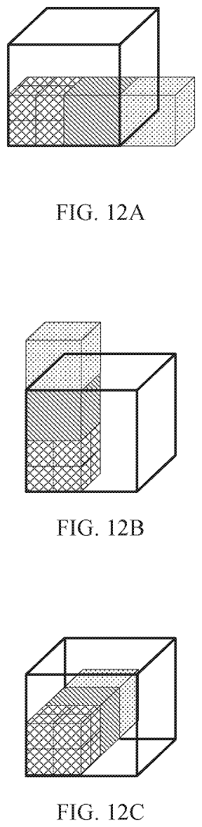

In embodiments of the disclosure, FIG. 12A to FIG. 12C is a schematic diagram of a current node at a high plane position of a parent node. As illustrated in FIG. 12A to FIG. 12C illustrate three examples in which the current node is located at the high plane position of the parent node. Details are as follows.
1. If any one of child nodes 4 to 7 of a grid-filled node is occupied and a dot-filled node is unoccupied, it is strongly likely that there is a plane in the current node (filled with diagonal lines) and the plane position is low.
2. If the child nodes 4 to 7 of the grid-filled node are all unoccupied and the dot-filled node is occupied, it is strongly likely that there is a plane in the current node (filled with diagonal lines) and the plane position is high.
3. If the child nodes 4 to 7 of the grid-filled node are all unoccupied and the dot-filled node is unoccupied, the plane position is unable to be inferred, and thus the plane position is labelled as unknown.
4. If one of the child nodes 4 to 7 of the grid-filled node is occupied and the dot-filled node is occupied, the plane position is unable to be inferred, and thus the plane position is labelled as unknown.

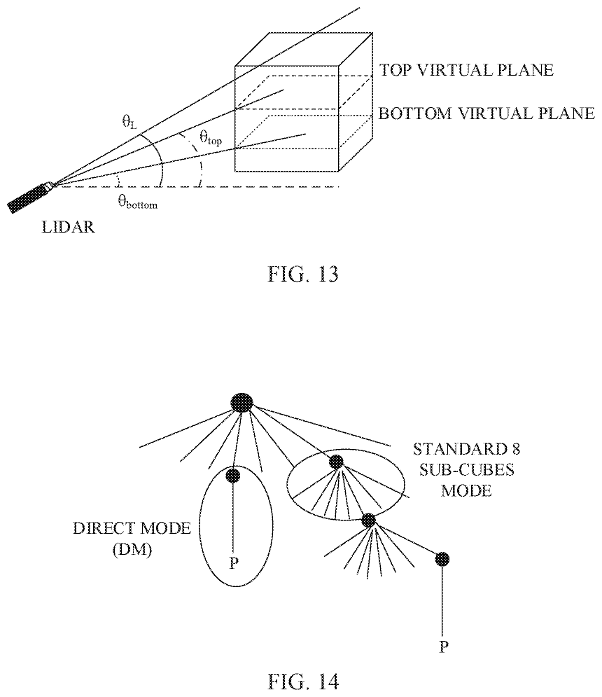

It may also be understood that, for coding of plane position information of a lidar point cloud, FIG. 13 is a schematic diagram illustrating predictive coding of plane position information of a lidar point cloud. As illustrated in FIG. 13, when a transmission angle of a lidar is θ_{bottom}, it may be mapped to a bottom virtual plane, or when the transmission angle of the lidar is θₜₒₚ, it may be mapped to a top virtual plane.

That is to say, a collection parameter of the lidar is used for predicting a plane position of the current node, and a position(s) where the current node intersects with a laser(s) is used for quantizing the plane position into multiple intervals, which are ultimately used as context information of the plane position of the current node. The specific calculation is as follows. Assuming that coordinates of the lidar are (x_{Lidar}, y_{Lidar}, z_{Lidar}) and geometry coordinates of the current node are (x, y, z), a vertical tangent value tan θ of the current node relative to the lidar is first calculated. A calculation formula is as follows.

$$tan θ = \frac{z - {z}_{Lidar}}{\sqrt{{( x - {x}_{Lidar} )}^{2} + {( y - {y}_{Lidar} )}^{2}}}$$

Further, since each laser has a certain offset angle relative to the lidar, a relative tangent value tan θ_{corr,L} of the current node relative to the laser also needs to be calculated. The specific calculation is as follows.

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r}$$

Finally, the relative tangent value tan θ_{corr,L} of the current node is used for predicting the plane position of the current node. Specifically, assuming that a tangent value of a bottom boundary of the current node is tan(θ_{bottom}), and a tangent value of a top boundary of the current node is tan(θₜₒₚ), the plane position is quantized into four quantization intervals according to tan θ_{corr,L}, to determine the context information of the plane position.

However, in an octree-based geometry information encoding mode, an efficient compression rate is achieved for only points with correlation in space, and for points at isolated positions in geometric space, complexity can be greatly reduced by using a direct coding mode (DCM). For all nodes in the octree, instead of being indicated by a flag, the usage of the DCM is inferred from information of a neighbour(s) and a parent node of a current node. There are three methods for determining whether the current node has eligibility for DCM coding. Details are as follows.
(1) The current node has no sibling child node, that is, the parent node of the current node has only one child node. In addition, a parent node of the parent node of the current node has only two occupied child nodes, that is, the current node has at most one neighbouring node.
(2) The parent node of the current node has only one occupied child node, i.e., the current node. In addition, six neighbouring nodes sharing a face with the current node all belong to empty nodes.
(3) The number of sibling nodes of the current node is greater than 1.

Exemplarily, FIG. 14 provides a schematic diagram illustrating IDCM coding. If the current node does not have eligibility for DCM coding, octree partitioning will be performed on the current node. If the current node has eligibility for DCM coding, the number of points contained in the current node will be further determined. If the number of points is less than a threshold (for example, 2), DCM coding is performed on the current node, and otherwise, octree partitioning is continued. For using a DCM coding mode, whether the current node is a real isolated point, i.e., IDCM_flag, needs to be first encoded. If IDCM_flag is true, DCM coding is used for the current node, and otherwise, octree coding is still used for the current node. When the current node is eligible for DCM coding, the DCM coding mode for the current node needs to be encoded. Currently, there are two DCM modes: (a) there is only one point (or multiple points which, however, belong to duplicate points); and (b) two points are contained. Finally, geometry information of each point needs to be encoded. Assuming that a side length of a node is 2^{d}, d bits are needed for encoding each component of geometry coordinates of the node, and information of these bits is directly signalled into a bitstream. Herein, it may be noted that for coding of the lidar point cloud, the collection parameter of the lidar is used for predictive coding of coordinate information in three dimensions, thereby further improving the coding efficiency of geometry information.

Further, the IDCM coding will be described in detail below.

When the current node is eligible for the DCM coding mode, the number numPoints of points in the current node is first encoded, and the number of points in the current node is encoded according to different DirectMode.

If the current node does not satisfy requirements for a DCM node, directly exit (that is, the number of points is greater than 2, and these points are not duplicate points).

If the number numPoints of points contained in the current node is less than or equal to 2, the encoding process is as follows.
1) Whether numPoints of the current node is greater than 1 is first encoded.
2) If the current node contains only one point and the geometry encoding environment is lossless geometry encoding, encode that the second point in the current node is not a duplicate point.

If the number numPoints of points contained in the current node is greater than 2, the encoding process is as follows.
1) First, whether numPoints of the current node is less than or equal to 1 is encoded.
2) Next, encode that the second point in the current node is a duplicate point. Then, whether the number of duplicate points in the current node is greater than 1 is encoded. When the number of duplicate points is greater than 1, exponential Golomb encoding needs to be performed on the number of remaining duplicate points.

After the number of points in the current node is encoded, coordinate information of a point(s) contained in the current node is encoded. Lidar point clouds and human eye-oriented point clouds will be separately described in detail below.

### (I) Human Eye-Oriented Point Clouds

(1) If the current node contains only one point, geometry information of the point in three dimension directions is directly encoded (bypass coding).
(2) If the current node contains two points, a coordinate axis dirextAxis to be preferentially encoded is first obtained based on geometry coordinates of the points. Herein, it may be noted that, coordinate axes currently compared include only the x-axis and the y-axis, and do not include the z-axis. Assuming that geometry coordinates of the current node are nodePos, the determination method is as follows.

$$directAxis = ! ( nodePos [ 0 ] < nodePos [ 1 ] )$$

That is, an axis with a small node-coordinate geometry position is determined as the coordinate axis dirextAxis to be preferentially encoded. Then, geometry information in the coordinate axis dirextAxis to be preferentially encoded is first encoded in the following manner. Assuming that a geometry bit depth to-be-encoded corresponding to the axis to be preferentially encoded is nodeSizeLog2, and coordinates of the two points are pointPos[0] and pointPos[1] respectively, the specific encoding process is as follows.

```
Bool sameBit=true;
while(nodeSizeLog2&& sameBit){
  int mask=1<< nodeSizeLog2;
  --nodeSizeLog2;
    bool bit0 =!!( pointPos[0]& mask)
bool bit1=!!( pointPos[1]& mask)
    sameBits=bit0==bit1;
    entropyCodeSameBit(sameBits); ///<entropy coding
    if(sameBits)
      encodePosBit(bit0);///<Bypass coding
      }
```

After the coordinate axis dirextAxis to be preferentially encoded is encoded, the geometry coordinates of the current node are further directly encoded. Assuming that a remaining coding bit depth of each point is nodeSizeLog2, the specific encoding process is as follows.

for(int axisIdx=0;axisIdx<3;++axisIdx)
for(int mask=(1<< nodeSizeLog2[axisIdx])>>1;mask;mask>>1)
encodePosBit(!!(pointPos[axisIdx]&mask)).

### (II) Lidar-Oriented Point Clouds

If the current node contains two points, a coordinate axis dirextAxis to be preferentially encoded is first obtained based on geometry coordinates of the points. Assuming that geometry coordinates of the current node are nodePos, the determination method is as follows.

$$directAxis = ! ( nodePos [ 0 ] < nodePos [ 1 ] )$$

That is, an axis with a small node-coordinate geometry position is determined as the coordinate axis dirextAxis to be preferentially encoded. Herein, it may be noted that, coordinate axes currently compared include only the x-axis and the y-axis, and do not include the z-axis. Then, geometry information in the coordinate axis dirextAxis to be preferentially encoded is first encoded in the following manner. Assuming that a geometry bit depth to-be-encoded corresponding to the axis to be preferentially encoded is nodeSizeLog2, and coordinates of the two points are pointPos[0] and pointPos[1] respectively, the specific encoding process is as follows.

```
  Bool sameBit-true;
  while(nodeSizeLog2&& sameBit){
    int mask=1<< nodeSizeLog2;
    --nodeSizeLog2;
    bool bit0=!!( pointPos[0]& mask)
bool bit1=!!( pointPos[1]& mask)
    sameBits=bit0==bit1;
    entropyCodeSameBit(sameBits);
    if(sameBits)
      encodePosBit(bit0);
    }
```

After the coordinate axis dirextAxis to be preferentially encoded is encoded, the geometry coordinates of the current node are encoded.

For the lidar point cloud, since a collection parameter of the lidar point cloud may be obtained, geometry coordinate information of the current node may be predicted based on the collection parameter, thereby further improving the encoding efficiency of geometry information of the point cloud. Similarly, a principal axis direction for direct coding is first obtained based on geometry information nodePos of the current node, and then predictive coding is performed on geometry information in another dimension based on encoded geometry information in the direction. Likewise, assuming that an axis direction for direct coding is directAxis, and a bit depth to-be-encoded in the direct coding is nodeSizeLog2, the encoding is as follows.

for(int mask=(1<< nodeSizeLog2)>>1;mask;mask>>1)
encodePosBit(!!(pointPos[directAxis]&mask)).

Herein, it may be noted that, all geometry precision information in the direction directAxis is encoded.

Exemplarily, FIG. 15 provides a schematic diagram illustrating coordinate transform of a point cloud obtained by a rotating lidar. In the Cartesian coordinate system, coordinates (x, y, z) of each node may be transformed to be represented by (R, φ, i). In addition, a laser scanner may perform laser scanning according to a preset angle, and for different values of i, different θ(i) may be obtained. For example, when i is equal to 1, θ(1) may be obtained, and a corresponding scanning angle is −15°. When i is equal to 2, θ(2) may be obtained, and a corresponding scanning angle is −13°. When i is equal to 10, θ(10) may be obtained, and a corresponding scanning angle is +13°. When i is equal to 9, θ(19) may be obtained, and a corresponding scanning angle is +15°.

As such, after all precision in the coordinate direction directAxis is encoded, first, LaserIdx of a current point, i.e., pointLaserIdx in FIG. 15, is calculated, and LaserIdx of a current node, i.e., nodeLaserIdx, is calculated. Next, based on LaserIdx of the node, i.e., nodeLaserIdx, predictive coding is performed on LaserIdx of the point, i.e., pointLaserIdx. A calculation method for LaserIdx of the node or point is as follows. Assuming that geometry coordinates of the point are pointPos, start coordinates of a laser are LidarOrigin, the number of lasers is LaserNum, a tangent value of each laser is tan θᵢ, and an offset position of each laser in the vertical direction is Zᵢ, then:

```
  Int bestLaserIdx=0;
  Int Distoration=INT_MAX;
For(int LaserIdx=0; LaserIdx<numLaser;++ LaserIdx){
  int radius = \sqrt{(pointPos[0]-LidarOrigin[0])2+(pointPos[1]-LidarOrigin[1])2}
int invRadius=1/ radius
int Z=pointPos[2]+ Zᵢ
int tan Theta= Z×invRadius
if(std::abs(tanTheta-tanθᵢ)< Distoration){
  Distoration= std::abs(tanTheta-tanθᵢ);
  bestLaserIdx= LaserIdx;
  }
}
```

After LaserIdx of the current point is calculated, predictive coding is first performed on pointLaserIdx of the point based on LaserIdx of the current node. After coding of LaserIdx of the current point is completed, predictive coding is performed on geometry information of the current point in three dimensions based on a collection parameter of a lidar.

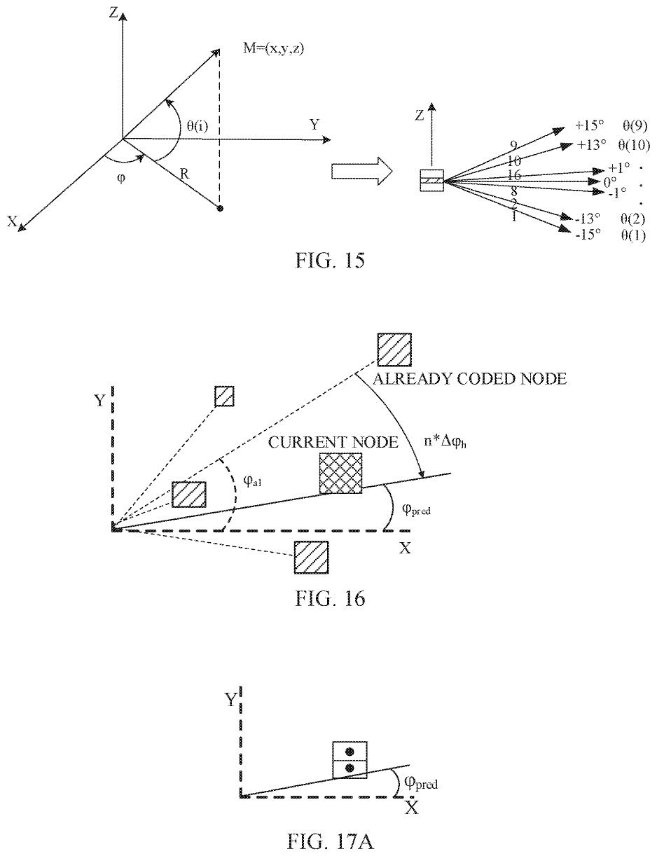

Exemplarily, FIG. 16 is a schematic diagram illustrating predictive coding in an x-axis or y-axis direction. As illustrated in FIG. 16, a grid-filled box represents a current node, and a box filled with diagonal lines represents an already coded node. Herein, a prediction value of a corresponding horizontal azimuth angle, i.e., φ_{pred}, is first obtained based on LaserIdx of the current node. Next, a horizontal azimuth angle φ_{node} of the node is obtained based on node geometry information of the current node. Assuming that geometry coordinates of the node are nodePos, a calculation method for a horizontal azimuth angle σ and node geometry information is as follows.

$$φ = arctan ( nodePos [ 1 ] / nodePos [ 0 ] )$$

Based on a collection parameter of a lidar, the number numPoints of points per rotation of each laser may be obtained, which indicates the number of points obtained by each laser during one rotation. In this case, a rotational angular velocity deltaPhi of each laser can be calculated based on the number of points per rotation of each laser. A calculation method is as follows.

$$deltaPhi = \frac{2 π}{numPoints}$$

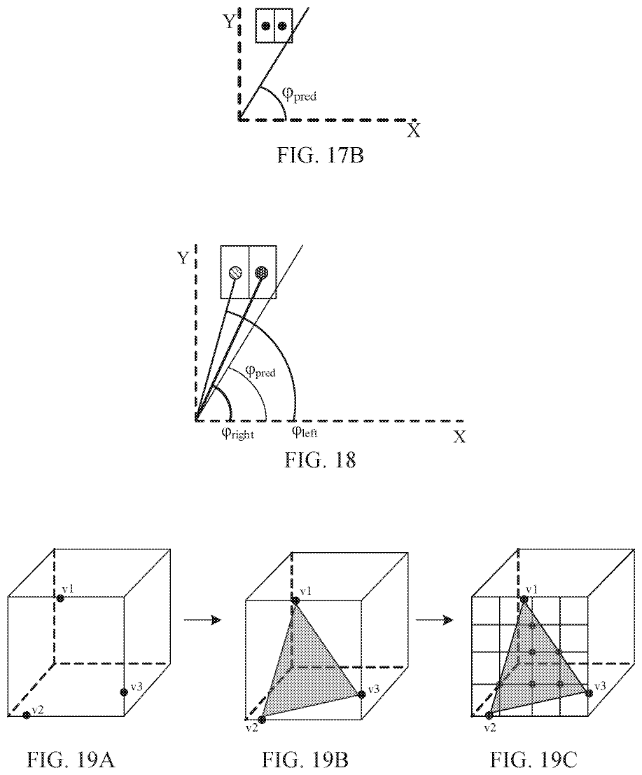

Further, a prediction value φ_{predPoint} of a horizontal azimuth angle of a current point, i.e., a prediction value of a horizontal azimuth angle as illustrated in FIG. 17A or FIG. 17B, is calculated based on the horizontal azimuth angle φ_{node} of the node and a horizontal azimuth angle φ_{pred} of a previous coded point for a laser corresponding to the current point. FIG. 17A is a schematic diagram illustrating a y-planar angle predicted using a horizontal azimuth angle, and FIG. 17B is a schematic diagram illustrating an x-planar angle predicted using a horizontal azimuth angle. Herein, a calculation method for the prediction value φ_{predPoint} of the horizontal azimuth angle of the current point is as follows.

$${φ}_{p r e d Point} = \frac{{φ}_{p r e d} - {φ}_{n o d e}}{deltaPhi} \times deltaPhi + {φ}_{p r e d}$$

Exemplarily, FIG. 18 is another schematic diagram illustrating predictive coding in an x-axis or y-axis direction. As illustrated in FIG. 18, a grid-filled part (on the left) indicates a low plane, a dot-filled part (on the right) indicates a high plane, φ_{left} indicates a horizontal azimuth angle of a current node in the low plane, φ_{right} indicates a horizontal azimuth angle of the current node in the high plane, and φ_{pred} indicates a prediction value of a horizontal azimuth angle of the current node.

As such, predictive coding is performed on geometry information of the current node based on the prediction value φ_{predPoint} of the horizontal azimuth angle, the horizontal azimuth angle φ_{left} of the current node in the low plane, and the horizontal azimuth angle φ_{right} of the current node in the high plane. Details are as follows:

int angLel = φ_{left} - φ_{pred};
int angLeR = φ_{right} - φ_{pred};
int context = (angLel ≥ 0&&angLeR ≥ 0)||(angLel < 0&&angLeR < 0)?0:2;
int minAngle = std : : min(abs(angLel),abs(angLeR));
int maxAngle = std : : max(abs(angLel),abs(angLeR));
context+= maxAngle > minAngle?0:1;
context+= maxAngle > minAngle?0:4.

After coding of LaserIdx of the point is completed, predictive coding is performed on a z-axis direction of the current point based on LaserIdx of the current point. That is, depth information “radius” in the radar coordinate system is currently calculated based on x and y information of the current point, and then a tangent value of the current point and an offset of the current point in the vertical direction are obtained based on LaserIdx of the current point. In this way, a prediction value Z_pred of the current point in the z-axis direction can be obtained. Details are as follows:

$$int radius = \sqrt{{( pointPos [ 0 ] - LidarOrigin [ 0 ] )}^{2} + {( pointPos [ 1 ] - LidarOngin [ 1 ] )}^{2}} ;$$

int tan Theta=tan θ_{laserIdx};
int zOffset=Z_{laserIdx};
Z_pred=radius×tanTheta-zOffset.

Further, a prediction residual Z_res is obtained by performing predictive coding on geometry information of the current point in the z-axis direction based on Z_pred, and finally Z_res is encoded.

It may be noted that, when a node is partitioned into a leaf node, in case of lossless geometry encoding, the number of duplicate points in the leaf node needs to be encoded. Finally, occupancy information of all nodes is encoded to generate a binary bitstream. In addition, a planar coding mode is currently introduced in G-PCC. During geometry partitioning, whether child nodes of the current node are located at the same plane is determined. If the child nodes of the current node are at the same plane, the child nodes of the current node may be represented by this plane.

For the octree geometry decoding, before decoding occupancy information of each node in the order of breadth-first search, the decoding end first determines, based on reconstructed geometry information, whether planar decoding or IDCM decoding is performed on the current node. If the current node satisfies a condition for planar decoding, the decoding end first decodes planar flag information and plane position information of the current node, and then decodes occupancy information of the current node based on planar information. If the current node satisfies a condition for IDCM decoding, the decoding end first decodes whether the current node is a real IDCM node. If the current node is a real IDCM node, the decoding end further parses a DCM decoding mode for the current node, then obtains the number of points in a current DCM node, and finally decodes geometry information of each point. For a node that is eligible for neither planar decoding nor DCM decoding, occupancy information of the current node is decoded. An occupancy code of each node is obtained through continuous parsing in such a manner, and the node is sequentially partitioned until a 1×1×1 unit cube is obtained. The number of points contained in each leaf node is parsed out, and finally geometry-reconstructed point cloud information is restored.

The IDCM decoding will be described in detail below.

Similar to the processing at the encoding end, whether IDCM is enabled for a node is first determined based on prior information. That is, conditions for enabling IDCM are as follows.
(1) A current node has no sibling child node, that is, a parent node of the current node has only one child node. In addition, a parent node of the parent node of the current node has only two occupied child nodes, that is, the current node has at most one neighbouring node.
(2) The parent node of the current node has only one occupied child node, i.e., the current node. In addition, six neighbouring nodes sharing a face with the current node all belong to empty nodes.
(3) The number of sibling nodes of the current node is greater than 1.

Further, when the node satisfies a condition for DCM coding, whether the current node is a real DCM node, i.e., IDCM_flag, is first decoded. If IDCM_flag is true, DCM coding is used for the current node, and otherwise, octree coding is still used for the current node.

Next, the number numPoints of points in the current node is decoded. The specific decoding is as follows.
i) Whether numPoints of the current node is greater than 1 is first decoded.
ii) If numPoints of the current node obtained by decoding is greater than 1, whether the second point is a duplicate point is further decoded. If the second point is not a duplicate point, it may be implicitly inferred herein that a second DCM mode is satisfied, that is, only two points are contained.
iii) If numPoints of the current node obtained by decoding is less than or equal to 1, whether the second point is a duplicate point is further decoded. If the second point is not a duplicate point, it may be implicitly inferred herein that a second DCM mode is satisfied, that is, only one point is contained. If the second point obtained by decoding is a duplicate point, it may be inferred that a third DCM mode is satisfied, that is, multiple points are contained but are all duplicate points. In this case, whether the number of duplicate points is greater than 1 is further decoded (entropy decoding). If the number of duplicate points is greater than 1, the number of remaining duplicate points is further decoded (exponential Golomb decoding).

If the current node does not satisfy requirements for a DCM node, directly exit (that is, the number of points is greater than 2, and these points are not duplicate points).

After the number of points in the current node is decoded, coordinate information of a point(s) contained in the current node is decoded. Lidar point clouds and human eye-oriented point clouds will be separately described in detail below.

### (I) Human Eye-Oriented Point Clouds

(1) If the current node contains only one point, geometry information of the point in three dimension directions is directly decoded (bypass coding).
(2) If the current node contains two points, a coordinate axis dirextAxis to be preferentially decoded is first obtained based on geometry coordinates of the points. Herein, it may be noted that, coordinate axes currently compared include only the x-axis and the y-axis, and do not include the z-axis. Assuming that geometry coordinates of the current node are nodePos, the determination method is as follows.

$$directAxis = ! ( nodePos [ 0 ] < nodePos [ 1 ] )$$

That is, an axis with a small node-coordinate geometry position is determined as the coordinate axis dirextAxis to be preferentially decoded. Then, geometry information in the coordinate axis dirextAxis to be preferentially decoded is first decoded in the following manner. Assuming that a geometry bit depth to-be-decoded corresponding to the axis to be preferentially decoded is nodeSizeLog2, and coordinates of the two points are pointPos[0] and pointPos[1] respectively, the specific decoding process is as follows.

```
Bool sameBit=true;
while(nodeSizeLog2&& sameBit){
  pointPos[0][ dirextAxis]<<1;
  pointPos[1][ dirextAxis]<<1;
  --nodeSizeLog2;
    int bit=0;
      deEntropyCodeSameBit(sameBits); ///<entropy coding
    if(sameBits){
        bit =decodePosBit( );///<Bypass coding
        pointPos[0][ dirextAxis]|= bit
          pointPos[1][ dirextAxis]|= bit
    }else
            pointPos[1][ dirextAxis]|= 1///<The reason herein is that
during encoding, the two points are ordered in a direction of an axis to be preferentially encoded, and thus
it can be ensured that pointPos[0][dirextAxis]< pointPos[1][dirextAxis]. Therefore, during decoding, if bit
information of the two points are different, it may be inferred that a bit of the first point is 0 and a bit of
the second point is 1.
    }
```

After the coordinate axis dirextAxis to be preferentially decoded is decoded, the geometry coordinates of the current point are further directly decoded. Assuming that a remaining coding bit depth of each point is nodeSizeLog2, and coordinate information of the point is pointPos, the specific decoding process is as follows.

```
for(int axisIdx=0;axisIdx<3;++axisIdx)
for(int idx= nodeSizeLog2[axisIdx]; idx; idx--){
  pointPos[axisIdx]<<1;
  pointPos[axisIdx]|=decodePosBit( );
    }
```

### (II) Lidar-Oriented Point Clouds

If the current node contains two points, a coordinate axis dirextAxis to be preferentially decoded is first obtained based on geometry coordinates of the points. Assuming that geometry coordinates of the current node are nodePos, the determination method is as follows.

$$directAxis = ! ( nodePos [ 0 ] < nodePos [ 1 ] ) \qquad ( 11 )$$

That is, an axis with a small node-coordinate geometry position is determined as the coordinate axis dirextAxis to be preferentially decoded. Herein, it may be noted that, coordinate axes currently compared include only the x-axis and the y-axis, and do not include the z-axis. Then, geometry information in the coordinate axis dirextAxis to be preferentially decoded is first decoded in the following manner. Assuming that a geometry bit depth to-be-decoded corresponding to the axis to be preferentially decoded is nodeSizeLog2, and coordinates of the two points are pointPos[0] and pointPos[1] respectively, the specific decoding process is as follows.

```
Bool sameBit=true;
while(nodeSizeLog2&& sameBit){
  pointPos[0][ dirextAxis]<<1;
  pointPos[1][ dirextAxis]<<1;
    --nodeSizeLog2;
    int bit=0;
      deEntropyCodeSameBit(sameBits); ///<entropy coding
    if(sameBits){
      bit =decodePosBit( );///<Bypass coding
      pointPos[0][ dirextAxis]|= bit
      pointPos[1][ dirextAxis]|= bit
    }else
        pointPos[1][dirextAxis]|= 1///<The reason herein is that during
encoding, the two points are ordered in a direction of an axis to be preferentially encoded, and thus it can
be ensured that pointPos[0][dirextAxis]< pointPos[1][dirextAxis]. Therefore, during decoding, if bit
information of the two points are different, it may be inferred that a bit of the first point is 0 and a bit of
the second point is 1.
    }
```

After the coordinate axis dirextAxis to be preferentially decoded is decoded, the geometry coordinates of the current point are decoded.

Similarly, a principal axis direction for direct decoding is first obtained based on geometry information nodePos of the current node, and then geometry information in another dimension is decoded based on decoded geometry information in the direction. Likewise, assuming that an axis direction for direct decoding is directAxis, and a bit depth to-be-decoded in the direct decoding is nodeSizeLog2, the decoding is as follows.

```
for(int idx= nodeSizeLog2[directAxis]; idx; idx--){
  pointPos[directAxis]<<1;
  pointPos[directAxis]|=decodePosBit( );
    }
```

Herein, it may be noted that, all geometry precision information in the direction directAxis is decoded.

After all precision in the coordinate direction directAxis is decoded, LaserIdx of a current node, i.e., nodeLaserIdx, is first calculated. Next, based on LaserIdx of the node, i.e., node LaserIdx, predictive decoding is performed on LaserIdx of a point, i.e., pointLaserIdx. A calculation method for LaserIdx of the node or point is the same as that at the encoding end. Finally, prediction residual information between LaserIdx of the current point and LaserIdx of the node is decoded to obtain ResLaserIdx. The decoding is as follows:

$$PointLaserIdx = nodeLaserIdx + ResLaserIdx$$

After LaserIdx of the current point is decoded, predictive decoding is performed on geometry information of the current point in three dimensions based on a collection parameter of a lidar. The specific algorithm is as follows.

As illustrated in FIG. 16, a prediction value of a corresponding horizontal azimuth angle, i.e., φ_{pred}, is first obtained based on LaserIdx of a current node. Next, a horizontal azimuth angle φ_{node} of the node is obtained based on node geometry information of the current node. Assuming that geometry coordinates of the node are nodePos, a calculation method for a horizontal azimuth angle φ and node geometry information is as follows.

$$φ = arctan ( nodePos [ 1 ] / nodePos [ 0 ] )$$

Based on a collection parameter of a lidar, the number numPoints of points per rotation of each laser may be obtained, which indicates the number of points obtained by each laser during one rotation. In this case, a rotational angular velocity deltaPhi of each laser can be calculated based on the number of points per rotation of each laser. A calculation method is as follows.

$$deltaPhi = \frac{2 π}{numPoints}$$

Further, a prediction value φ_{predPoint} of a horizontal azimuth angle of a current point, i.e., a prediction value of a horizontal azimuth angle as illustrated in FIG. 17A or FIG. 17B, is calculated based on the horizontal azimuth angle φ_{node} of the node and a horizontal azimuth angle φ_{pred} of a previous coded point for a laser corresponding to the current point. A calculation method is as follows.

$${φ}_{predPoint} = \frac{{φ}_{pred} - {φ}_{node}}{deltaPhi} \times deltaPhi + {φ}_{pred}$$

As such, predictive decoding is performed on geometry information of the current node based on the prediction value φ_{predPoint} of the horizontal azimuth angle, a horizontal azimuth angle φ_{left} of the current node in a low plane, and a horizontal azimuth angle φ_{right} of the current node in a high plane. Details are as follows:

int angLel = φ_{left} - φ_{pred};
int angLeR = φ_{right} - φ_{pred};
int context = (angLel ≥ 0&&angLeR ≥ 0)||(angLel < 0&&angLeR < 0)?0:2;
int absAngleL = abs(angLel);
int absAngleR = abs(angLeR);
context+= absAngleL > absAngleR?0:1;
context+= maxAngle > minAngle <<1 ?4:0.

After LaserIdx of the point is decoded, predictive decoding is performed on a z-axis direction of the current point based on LaserIdx of the current point. That is, depth information “radius” in the radar coordinate system is currently calculated based on x and y information of the current point, and then a tangent value of the current point and an offset of the current point in the vertical direction are obtained based on LaserIdx of the current point. In this way, a prediction value Z_pred of the current point in the z-axis direction can be obtained. Details are as follows:

$$int radius = \sqrt{( pointPos [ 0 ] - LidarOrigin [ 0 ] ) 2 + ( pointPos [ 1 ] - LidarOrigin [ 1 ] ) 2} ;$$

int tan Theta-tan θ_{laserIdx};
int zOffset=Z_{laserIdx};
Z_pred=radius×tanTheta-zOffset.

Further, geometry information of the current point in the z-axis direction is reconstructed and restored based on decoded Z_res and Z_pred.

For triangle soup (trisoup)-based geometry information encoding, geometry partitioning is also performed first in a trisoup-based geometry information encoding framework. However, different from binary tree/quadtree/octree-based geometry information encoding, in this method, instead of partitioning the point cloud layer-by-layer into 1×1×1 unit cubes, the partitioning is stopped when the side length of a block is W. Based on a surface formed by distribution of the point cloud in each block, up to 12 vertices generated between the 12 edges of the block and the surface are obtained. Then, coordinates of the vertices of each block are encoded in sequence and thus the binary bitstream is generated.

For trisoup-based point cloud geometry information reconstruction, during point cloud geometry information reconstruction at the decoding end, the decoding end first decodes vertex coordinates to complete trisoup reconstruction. This process is illustrated in FIG. 19A, FIG. 19B, and FIG. 19C. There are three vertices (v1, v2, v3) in a block illustrated in FIG. 19A. A structure formed by these three vertices in a certain order is called a triangle soup, i.e., trisoup, as illustrated in FIG. 19B. Then, sampling is performed on the trisoup, and an obtained sampling point(s) is determined as a reconstructed point cloud in the block, as illustrated in FIG. 19C.

The predictive geometry encoding (PredGeomTree) includes the following operations. First, ordering is performed on an input point cloud. Ordering methods currently used include disordering, Morton ordering, azimuth ordering, and radial distance ordering. At the encoding end, a prediction tree structure is built in two different modes: high-latency slow mode (KD-Tree) and low-latency fast mode (using lidar calibration information). By using the lidar calibration information, each point is assigned to a different laser, and the prediction tree structure is built according to the different laser. Next, based on the prediction tree structure, by traversing each node in the prediction tree, geometry position information of the node is predicted by selecting a different prediction mode to obtain a prediction residual, and the geometry prediction residual is quantized by using a quantization parameter. Finally, the prediction residual of the position information of the prediction tree node, the prediction tree structure, the quantization parameter, and the like are encoded through continuous iteration, to generate a binary bitstream.

For predictive geometry decoding, the decoding end reconstructs a prediction tree structure by continuously parsing a bitstream. Then, the decoding end obtains prediction residual information of a geometry position of each prediction node and a quantization parameter through parsing, and performs inverse quantization on the prediction residual to restore reconstructed geometry position information of each node. Finally, geometry reconstruction at the decoding end is completed.

After completion of geometry encoding, geometry information needs to be reconstructed. Currently, attribute encoding is mainly performed on colour information. First, the colour information is transformed from RGB colour space to YUV colour space. Then, the reconstructed geometry information is used to recolour the point cloud, such that the uncoded attribute information can correspond to the reconstructed geometry information. During encoding of the colour information, there are mainly two transform methods. One is distance-based lifting transform which relies on LOD partitioning, and the other is direct RAHT, both of which transform the colour information from the spatial domain to the frequency domain to obtain high-frequency coefficients and low-frequency coefficients through transform, and finally quantize and encode the coefficients to generate a binary bitstream. For details, reference can be made to FIG. 4A and FIG. 4B.

Further, during prediction of attribute information based on the geometry information, Morton codes can be used for nearest-neighbour search, and a Morton code corresponding to each point in the point cloud can be obtained from geometry coordinates of the point. A specific method for calculating the Morton code will be described below. For 3D coordinates with each component represented by a d-bit binary digit, three components may be represented as follows.

$$x = {\sum }_{l = 1}^{d} {2}^{d - l} {x}_{l} , y = {\sum }_{l = 1}^{d} {2}^{d - l} {y}_{l} , z = {\sum }_{l = 1}^{d} {2}^{d - l} {z}_{l}$$

xₗ,yₗ,zₗ∈{0,1} are respectively corresponding binary values from the most significant bit (l=1) to the least significant bit (l=d) of x, y, z. The Morton code M is obtained by interleaving xₗ,yₗ,zₗ from the most significant bit to the least significant bit for x, y, z. The calculation formula of M is as follows.

$$M = {\sum }_{l = 1}^{d} {2}^{3 ( d - l )} ( 4 {x}_{l} + 2 {y}_{l} + {z}_{l} ) = {\sum }_{{l}^{′} = 1}^{3 d} {2}^{3 d - {l}^{′}} {m}_{{l}^{′}}$$

mₗ′={0,1} are respectively values from the most significant bit (l′=1) to the least significant bit (l′=3d) of M. After the Morton code M of each point in the point cloud is obtained, the points in the point cloud are ordered in an ascending order of the Morton codes, and a weight w of each point is set to 1.

It may also be understood that for the G-PCC coding framework, common test conditions (CTC) are as follows.
(1) There are four test conditions in total: condition 1, limit-lossy geometry position and lossy attribute; condition 2, lossless geometry position and lossy attribute; condition 3, lossless geometry position and limit-lossy attribute; and condition 4, lossless geometry position and lossless attribute.
(2) There are four categories of common test sequences, namely Cat1A, Cat1B, Cat3-fused, and Cat3-frame. Cat2-frame point cloud contains only reflectance attribute information, Cat1A point cloud and Cat1B point cloud each contain only colour attribute information, and Cat3-fused point cloud contains both the colour attribute information and the reflectance attribute information.
(3) Technical route: based on algorithms used for geometry compression, there are two technical routes in total.

### Technical Route 1: Octree Coding Branch

At the encoding end, a bounding box is sequentially partitioned into sub-cubes, and non-empty (containing points in a point cloud) sub-cubes are continued to be partitioned until a resulting leaf node is 1×1×1 unit cube. In case of lossless geometry encoding, the number of points contained in the leaf node is encoded, and finally encoding of a geometry octree is completed, to generate a binary bitstream.

At the decoding end, the decoding end obtains an occupancy code of each node through continuous parsing in the order of breadth-first search, and sequentially partitions a node until a 1×1×1 unit cube is obtained. In case of lossless geometry decoding, the decoding end needs to parse out the number of points contained in each leaf node and finally restore geometry-reconstructed point cloud information.

### Technical Route 2: Prediction Tree Coding Branch

At the encoding end, a prediction tree structure is built in two different modes: based on KD-Tree (high-latency slow mode) and based on lidar calibration information (low-latency fast mode). By using the lidar calibration information, each point is assigned to a different laser, and the prediction tree structure is built based on the different laser. Next, based on the prediction tree structure, by traversing each node in the prediction tree, geometry position information of the node is predicted by selecting a different prediction mode to obtain a prediction residual, and the geometry prediction residual is quantized by using a quantization parameter. Finally, the prediction residual of the position information of the prediction tree node, the prediction tree structure, the quantization parameter, and the like are encoded through continuous iteration, to generate a binary bitstream.

At the decoding end, the decoding end reconstructs a prediction tree structure by continuously parsing a bitstream. Then, the decoding end obtains prediction residual information of a geometry position of each prediction node and a quantization parameter through parsing, and performs inverse quantization on the prediction residual to restore reconstructed geometry position information of each node. Finally, geometry reconstruction at the decoding end is completed.

It may also be noted that as illustrated in FIG. 4A or FIG. 4B, in the current G-PCC coding framework, there are three attribute coding methods: predicting transform (PT), lifting transform (LT), and RAHT. In the first two methods, predictive coding is performed on a point cloud based on the order of LOD generation, and in RAHT, adaptive transform is performed on attribute information from the bottom to the top based on a hierarchy of octree construction. These three point cloud attribute coding methods will be described in detail below.

### (a) Predictive Coding of Attribute Information of a Point Cloud

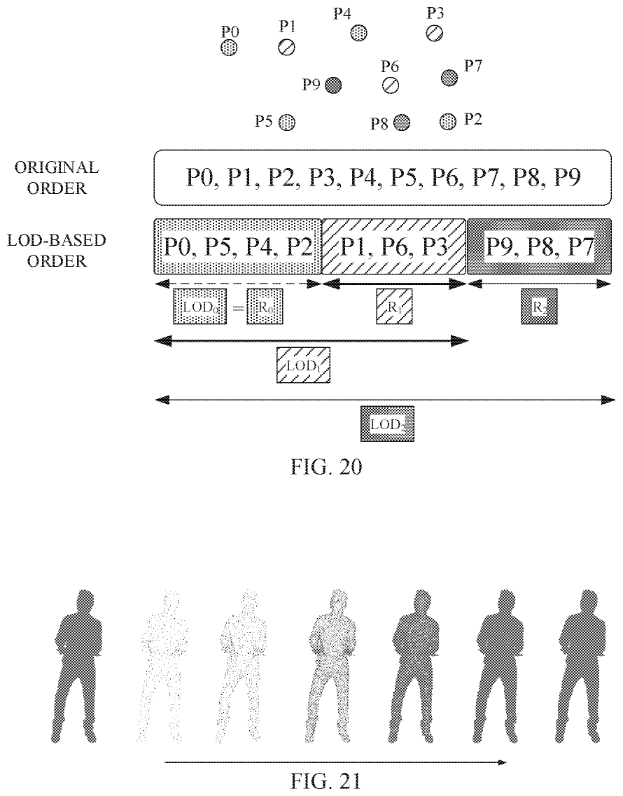

Currently, an attribute prediction module in G-PCC uses a nearest-neighbour attribute prediction coding scheme based on a LOD structure. A method for LOD construction includes a distance-based LOD construction scheme, a fixed sampling rate-based LOD construction scheme, an octree-based LOD construction scheme, and the like. In the distance threshold-based LOD construction scheme, before LOD construction, Morton ordering is first performed on the point cloud to ensure strong attribute correlation between neighbouring points. FIG. 20 is a schematic diagram illustrating distance-based LOD construction. As illustrated in FIG. 20, according to L Manhattan distances (dl), l=0, 1, . . . , L−1 preset by a user, point clouds are partitioned into L different refinement levels (Rl), l=0, 1, . . . , L−1. Herein, (dl)l=0, 1, . . . , L−1 satisfies d/<dl−1. The LOD construction is described as follows.

(1) First, all points in the point cloud are labelled as non-visited, and a set V is established to store a set of visited points. (2) At each iteration l, the points in the point cloud are traversed. If a current point has been visited, the current point is ignored. Otherwise, the minimum distance D of the current point to the set V of points is calculated. If D<dl, the current point is ignored. Otherwise, the current point is labelled as visited and added to the refinement level R/and the set V of points. (3) Points in the level of detail LODl include points in refinement levels R0, R1, R2 . . . . Rl. (4) The above operations are repeated until all the points are labelled as visited.

Based on the LOD structure, a reconstructed attribute value of a point in the same or higher LOD layer is used for linear weighted prediction on an attribute value of each point. The maximum number of reference prediction neighbours is determined by a high-level syntax element in the encoder. For an attribute of each point, at the encoding end, based on a rate-distortion optimization algorithm, attributes of N nearest neighbouring points found are selected for weighted prediction or an attribute of a single nearest neighbouring point is selected for prediction. Finally, a selected prediction mode and prediction residual are encoded.

$${Attr}_{i}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} {Attr}_{m} )$$

N represents the number of prediction points in a set of nearest neighbouring points of point i, Pᵢ represents the sum of N nearest neighbouring points of point i, Dₘ represents a spatial geometry distance between nearest neighbouring point m and current point i, Attrₘ represents a reconstructed attribute value of nearest neighbouring point m, Attrᵢ′ represents an attribute prediction value of current point i, and the number N of points is a preset value.

To keep tradeoff of attribute coding efficiency and parallel processing between different LOD layers, a switch is introduced in a high-level syntax element in the encoder to control whether to introduce intra LOD prediction. If the switch is switched on, intra LOD prediction is enabled, and thus points in the same LOD layer may be used for prediction. It may be noted that, intra LOD prediction is always used when the number of LOD layers is 1,

FIG. 21 is a schematic diagram illustrating a visualization result of LOD generation. As illustrated in FIG. 21, a subjective example of distance-based LOD generation is provided herein. Specifically (from left to right), points in the first layer represent an outer contour of a point cloud, and as the number of LODs increases, details of the point cloud gradually become clear.

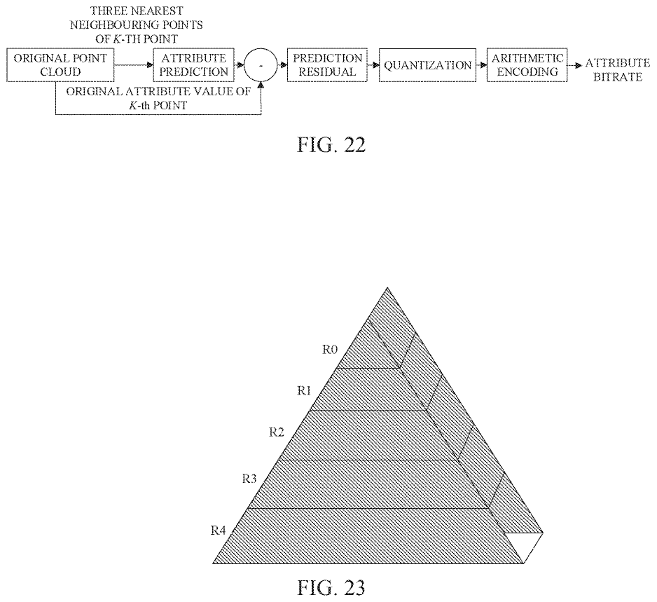

FIG. 22 is a schematic flowchart of attribute prediction coding. As illustrated in FIG. 22, in the specific process of G-PCC attribute prediction, for an original point cloud, three nearest neighbouring points of the K-th point are first searched, and then attribute prediction is performed. A difference between an attribute prediction value of the K-th point and an original attribute value of the K-th point is calculated to obtain a prediction residual of the K-th point. Then, quantization and arithmetic encoding are performed, and finally an attribute bitrate is generated.

### (i) Selection of an Optimal Prediction Value

After LOD construction is completed, according to the order of LOD generation, three nearest neighbouring points of a current point to-be-encoded are first found from encoded data points. Reconstructed attribute values of these three nearest neighbouring points are determined as candidate prediction values of the current point to-be-encoded. Then, an optimal prediction value is selected therefrom according to rate-distortion optimization (RDO). For example, during encoding of an attribute value of point P2 in FIG. 20, a predictor index of an attribute value of first-nearest neighbouring point P4 is set to 1, an attribute predictor index of second-nearest neighbouring point P5 and an attribute predictor index of third-nearest neighbouring point P0 are set to 2 and 3 respectively, and a predictor index of a weighted average value of points P0, P5, and P4 is set to 0, as illustrated in Table 1. Finally, an optimal predictor is selected according to RDO. A formula for weighted averaging is as follows.

$${\hat{a}}_{i} = Round ( {\sum }_{j = 0}^{2} \frac{{\tilde{w}}_{ij}}{{\sum }_{j = 0}^{2} {\tilde{w}}_{ij}} {\tilde{a}}_{j} )$$

In the above, \tilde{w}ᵢⱼ represents a spatial geometry weight from a nearest neighbouring point j to the current point i.

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}}$$

âᵢ represents an attribute prediction value of the current point i, j represents indexes of three nearest neighbouring points, ãⱼ represents a reconstructed attribute value of the nearest neighbouring point, xᵢ,yᵢ,zᵢ represent geometry position coordinates of the current point i, and xᵢⱼ, yᵢⱼ, zᵢⱼ represent geometry coordinates of the nearest neighbouring point j.

Exemplarily, Table 1 provides an example of samples of candidate predictors for attribute coding.

TABLE 1

| Prediction mode | Prediction value |
|---|---|
| 0 | Weighted average of attributes of |
| | three nearest neighbours |
| 1 | P4 (attribute value of first-nearest |
| | neighbour) |
| 2 | P5 (attribute value of second- |
| | nearest neighbour) |
| 3 | P0 (attribute value of third-nearest |
| | neighbour) |

### (ii) Attribute Prediction Residual and Quantization

The attribute prediction value (âᵢ)_{i∈0 . . . k-1} (where k is the total point number of the point cloud) of the current point i is obtained through the above prediction. Assuming that (aᵢ)_{i∈0 . . . k-1} is an original attribute value of the current point, an attribute residual (rᵢ)_{i∈0 . . . k-1} is denoted as:

$${r}_{i} = {a}_{i} - {\hat{a}}_{i}$$

Further, a prediction residual is quantized:

$${Q}_{i} = \frac{{r}_{i}}{Qs}$$

Qᵢ represents a quantized attribute residual of the current point i. Qs is a quantization step (Qs), which can be calculated from a quantization parameter (QP) specified in CTC.

(iii) Reconstruction of an Attribute Value at the Encoding End

The purpose of reconstruction at the encoding end is for prediction of a subsequent point(s). Before reconstruction of the attribute value, inverse quantization needs to be performed on a residual. îᵢ is denoted as an inverse-quantized residual:

$${\hat{r}}_{i} = {Q}_{i} \times Qs$$

A reconstructed value ãᵢ of the point i is obtained by adding \hat{r}ᵢ and the prediction value ãᵢ.

$${\tilde{a}}_{i} = {\hat{r}}_{i} + {\hat{a}}_{i}$$

There are currently two main categories of algorithms for attribute nearest-neighbour search based on LOD partitioning: intra nearest-neighbour search and inter nearest-neighbour search. An algorithm for inter nearest-neighbour search will be described in detail below, and intra nearest-neighbour search can be classified into inter-layer nearest-neighbour search and intra-layer nearest-neighbour search.

### (i) Intra Nearest-Neighbour Search

For intra nearest-neighbour search, there are two algorithms: inter-layer nearest-neighbour search and intra-layer nearest-neighbour search. After LOD partitioning, it resembles a pyramid structure, as illustrated in FIG. 23.

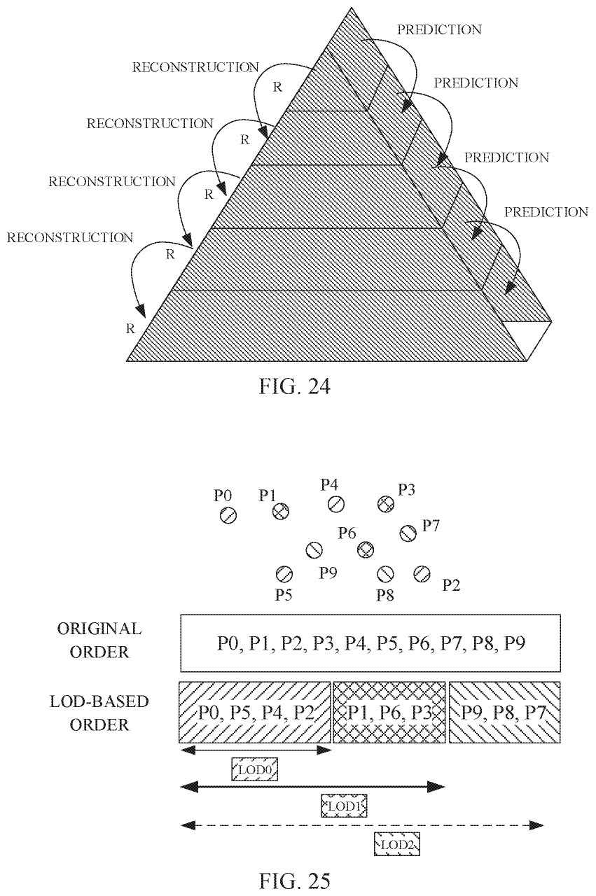

In a specific implementation, for inter-layer nearest-neighbour search, a pyramid structure is illustrated in FIG. 24. FIG. 25 is a schematic diagram illustrating an LOD construction process for inter-layer nearest-neighbour search. As illustrated in FIG. 25, different LOD layers, LOD0, LOD1, and LOD2, are obtained through partitioning based on geometry information. A point in LOD0 is used for prediction of an attribute of a point in a next LOD layer during inter-layer nearest-neighbour search.

The whole process of intra nearest-neighbour search will be described in detail below.

In the whole LOD partitioning process, there are three sets: O(k), L(k), and I(k). Herein, k is an index of an LOD layer during LOD partitioning, and I(k) is an input point set during partitioning of a current LOD layer. After LOD partitioning, sets O(k) and L(k) are obtained. The set O(k) stores a set of sampling points, and L(k) is a set of points in the current LOD layer. That is, the whole LOD partitioning process is as follows.

```
(1) Initialization
if k=0, (k)←{ }. Otherwise, (k)←L(k-1);
  O(k)←{ };
  (2) According to an LOD partitioning algorithm, sampling points are
stored in O(k), and remaining points are partitioned into L(k).
  (3) When the next iteration proceeds, I←O(k).
```

It may be noted herein that, since the whole LOD partitioning is performed based on Morton codes, Morton code indexes corresponding to points are stored in O(k), L(k), and I(k).

During inter-layer nearest-neighbour search, i.e., nearest-neighbour search for points in the set L(k) in the set O(k), a search algorithm is as follows.

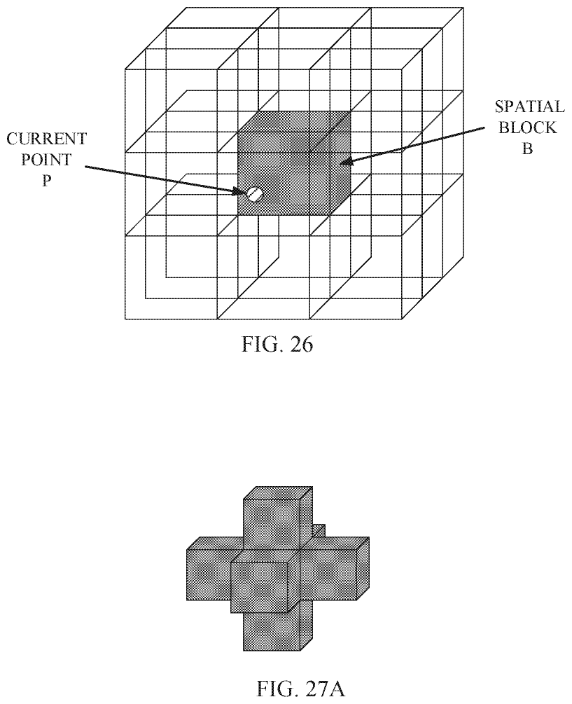

Taking nearest-neighbour search based on a spatial relationship as an example, during prediction of current point P, a parent block (block B) corresponding to point P is used for neighbour search, as illustrated in FIG. 26, and points in a neighbouring block that is coplanar or collinear with the current parent block are searched for attribute prediction.

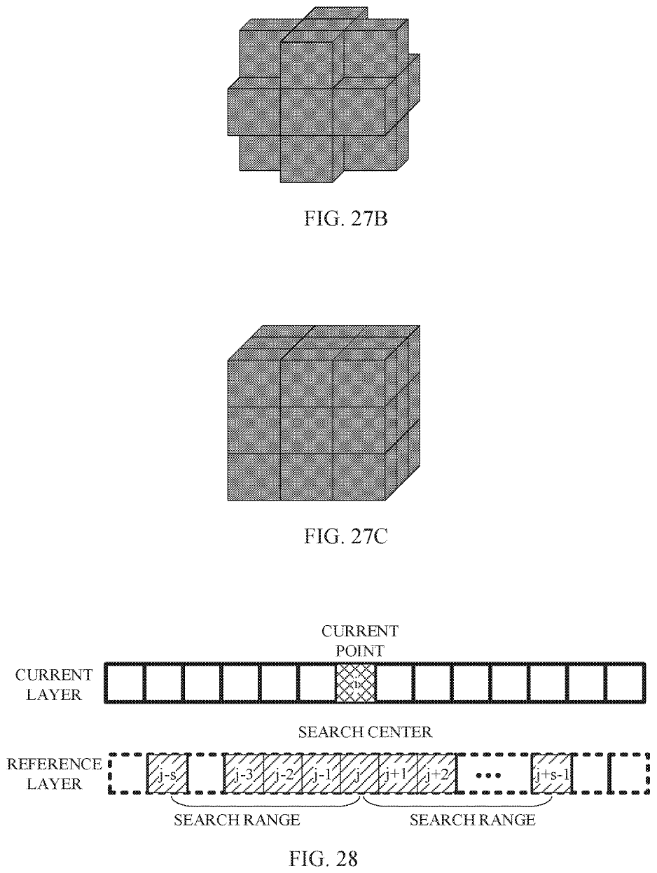

FIG. 27A is a schematic diagram illustrating a coplanar spatial relationship, where there are a total of 6 spatial blocks having a relationship with the current parent block. FIG. 27B is a schematic diagram illustrating a coplanar or collinear spatial relationship, where there are a total of 18 spatial blocks having a relationship with the current parent block. FIG. 27C is a schematic diagram illustrating a coplanar, collinear, or concurrent spatial relationship, where there are a total of 26 spatial blocks having a relationship with the current parent block.

First, a corresponding spatial block is obtained based on coordinates of a current point. Second, N nearest neighbours of the current point are obtained through nearest-neighbour search for a spatial block that is coplanar, collinear, or concurrent with a current block in a previously-encoded LOD layer.

After the coplanar, collinear, or concurrent nearest-neighbour search, if the N nearest neighbours of the current point are still not obtained, then the N nearest neighbours of the current point may be obtained based on a fast search algorithm. A specific algorithm is as follows.

As illustrated in FIG. 28, during attribute inter-layer prediction, a Morton code of a current point to-be-encoded is first obtained based on geometry coordinates of the current point. Next, based on the Morton code of the current point, the first reference point (j) with Morton code greater than the Morton code of the current point is found in a reference picture. Then, nearest-neighbour search is performed within a range of [j−searchRange, j+searchRange].

Other specific algorithms for updating nearest neighbours are the same as the algorithm for inter nearest-neighbour search and will not be described in detail herein. The specific algorithms will be mentioned in the algorithm for inter nearest-neighbour search.

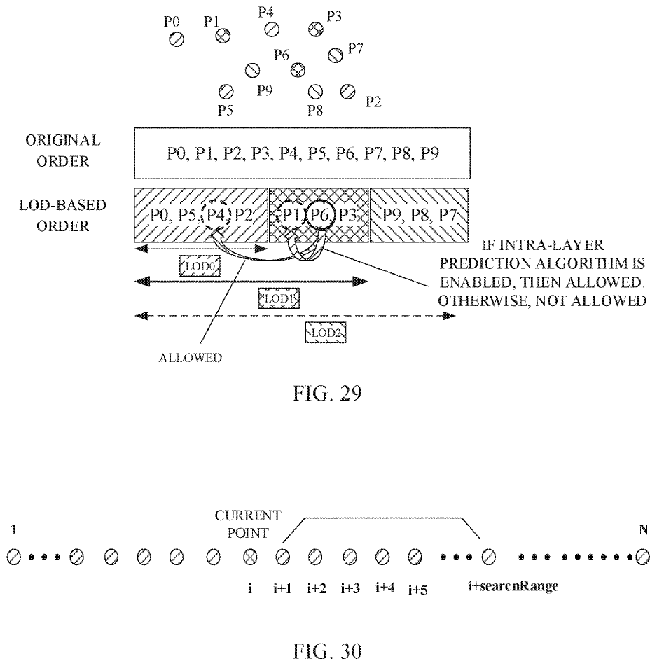

In another specific implementation, for intra-layer nearest-neighbour search, FIG. 29 is a schematic diagram of an LOD structure for attribute intra-layer nearest-neighbour search. As illustrated in FIG. 29, if an intra-layer prediction algorithm is enabled, that is, a syntax element EnableRefferingSameLoD=1, then nearest-neighbour search may be allowed within a layer, for example, a nearest neighbouring point of current point P6 may be P1 in LOD1, and nearest-neighbour search is not allowed in other layers. If the syntax element EnableRefferingSameLoD=0, then inter-layer search is allowed in other layers, for example, the nearest neighbouring point of current point P6 may be P4 in LOD1. In other words, when the intra-layer prediction algorithm is enabled, nearest-neighbour search is performed in a set of encoded points in the same layer within the same LOD layer, to obtain N nearest neighbours of the current point (inter-layer nearest-neighbour search is also performed).

During attribute intra-layer prediction, nearest-neighbour search is performed based on a fast search algorithm. A specific algorithm is illustrated in FIG. 30. A current point is represented by grids. Assuming that a Morton code index of the current point is i, then nearest-neighbour search is performed in [i+1, i+searchRange]. A specific algorithm for nearest-neighbour search is the same as an inter block-based fast search algorithm and will not be described in detail herein.

### (ii) Inter Nearest-Neighbour Search

FIG. 28 is a schematic diagram illustrating attribute inter prediction. As illustrated in FIG. 28, during attribute inter prediction, a Morton code of a current point to-be-encoded is first obtained based on geometry coordinates of the current point. Next, based on the Morton code of the current point, the first reference point (j) with Morton code greater than the Morton code of the current point is found in a reference picture. Then, nearest-neighbour search is performed within a range of [j−searchRange, j+searchRange].

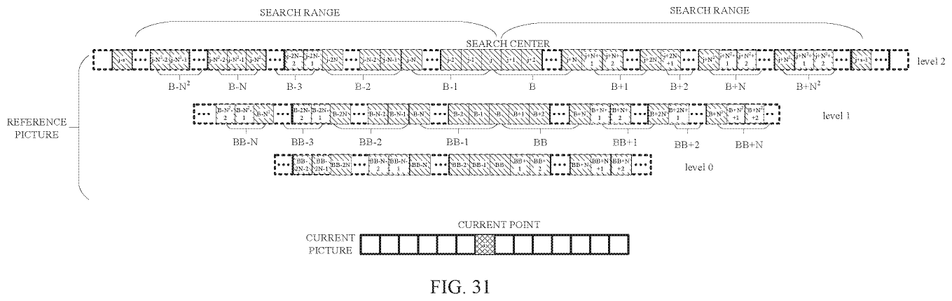

Currently, during intra and inter nearest-neighbour search, neighbourhood search is performed based on a block. For details, reference can be made to FIG. 31. As illustrated in FIG. 31, during neighbourhood search for a current point (with a Morton code index i), points in a reference picture are first partitioned into N (N=3) layers according to Morton codes. A specific partitioning algorithm is as follows.

For the first layer, assuming that the number of points in the reference picture are numPoints, the points in the reference picture are first partitioned into one block every M (M=2⁵=32) points.

For the second layer, based on the first layer, blocks in the first layer are also partitioned into one block every M (M=2⁵=32) blocks in the order of Morton codes.

For the third layer, based on the second layer, blocks in the second layer are also partitioned into one block every M (M=2⁵=32) blocks in the order of Morton codes.

Finally, a prediction structure illustrated in FIG. 31 is obtained.

During attribute prediction based on the prediction structure illustrated in FIG. 31, assuming that a Morton code index of a current point to-be-encoded is i, the first point with Morton code greater than or equal to the Morton code of the current point is first obtained in the reference picture, and an index of the first point is j. Then, a block index of a reference point is calculated based on j. The specific calculation method is as follows.

For the first layer, BucketSize_0=2⁵=32.
For the second layer, BucketSize_1=2⁵=32×BucketSize_0=1024.
For the third layer, BucketSize_2=2⁵=32×BucketSize_1=32768.

Assuming that a reference range of a prediction picture of the current point is [j−searchRange, j+searchRange], a start index of the third layer is calculated based on j−searchRange, and an end index of the third layer is calculated based on j+searchRange. Next, whether nearest-neighbour search is needed for some blocks in the second layer is first determined in blocks in the third layer. Then, proceed to the second layer, and whether the search is needed for each block in the first layer is determined. If nearest-neighbour search is needed for some blocks in the first layer, then point-by-point determination is performed on points in those blocks in the first layer to update a nearest neighbour(s).

The following will introduce an algorithm for index-based block calculation. Assuming that a Morton code index of a current point is index, then an index of a corresponding block in the third layer is:

$$idx\_ 2 = index / BucketSize\_ 2$$

After the index idx_2 of the block in the third layer is obtained, a start index and an end index of a block corresponding to a current block in the second layer can be obtained based on idx_2.

$$startIdx 1 = idx\_ 2 \times BucketSize\_ 1$$

$$endIdx = idx\_ 2 \times BucketSize\_ 1 + BucketSize\_ 1 - 1$$

Similarly, based on the same algorithm, an index of a block in the first layer is obtained based on an index of a block in the second layer.

During block-based nearest-neighbour search, whether nearest-neighbour search is needed for the current block is first determined, that is, to filter blocks for nearest-neighbour search. Each spatial block can be obtained based on two variables minPos and maxPos, where minPos represents a minimum value of the block, and maxPos represents a maximum value of the block.

It is assumed that a distance of the farthest point among N nearest neighbours found for the current point is Dist, coordinates of a point to-be-encoded are (x, y, z), and the current block is represented by (minPos, maxPos), where minPos is a minimum value of a bounding box in three dimensions, and maxPos is a maximum value of the bounding box in three dimensions. In this case, a distance D between the current point and the bounding box is calculated as follows:

$$int dx = int ( std \text{::} max ( std \text{::} max ( min Pos [ 0 ] - point [ 0 ] , 0 ) , point [ 0 ] - max Pos [ 0 ] ) ) ;$$

$$int dy = int ( std \text{::} max ( std \text{::} max ( min Pos [ 1 ] - point [ 1 ] , 0 ) , point [ 1 ] - max Pos [ 1 ] ) ) ;$$

$$int dz = int ( std \text{::} max ( std \text{::} max ( min Pos [ 2 ] - point [ 2 ] , 0 ) , point [ 2 ] - max Pos [ 2 ] ) ) ;$$

$$D = dx + dy + dz ;$$

points in the current block are traversed only when D is less than or equal to Dist.

### (b) Lifting Transform Coding of Attribute Information of a Point Cloud

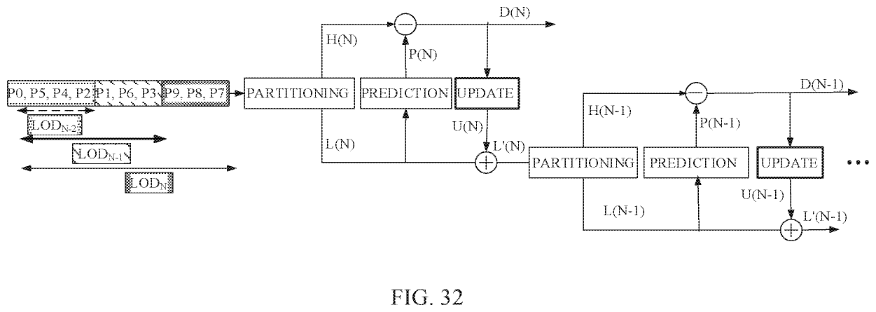

FIG. 32 is a schematic flowchart of lifting transform coding. Lifting transform also refers to predictive coding of attributes of the point cloud based on LOD. Different from predicting transform, in lifting transform, LOD is first partitioned into high and low layers, prediction is performed in the reverse order of LOD generation layers, and an update operator is introduced in the prediction process to update quantization weights of points in the low LOD layer, thereby improving the accuracy of prediction. This is because the points in the low LOD layer are more influential since attribute values of the points in the low LOD layer are frequently used for prediction of attribute values of points in the high LOD layer.

### Step 1, Partitioning Process

In the partitioning process, the complete LOD is partitioned into a low LOD layer(s) L(N) and a high LOD layer(s) H(N). If a point cloud has three LOD layers, that is, (LODₗ)_{l=0, 1, 2}, then after partitioning, LOD₂ is the high LOD layer and denoted as H(N), and (LODₗ)_{l=-0, 1} is the low LOD layer and denoted as L(N).

### Step 2, Prediction Process

For a point in the high LOD layer, attribute information of a nearest neighbouring point is selected from the low layer as an attribute prediction value P(N) of a current point to-be-encoded, and a prediction residual D(N) is denoted as:

$$D ( N ) = H ( N ) - P ( N )$$

### Step 3, Update Process

The attribute prediction residual D(N) of the high LOD layer is updated to obtain U(N), and an attribute value of a point in the low LOD layer is lifted based on U(N), as illustrated in the following formula:

$${L}^{′} ( N ) = L ( N ) + U ( N )$$

In the descending order of LODs, the above processes will be continuously iterated until the lowest LOD layer.

Since the LOD-based prediction scheme makes points in the low LOD layer more influential, a quantization weight is introduced in a transform scheme based on lifting wavelet transform, a prediction residual is updated based on the prediction residual D(N) and a distance between a prediction point and a neighbouring point, and finally the prediction residual is adaptively quantized by using a quantization weight during transform. It may be noted herein that, a quantization weight of each point may be determined through geometry reconstruction at the decoding end, and thus the quantization weight does not need to be encoded.

### (c) RAHT

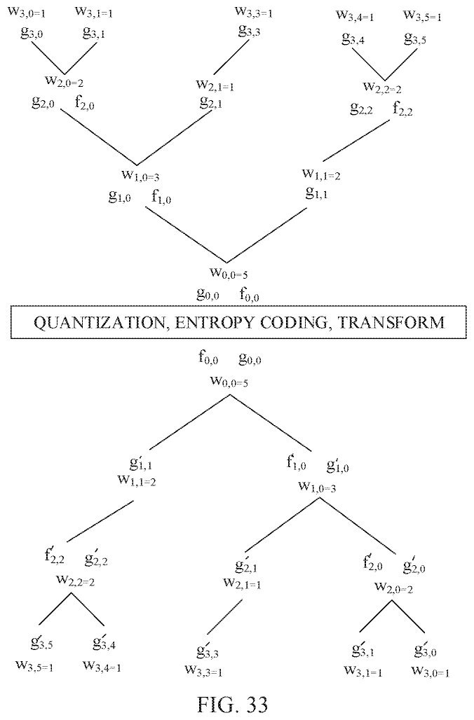

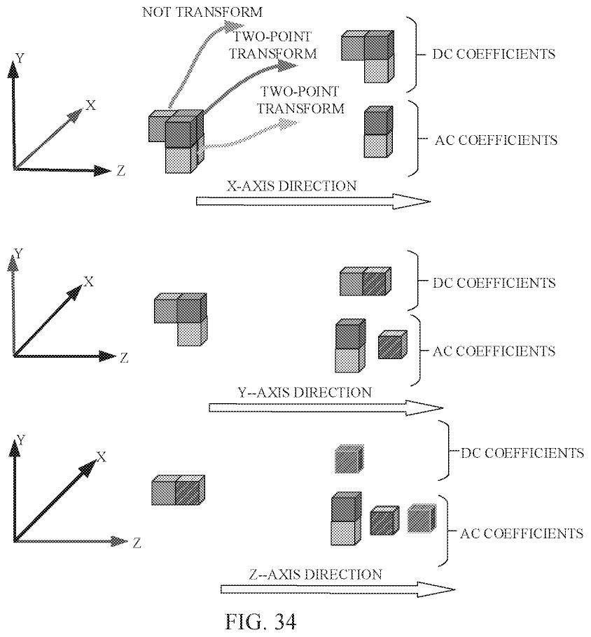

RAHT is a Haar wavelet transform in which attribute information of the point cloud may be transformed from the spatial domain to the frequency domain, further reducing correlation between attributes of the point cloud. The main idea of RAHT is to transform nodes in each layer in x, y, and z dimensions in a bottom-up manner according to an octree structure (as illustrated in FIG. 34), and this process is iterated until a root node of the octree is reached. As illustrated in FIG. 33, the basic idea is to perform wavelet transform based on a hierarchical structure of an octree, associate attribute information with octree nodes, perform recursive transform on attributes of an occupied node(s) in the same parent node in a bottom-up manner, and perform transform on nodes in each layer in x, y, and z dimensions until the root node of the octree is reached. During hierarchical transform, low-pass/low-frequency (DC) coefficients obtained after transform of nodes in the same layer are transmitted to nodes in the next layer for further transform, and all high-pass/high-frequency (an alternating current (AC)) coefficients may be encoded using an arithmetic encoder.

In the transform process, transformed DC coefficients (direct-current components) of the nodes in the same layer are transmitted the previous layer for further transform, and transformed AC coefficients (alternating-current components) of each layer are quantized and encoded. The main transform process will be described below.

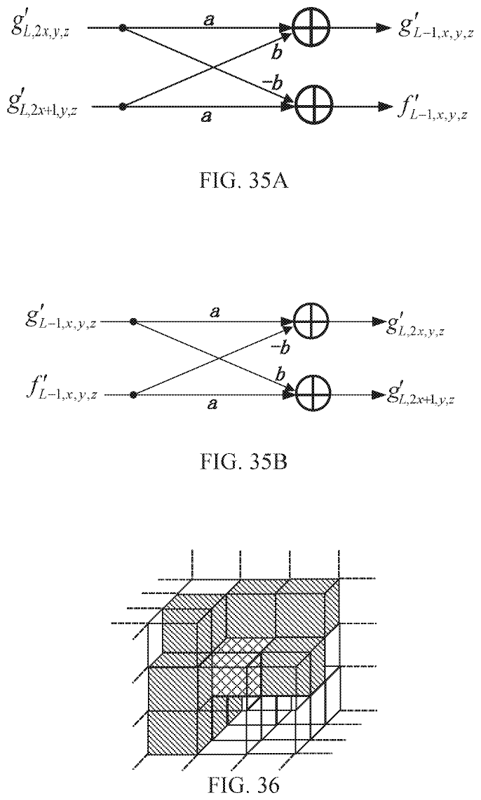

FIG. 35A is a schematic diagram illustrating RAHT forward transform, and FIG. 35B is a schematic diagram illustrating RAHT inverse transform. For the transform and inverse transform processes of RAHT, it is assumed that

$${g}_{L , 2 x , y , z}^{′} and {g}_{L , 2 x + 1 , y , z}^{′}$$

are attribute DC coefficients of two neighbouring points in layer L. After linear transformation, information of layer L−1 includes an AC coefficient

$${f}_{L - 1 , x , y , z}^{′}$$

and a DC coefficient

$${g}_{L - 1 , x , y , z}^{′} . Then , {f}_{L - 1 , x , y , z}^{′}$$

is no longer transformed and is diretly quantized and encoded. For

$${g}_{L - 1 , x , y , z}^{′} ,$$

a nearest neighbour continues to be searched for the transform. If no nearest neighbour is found,

$${g}_{L - 1 , x , y , z}^{′}$$

may be directly transmitted to layer L−2. That is, RAHT transform is valid for only nodes with neighbouring points, and nodes without neighbouring points will be directly transmitted to the previous layer. In the above transform process, if weights (the number of non-empty child nodes in the node) corresponding to

$${g}_{L , 2 x , y , z}^{′} and {g}_{L , 2 x + 2 , y , z}^{′}$$

are respectively

$${w}_{L , 2 x , y , z}^{′} and {w}_{L , 2 x + 1 , y , z}^{′}$$

(respectively abbreviated as

$${w}_{0}^{′} and {w}_{1}^{′} ) ,$$

and a weight corresponding to

$${g}_{L - 1 , x , y , z}^{′} is {w}_{L - 1 , x , y , z}^{′} ,$$

then the general transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ]$$

In the above, T_{w0, w1} is a transform matrix:

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ]$$

The transform matrix is adaptively updated based on a weight corresponding to each point. The above process is iteratively updated according to a partitioning structure of an octree until the root node of the octree is reached.

In a specific implementation, for region adaptive hierarchical intra prediction transform coding, prediction may be performed based on RAHT transform coding. As illustrated in FIG. 33, RAHT attribute transform is based on a hierarchical order of an octree, and the transform proceeds from the voxel level until a root node is obtained, thereby completing hierarchical transform coding of the whole attribute. In prediction transform coding, attribute prediction transform coding is also performed based on the hierarchical order of the octree, but the transform proceeds from the root node down to the voxel level. In each RAHT attribute transform process, attribute prediction transform coding is performed based on a 2×2×2 block. Details are illustrated in FIG. 36. As illustrated in FIG. 36, it can be seen that a grid-filled block is a current block to-be-encoded, and blocks filled with diagonal lines are some neighbouring blocks that are coplanar or collinear with the current block to-be-encoded. An attribute of the current block is normalized in the following manner:

$${A}_{node} = {\sum }_{p ∈ node} attribute ( p ) ;$$

$${w}_{node} = {\sum }_{p ϵ node} 1 = \{ p ∈ node \} ;$$

$${a}_{node} = {A}_{node} / {w}_{node} .$$

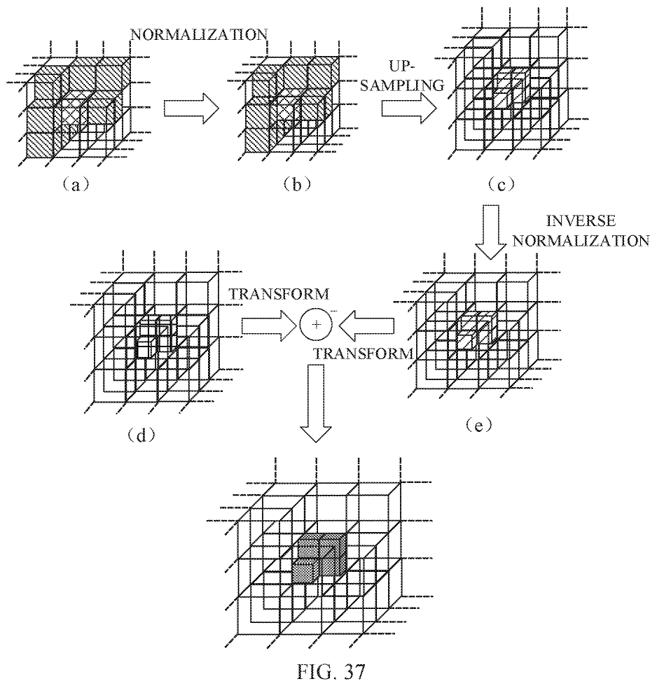

First, the attribute of the current block, i.e., A_{node}, can be obtained based on attributes of points contained in the current block. The attributes of the points contained in the current block are added simply, and then the attribute of the current block is normalized with the number of points in the current block, to obtain an average a_{node} of the attribute of the current block. Attribute transform coding is performed based on the average of the attribute of the current block. For the specific coding process, reference can be made to FIG. 37.

An overall process of RAHT attribute prediction transform coding is illustrated in FIG. 37. Herein, (a) illustrates the current block and some coplanar and collinear neighbouring blocks, (b) illustrates a normalized block, (c) illustrates an up-sampled block, (d) illustrates the attribute of the current block, and (e) illustrates attributes of a prediction block obtained by performing linear weighted fitting based on neighbourhood attributes of the current block. Finally, attribute transform is performed on both (d) and (e) to obtain DC and AC coefficients, and predictive coding is performed on the AC coefficients.

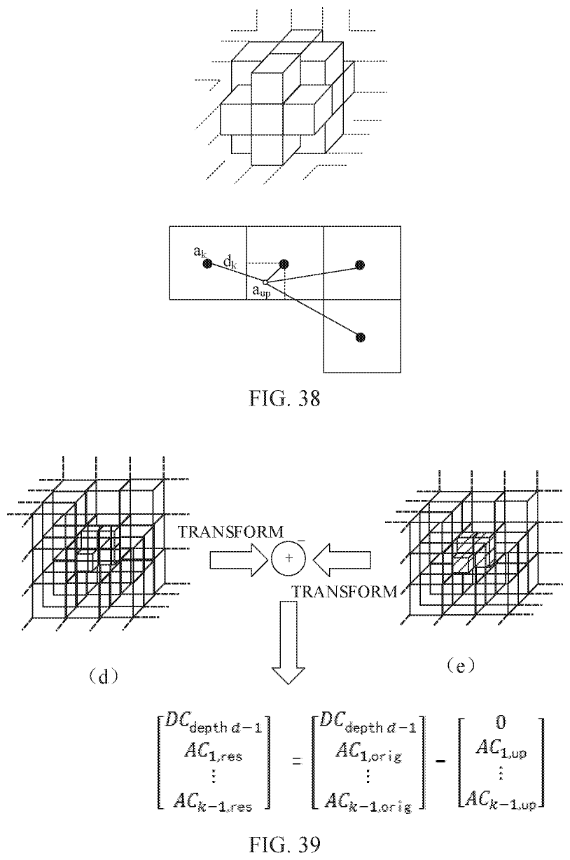

A predicted attribute of the current block can be obtained through linear fitting as illustrated in FIG. 38. As illustrated in FIG. 38, 19 neighbourhood blocks of the current block are first obtained, then linear weighted prediction is performed on an attribute of each sub-block based on spatial geometry distances between the neighbourhood blocks and each sub-block of the current block, and finally, transform is performed based on an attribute of a prediction block obtained through linear weighting. The specific attribute transform is illustrated in FIG. 39.

In FIG. 39, (d) represents an original attribute value, and corresponding attribute transform coefficients are as follows:

$$[ \begin{matrix}* \\ {AC}_{1 , orig} \\ ⋮ \\ {AC}_{k - 1 , orig}\end{matrix} ] = {T}_{node} [ \begin{matrix}{A}_{1} , orig / \sqrt{{w}_{1}} \\ ⋮ \\ {A}_{k , orig} / \sqrt{{w}_{k}}\end{matrix} ]$$

(e) represents an attribute prediction value, and corresponding attribute transform coefficients are as follows:

$$[ \begin{matrix}* \\ {AC}_{1 , up} \\ ⋮ \\ {AC}_{k - 1 , up}\end{matrix} ] = {T}_{node} [ \begin{matrix}{A}_{1 , up} / \sqrt{{w}_{1}} \\ ⋮ \\ {A}_{k , up} / \sqrt{{w}_{k}}\end{matrix} ]$$

By subtracting the attribute prediction value from the original attribute value, a prediction residual can be obtained as follows:

$$[ \begin{matrix}{DC}_{depth d - 1} \\ {AC}_{1 , res} \\ ⋮ \\ {AC}_{k - 1 , res}\end{matrix} ] = [ \begin{matrix}{DC}_{depth d - 1} \\ {AC}_{1 , orig} \\ ⋮ \\ {AC}_{k - 1 , orig}\end{matrix} ] - [ \begin{matrix}0 \\ {AC}_{1 , up} \\ ⋮ \\ {AC}_{k - 1 , up}\end{matrix} ]$$

In another specific implementation, for region adaptive hierarchical inter prediction transform coding, in a G-PCC attribute inter prediction coding scheme, if inter prediction coding scheme is enabled, an RAHT attribute transform coding structure is first constructed based on geometry information of a current node to be coded. That is, the node merge proceeds from the voxel level until a root node of the whole RAHT transform tree is obtained, thereby completing a transform coding hierarchical structure of the whole attribute. Next, according to the RAHT attribute transform coding structure, the root node is partitioned to obtain N child nodes (where N is less than or equal to 8) of each node. Independent orthogonal transform is first performed on attributes of the N child nodes through RAHT transform to obtain DC and AC coefficients, and then attribute inter prediction is performed on the AC coefficients of the N child nodes in the following manners. A process is as follows.

If an inter prediction node of the current node is valid, that is, a collocated node exists, then an attribute of the prediction node is directly used as an attribute prediction value of the current node to be coded. The current node to be coded can also be understood as the current node.

For the current node, if a node at exactly the same position as the current node can be found in a buffer of a reference picture, that is, a collocated node exists, then AC coefficients of M child nodes contained in the collocated node may be directly used as attribute prediction values of AC coefficients of N child nodes of the current node.

It can be noted that, if an AC coefficient of a prediction node is not zero, then the AC coefficient of the prediction node is directly used as a prediction value of the AC coefficient.

If an inter prediction node of the current node is invalid, that is, no collocated node exists, then an attribute prediction value of an intra neighbouring node is used as the attribute prediction value of the node to be coded. Based on this, in the existing RAHT inter coding, an optimal RAHT coding mode, intra prediction coding or inter prediction coding, is selected for each layer. When a cost of the intra prediction coding mode is less than a cost of the inter prediction coding mode, RAHT intra prediction is performed on the current layer. Otherwise, RAHT inter prediction is performed.

In the G-PCC RAHT attribute inter prediction coding, in the case where inter attribute prediction coding is enabled, during inter prediction coding on an attribute of the current node, predictive coding is performed by using reconstructed attribute information of a collocated node in a reference picture. Specifically, a position of the node to be coded is used to obtain the collocated node (i.e., a node with the exact same spatial position) in the reference picture. If the collocated node can be found in the reference picture, an attribute of the collocated node is used for inter prediction on an attribute of the current node to be coded. Otherwise, intra prediction is performed on attribute information of the current node (i.e., an attribute prediction value of a neighboring node(s) in the picture is determined as an attribute prediction value of the current node). Based on this coding scheme, the efficiency of point cloud attribute coding can be further improved. Moreover, in the existing method, predictive coding is performed only according to the reconstructed attribute information of the collocated node in the reference picture, without considering other factors.

Based on the above analysis, in embodiments of the disclosure, a scheme for inter prediction coding based on a type of a coding unit is proposed. In this scheme, a concept of the type of the coding unit is first introduced in RAHT attribute inter prediction coding. Whether a unidirectional prediction list, a bidirectional prediction list, or no prediction list is used for reference is determined based on the type of the coding unit. Subsequently, attribute inter prediction coding is performed on an AC coefficient of the attribute of the current node to be coded based on a unidirectional or bidirectional reference list or a reconstructed attribute/reconstructed AC coefficient of the neighboring node(s) in the picture. Compared with the predictive coding scheme mentioned above, in this coding scheme, prediction can be performed on different coding units by using different prediction methods flexibly. As a result, for each node to be coded, a reference for inter prediction may differ from that in the original coding scheme, offering greater flexibility and diversity, thereby effectively improving coding efficiency.

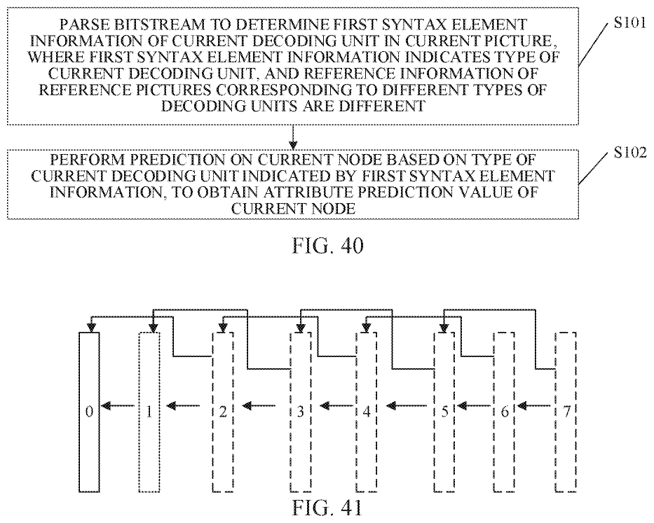

A decoding method is provided in embodiments of the disclosure. The decoding method is applied to a decoder. FIG. 40 is a schematic flowchart illustrating implementation of a decoding method provided in embodiments of the disclosure. As illustrated in FIG. 40, the decoding method includes the following operations at S101 to S102.

At S101, a bitstream is parsed to determine first syntax element information of a current decoding unit in a current picture, where the first syntax element information indicates a type of the current decoding unit, and reference information of reference pictures corresponding to different types of decoding units are different.

At S102, prediction is performed on a current node based on the type of the current decoding unit indicated by the first syntax element information to obtain an attribute prediction value of the current node.

In embodiments of the disclosure, for a point cloud decoding method, the decoder can parse the bitstream to obtain syntax element information and other decoding-related information, and then perform decoding processing on the current node.

A premise of implementing the decoding method provided in embodiments of the disclosure is that before the decoder decodes the current node, the decoder determines a type of a current decoding unit where the current node is located, and the decoder performs decoding processing in different manners based on the type of the current decoding unit where the current node is located.

In embodiments of the disclosure, the decoding unit is any one of a picture level, a tile level, a slice level, or an RAHT decoding layer level, which is not limited in embodiments of the disclosure.

It can be noted that, in embodiments of the disclosure, the decoder can decode multiple pictures in a current sequence according to a decoding order. For a decoding process of each picture, the decoder then parses each decoding unit until a node is parsed.

In embodiments of the disclosure, a decoding process of one node by the decoder is introduced as an example.

For S101, during the process of decoding the current node, the decoder can parse the bitstream to obtain the first syntax element information of the current decoding unit where the current node is located. The first syntax element information is generated by an encoder when encoding a current encoding unit. The first syntax element information indicates the type of the decoding unit. Therefore, the decoder can determine the type of the current decoding unit where the current node is located by parsing the first syntax element information in the bitstream.

It can be noted that, the type of the decoding unit may include three types: a first type, a second type, and a third type.

Reference information of reference pictures corresponding to the first type, the second type, and the third type are different. The reference information can be understood as the number of indices of reference index information.

In embodiments of the disclosure, the third type indicates that the current decoding unit has no reference index information, the second type indicates that the current decoding unit has at most one reference index information, and the first type indicates that the current decoding unit has at most two reference index information.

Exemplarily, in embodiments of the disclosure, a decoding unit of the first type can be represented as B decoding unit, a decoding unit of the second type can be represented as P decoding unit, and a decoding unit of the third type can be represented as I decoding unit. Exemplary definitions thereof are as follows.

I decoding unit: the current decoding unit has no reference index information.

P decoding unit: the current decoding unit has at most only one reference index information.

B decoding unit: the current decoding unit can have at most two reference index information.

For S102, since the decoder has determined the type of the current decoding unit, the decoder performs prediction, based on the type of the current decoding unit indicated by the first syntax element information, on the current node by using reference index information corresponding to the type of the current decoding unit, to obtain the attribute prediction value of the current node.

In embodiments of the disclosure, different types of decoding units correspond to different reference information of reference pictures. Therefore, for a decoding unit of a different type, the decoder can perform decoding processing in a different form on nodes contained in the decoding unit.

It can be understood that, during determination of the attribute prediction value of the current node, the type of the current decoding unit is first determined, and then different predictions are performed based on the type of the current decoding unit, so as to determine the attribute prediction value of the current node. In this way, the decoder can perform targeted and diverse attribute predictions based on different types of decoding units, thereby improving the accuracy of inter attribute prediction.

In embodiments of the disclosure, when the current decoding unit is of the first type, the decoding method may further include the following operations at S1021 to S1024.

At S1021, when the type of the current decoding unit indicated by the first syntax element information is the first type, two reference index information of the current decoding unit are parsed and determined.

At S1022, a first reference picture and a second reference picture are determined based on the two reference index information.

At S1023, a first collocated node of a parent node of the current node in the first reference picture and a second collocated node of the parent node of the current node in the second reference picture are searched for according to obtained geometry information of the current node.

At S1024, inter attribute prediction is performed on the current node according to the first collocated node and the second collocated node, to obtain the attribute prediction value of the current node.

In embodiments of the disclosure, when the first syntax element information indicates that the type of the current decoding unit is the first type, it means that two reference index information can be used for prediction on all nodes in the current decoding unit. Therefore, the decoder can parse the bitstream to obtain the two reference index information of the current decoding unit transmitted by the encoder. The decoder can determine, according to the two parsed reference index information, information of both the corresponding first reference picture and the corresponding second reference picture from at least one reference list. Then, the decoder searches for, according to the geometry information of the current node, the first collocated node of the parent node of the current node in the first reference picture and the second collocated node of the parent node of the current node in the second reference picture.

It can be noted that, in embodiments of the disclosure, the decoding method provided in embodiments of the disclosure can be used for all nodes other than a first root node. For a root node without a parent node, prediction can be implemented by directly searching for a collocated node of the root node in the reference picture, which is not limited in embodiments of the disclosure.

In embodiments of the disclosure, the decoder can first determine the parent node of the current node according to the geometry information of the current node.

In embodiments of the disclosure, the first collocated node refers to a node in the first reference picture that has the same geometry information/geometry coordinates as the parent node of the current node, and the second collocated node refers to a node in the second reference picture that has the same geometry information/geometry coordinates as the parent node of the current node. In embodiments of the disclosure, the current picture, the first reference picture, and the second reference picture can be understood as different point cloud pictures.

In embodiments of the disclosure, a relationship between the first reference picture, the second reference picture, and the current picture is not limited. The first reference picture and the second reference picture may be two forward pictures of the current picture, or may be two backward pictures of the current picture. Alternatively, the first reference picture may be a forward reference picture of the current picture, and the second reference picture may be a backward reference picture of the current picture.

In embodiments of the disclosure, the decoder performs inter attribute prediction on the current node according to the first collocated node and the second collocated node, to obtain the attribute prediction value of the current node as follows.

Manner 1, when the first collocated node is present in the first reference picture and the second collocated node is present in the second reference picture, the attribute prediction value of the current node is determined according to a reconstructed attribute value of a first child node of the first collocated node and a reconstructed attribute value of a second child node of the second collocated node.

Manner 2, when the first collocated node is absent in the first reference picture and the second collocated node is present in the second reference picture, the attribute prediction value of the current node is determined according to the reconstructed attribute value of the second child node of the second collocated node.

Manner 3, when the first collocated node is present in the first reference picture and the second collocated node is absent in the second reference picture, the attribute prediction value of the current node is determined according to the reconstructed attribute value of the first child node of the first collocated node.

Manner 4, when the first collocated node is absent in the first reference picture and the second collocated node is absent in the second reference picture, the attribute prediction value of the current node is determined according to a reconstructed attribute value of at least one neighbourhood node of the current node in the current picture.

It can be noted that, in embodiments of the disclosure, the parent node of the current node is used for determining the collocated node in the reference picture. However, when it is determined that the collocated node is present, multiple child nodes of the collocated node are determined based on independent orthogonal transform of the collocated node, a prediction node of the current node is determined from the multiple child nodes, and then a reconstructed attribute value of the prediction node is used for determining the attribute prediction value of the current node.

For Manner 1, the reconstructed attribute value of the first child node of the first collocated node and the reconstructed attribute value of the second child node of the second collocated node are weighted according to a first weighting coefficient for the reconstructed attribute value of the first child node of the first collocated node and a second weighting coefficient for the reconstructed attribute value of the second child node of the second collocated node, to obtain the attribute prediction value of the current node.

The first weighting coefficient is equal to a first value, and the second weighting coefficient is equal to a second value.

In some embodiments of the disclosure, the first weighting coefficient is determined according to an interval between a collection time of the current picture and a collection time of the first reference picture, or the first weighting coefficient is determined according to the geometry information of the current node and attribute distribution information of the first child node.

In some embodiments of the disclosure, the second weighting coefficient is determined according to an interval between a collection time of the current picture and a collection time of the second reference picture, or the second weighting coefficient is determined according to the geometry information of the current node and attribute distribution information of the second child node.

In some embodiments of the disclosure, the bitstream is parsed to obtain the first weighting coefficient and the second weighting coefficient.

In some embodiments of the disclosure, the bitstream is parsed to obtain a first weighting coefficient index and a second weighting coefficient index. The first weighting coefficient and the second weighting coefficient are determined from a coefficient list based on the first weighting coefficient index and the second weighting coefficient index.

Exemplarily, in some embodiments, the first weighting coefficient is equal to the first value, and the second weighting coefficient is equal to the second value. That is, the first weighting coefficient and the second weighting coefficient are predefined values, and may be equal or not equal, but a sum of the first weighting coefficient and the second weighting coefficient is equal to 1.

In some other embodiments, the first weighting coefficient can be determined according to the interval between the collection time of the current picture and the collection time of the first reference picture, and/or the second weighting coefficient can be determined according to the interval between the collection time of the current picture and the collection time of the second reference picture. For example, a longer interval leads to a smaller value of a weighting coefficient. Assuming that the interval between the collection time of the current picture and the collection time of the first reference picture is longer than the interval between the collection time of the current picture and the collection time of the second reference picture, then the first weighting coefficient is less than the second weighting coefficient.

In some embodiments, a mapping table between an interval between collection times and a weighting coefficient may be predefined, such that the decoder can determine the first weighting coefficient and the second weighting coefficient by looking up the table based on weighting coefficient indices. Certainly, the weighting coefficient is not limited to being determined based on the table lookup method, and in conclusion, a corresponding weighting coefficient can be determined according to an interval between collection times of two pictures.

In yet some other embodiments, the encoder may determine the first weighting coefficient and the second weighting coefficient as follows. Rate-distortion costs of multiple candidate weighting coefficient groups are determined, where each of the multiple candidate weighting coefficient groups contains a first candidate weighting coefficient for a reconstructed attribute value of the first collocated node and a second candidate weighting coefficient for a reconstructed attribute value of the second collocated node. A candidate weighting coefficient group with the minimum rate-distortion cost is selected from the multiple candidate weighting coefficient groups. A first candidate weighting coefficient in the candidate weighting coefficient group with the minimum rate-distortion cost is determined as the first weighting coefficient, and a second candidate weighting coefficient in the candidate weighting coefficient group with the minimum rate-distortion cost is determined as the second weighting coefficient.

It can be understood that, at an encoding end, since an actual attribute value of the current node is known, the rate-distortion costs of the candidate weighting coefficient groups can be determined. Correspondingly, the method further includes the following. The encoder signals the first weighting coefficient and the second weighting coefficient obtained based on the rate-distortion costs into the bitstream. The decoder parses the bitstream to obtain the first weighting coefficient and the second weighting coefficient. The method further includes the following. The encoder determines a first weighting coefficient index of the first weighting coefficient obtained based on the rate-distortion costs and a second weighting coefficient index of the second weighting coefficient obtained based on the rate-distortion costs, and then signals the first weighting coefficient index and the second weighting coefficient index into the bitstream. As such, the decoder can parse the bitstream to obtain the first weighting coefficient index and the second weighting coefficient index.

In the foregoing embodiments, the method for determining the attribute prediction value of the current node when both the first collocated node and the second collocated node are present is described. It can be understood that, the first collocated node may be absent in the first reference picture, and/or the second collocated node may be absent in the second reference picture. In this case, the attribute prediction value of the current node cannot be obtained by performing inter attribute prediction on the current node according to the first collocated node and the second collocated node.

For Manner 2, when the first collocated node is absent in the first reference picture and the second collocated node is present in the second reference picture, the attribute prediction value of the current node is equal to the reconstructed attribute value of the second child node of the second collocated node.

For Manner 3, when the first collocated node is present in the first reference picture and the second collocated node is absent in the second reference picture, the attribute prediction value of the current node is equal to the reconstructed attribute value of the first child node of the first collocated node.

In some embodiments of the disclosure, the implementation of Manner 1 or S1024 may further include the following.

At S201, when the first collocated node is present in the first reference picture and the second collocated node is present in the second reference picture, a first difference number of occupied child nodes between the first collocated node and the parent node of the current node is determined according to occupancy information of the first collocated node and occupancy information of the parent node of the current node.

At S202, a second difference number of occupied child nodes between the second collocated node and the parent node of the current node is determined according to occupancy information of the second collocated node and the occupancy information of the parent node of the current node.

At S203, the first weighting coefficient for the reconstructed attribute value of the first child node of the first collocated node and the second weighting coefficient for the reconstructed attribute value of the second child node of the second collocated node are determined according to a relationship between the first difference number and the second difference number.

At S204, the reconstructed attribute value of the first child node of the first collocated node and the reconstructed attribute value of the second child node of the second collocated node are weighted by using the first weighting coefficient and the second weighting coefficient, to determine the attribute prediction value of the current node.

In some embodiments, determining the first weighting coefficient for the reconstructed attribute value of the first child node of the first collocated node and the second weighting coefficient for the reconstructed attribute value of the second child node of the second collocated node according to the relationship between the first difference number and the second difference number includes at least one of the following.
(1) When the first difference number is equal to the second difference number, it is determined that the first weighting coefficient is equal to the second weighting coefficient.
(2) When the first difference number is less than the second difference number, it is determined that the first weighting coefficient is greater than the second weighting coefficient.
(3) When the first difference number is greater than the second difference number, determined that the first weighting coefficient is less than the second weighting coefficient.

Exemplarily, in some embodiments, when the first difference number is less than the second difference number, the attribute prediction value of the current node is equal to the reconstructed attribute value of the first child node of the first collocated node, i.e., the first weighting coefficient is 1, and the second weighting coefficient is 0. When the first difference number is greater than the second difference number, the attribute prediction value of the current node is equal to the reconstructed attribute value of the second child node of the second collocated node, i.e., the first weighting coefficient is 0, and the second weighting coefficient is 1.

It can be noted that, the first child node is a prediction node corresponding to the current node after transformation of the first collocated node, and the second child node is a prediction node corresponding to the current node after transformation of the second collocated node.

It can be understood that, the occupancy information of the first collocated node, the occupancy information of the second collocated node, and the occupancy information of the parent node of the current node each record occupancy statuses of respective child nodes. A smaller difference number of occupied child nodes between the parent node of the current node and a collocated node indicates a stronger geometric correlation between two corresponding point clouds/two corresponding pictures. Correspondingly, a stronger attribute correlation between two corresponding point clouds/two corresponding pictures indicates a greater temporal redundancy existing therebetween. Therefore, when the first difference number of occupied child nodes between the first collocated node and the parent node of the current node is less than the second difference number of occupied child nodes between the second collocated node and the parent node of the current node, it indicates that there is greater temporal redundancy between the current picture and the first reference picture than between the current picture and the second reference picture. Therefore, in this case, the attribute prediction value of the current node can be determined according to the reconstructed attribute value of the first child node of the first collocated node. For example, the reconstructed attribute value of the first child node of the first collocated node is directly determined as the attribute prediction value of the current node. In this way, compared with determining the attribute prediction value of the current node according to the reconstructed attribute value of the second child node of the second collocated node in this case, temporal redundancy can be better compressed, thereby improving performance of point cloud coding. Similarly, when the first difference number is greater than the second difference number, the attribute prediction value of the current node is determined according to the reconstructed attribute value of the second child node of the second collocated node. In this way, compared with determining the attribute prediction value of the current node according to the reconstructed attribute value of the first child node of the first collocated node, temporal redundancy can be better compressed, thereby improving the performance of point cloud coding.

In embodiments of the disclosure, when the current decoding unit is of the second type, the decoding method may further include the following operations at S1025 to S1028.

At S1025, when the type of the current decoding unit indicated by the first syntax element information is the second type, one reference index information of the current decoding unit is parsed and determined.

At S1026, a third reference picture is determined based on the one reference index information.

At S1027, a third collocated node of a parent node of the current node in the third reference picture is searched for according to the obtained geometry information of the current node.

At S1028, inter attribute prediction is performed on the current node according to the third collocated node, to obtain the attribute prediction value of the current node.

In embodiments of the disclosure, when the first syntax element information indicates that the type of the current decoding unit is the second type, it means that one reference index information can be used for prediction on all nodes in the current decoding unit. Therefore, the decoder can parse the bitstream to obtain the one reference index information of the current decoding unit transmitted by the encoder. The decoder can determine, according to the one parsed reference index information, information of the corresponding third reference picture from the at least one reference list. Then, the decoder searches for the third collocated node of the parent node of the current node in the third reference picture according to the geometry information of the current node.

It can be noted that, in embodiments of the disclosure, the decoding method provided in embodiments of the disclosure can be used for all nodes other than a first root node. For a root node without a parent node, prediction can be implemented by directly searching for a collocated node of the root node in the reference picture, which is not limited in embodiments of the disclosure.

In embodiments of the disclosure, the decoder can first determine the parent node of the current node according to the geometry information of the current node.

In embodiments of the disclosure, the third collocated node refers to a node in the third reference picture that has the same geometry information/geometry coordinates as the parent node of the current node. In embodiments of the disclosure, the current picture and the third reference picture can be understood as different point cloud pictures. In some embodiments, arrangement structures of point clouds of the current picture and the third reference picture are RAHT attribute transform decoding structures.

In embodiments of the disclosure, the third reference picture is a forward reference picture of the current picture, or the third reference picture is a backward reference picture of the current picture, which is not limited in embodiments of the disclosure.

In embodiments of the disclosure, the decoder performs inter attribute prediction on the current node according to the third collocated node, to obtain the attribute prediction value of the current node as follows.
(1) When the third collocated node is present in the third reference picture, the attribute prediction value of the current node is determined according to a reconstructed attribute value of a third child node of the third collocated node.
(2) When the third collocated node is absent in the third reference picture, the attribute prediction value of the current node is determined according to a reconstructed attribute value of at least one neighbourhood node of the current node in the current picture.

Exemplarily, when the third collocated node is present in the third reference picture, the reconstructed attribute value of the third child node of the third collocated node is equal to the attribute prediction value of the current node.

In embodiments of the disclosure, when the current decoding unit is of the third type, the decoding method may further include the following. When the type of the current decoding unit indicated by the first syntax element information is the third type, the attribute prediction value of the current node is determined according to the reconstructed attribute value of the at least one neighbourhood node of the current node in the current picture.

In some embodiments of the disclosure, the reference index information needs to be determined by using a reference list. In embodiments of the disclosure, a process of establishing a reference list is provided.

In some embodiments of the disclosure, at least one first reference list is determined based on index information of decoded pictures, where the at least one first reference list indicates a mapping relationship from reference picture indices to storage positions.

In some embodiments of the disclosure, the at least one first reference list includes two first reference lists, and the reference index information includes reference list index information. The first reference picture and the second reference picture are determined based on the two reference index information as follows. A first reference picture index and a second reference picture index are determined from the two first reference lists according to respective reference list index information. The first reference picture and the second reference picture are determined based on the first reference picture index and the second reference picture index, respectively.

In some embodiments of the disclosure, the at least one first reference list includes one first reference list, and the reference index information includes reference list index information. The third reference picture is determined based on the one reference index information as follows. A third reference picture index is determined from the one first reference list according to one reference list index information. The third reference picture is determined based on the third reference picture index.

In some embodiments of the disclosure, at least one second reference list is determined based on the index information of the decoded pictures, where the at least one second reference list indicates a mapping relationship from reference pictures to storage positions.

In some embodiments of the disclosure, the at least one second reference list includes two second reference lists, and the reference index information includes reference picture index information. The first reference picture and the second reference picture are determined based on the two reference index information as follows. The first reference picture and the second reference picture are determined from the two second reference lists according to respective reference picture index information.

In some embodiments of the disclosure, the at least one second reference list includes one second reference list, and the reference index information includes reference picture index information. The third reference picture is determined based on the one reference index information as follows. The third reference picture is determined from the one second reference list according to one reference picture index information.

It can be noted that, the reference index information may be a reference list index, or may directly be a reference picture index. However, compared with the reference picture index, the transmission of the reference list index requires fewer codewords.

In embodiments of the disclosure, the decoder can construct at least one reference list, and the at least one reference list can be classified into a first reference list and a second reference list based on different mapping relationships. The construction manner of the reference list is not limited in embodiments of the disclosure.

In some embodiments of the disclosure, a current picture index of the current picture is determined. After the current picture is decoded, a next picture is continued to be decoded according to a decoding order until a current sequence is decoded, and picture indices of respective pictures are determined. Decoded respective pictures are arranged based on the picture indices of the respective pictures, to obtain a decoded sequence.

In some embodiments of the disclosure, the bitstream is parsed to determine second syntax element information of the current decoding unit, where the second syntax element information indicates the current picture index.

It can be noted that, in embodiments of the disclosure, the decoding order and a playback order of the current sequence may be inconsistent with each other. Therefore, it is necessary to also parse or determine the current picture index of the current picture where the current decoding unit is located during decoding, such that the decoded sequence can be determined through re-arrangement according to respective picture indices when the decoding is completed.

Exemplarily, the following description is given with an example that the decoding unit of the first type is B decoding unit, the decoding unit of the second type is P decoding unit, and the decoding unit of the third type is I decoding unit.

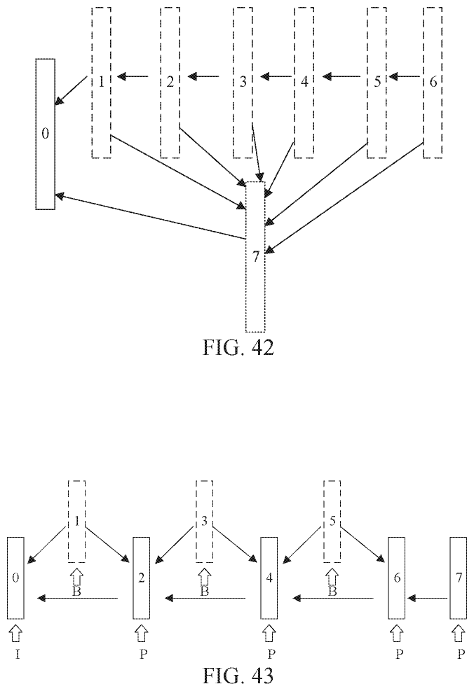

It can be noted that, in the existing RAHT attribute inter prediction, prediction is performed on an attribute of a current picture to be decoded only with reference to a forward reference picture. In such an inter prediction decoding scheme, attribute redundancy between adjacent decoded pictures can be effectively removed to a certain extent. However, for nodes in a subsequent decoded picture, not only can a forward adjacent picture be used as a reference picture, but more forward reference pictures can also be used for attribute inter prediction on the current node. As illustrated in FIG. 41, a decoding order of a constructed reference list is 07123456. When an attribute of picture 1 is decoded, only attribute values in picture 0 can be referenced. However, when picture 2 is decoded, both attribute values in picture 1 and attribute values of nodes in picture 0 can be referenced. Based on this, when there are multiple reference pictures for a subsequent decoded picture, attribute redundancy between the current picture to be decoded and the forward reference pictures can be further removed by using attributes of the multiple reference pictures, thereby further improving the efficiency of point cloud attribute decoding.

In embodiments of the disclosure, a scheme for bidirectional reference inter prediction coding based on RAHT attribute coding is provided. During RAHT coding on an attribute, a bidirectional prediction reference list is introduced, and predictive decoding is performed on an attribute of a current decoding picture by using reconstructed attributes in the bidirectional reference list.

Exemplarily, as illustrated in FIG. 42, picture 0 belongs to an I decoding unit, picture 1 belongs to a P decoding unit, and picture 2 to picture 7 belong to B decoding units. In embodiments of the disclosure, the decoding unit is not limited, i.e., the decoding unit may be a picture, a tile, a slice, or an RAHT decoding layer, etc.

Compared with a P encoding unit, for a B encoding unit, each node in the encoding unit can have more reference nodes, i.e., more reference attribute information can be provided for each encoding node. In embodiments of the disclosure, a manner of selecting and using multiple reference attributes for inter prediction is not limited, i.e., an optimal prediction mode may be selected for each node by using an RDO algorithm at the encoding end, or weighted prediction may be performed by using attributes of multiple collocated nodes, etc. In this way, for each node to be encoded, the number of references for inter prediction can be increased compared with the original coding scheme, such that slot redundancy between adjacent encoded pictures can be removed more effectively.

Further, due to the introduction of bidirectional reference pictures, a decoding order and a playback order of decoded pictures may be inconsistent with each other. Therefore, a syntax element needs to be added for each decoding unit to indicate a playback order of the current coding unit, i.e., the current picture index of the current decoding unit. In this way, after a decoding end completes decoding of point cloud information, the decoding end can rearrange decoding units in the playback order according to picture indices of the decoding units. For example, a bidirectional decoding structure can be as illustrated in FIG. 42 or FIG. 43. As illustrated in FIG. 42, a decoding order of a constructed reference list is: 01234567. As illustrated in FIG. 43, a decoding order of a constructed reference list is: 07421365. Moreover, picture 1, picture 3, and picture 5 are B decoding units, picture 2, picture 4, picture 6, and picture 7 are P decoding units, and picture 0 is an I decoding unit.

It can be noted that, for the bidirectional decoding structure as illustrated in FIG. 41, the decoding order is consistent with the original playback order. However, for the bidirectional decoding structures as illustrated in FIG. 42 and FIG. 43, the decoding order is inconsistent with the original playback order.

In embodiments of the disclosure, for each decoding unit, the playback order of the current decoding unit needs to be defined first, such that the decoding end rearranges pictures according to the playback order after decoding is completed. Secondly, for each decoding unit, when there is no reference index information, i.e., the current decoding unit is an I decoding unit, only intra prediction can be performed. When there is at most one reference index information, i.e., the current decoding unit is a P decoding unit, intra prediction or inter prediction can be used. For inter prediction, information of a reference picture is obtained from a reference list according to the reference index information. When there are at most two reference index information, i.e., the current decoding unit is a B decoding unit, intra decoding or inter prediction can be performed. For inter prediction, information of a reference picture is obtained from a reference list according to a reference index. In embodiments of the disclosure, the construction of the reference list is not limited, the reference list may be constructed in the manner as illustrated in FIG. 41 to FIG. 43, and other construction manners are also not limited.

In some embodiments of the disclosure, in the RAHT inter prediction transform coding scheme, the attribute prediction value refers to a prediction value of an AC coefficient, and the reconstructed attribute value refers to a reconstructed value of the AC coefficient. Based on this, in some embodiments, the attribute prediction value of the current node is a prediction value of an AC coefficient of the current node, and the method further includes the following. The bitstream is parsed to obtain a residual value of the AC coefficient of the current node. A reconstructed value of the AC coefficient of the current node is determined according to the residual value of the AC coefficient and the prediction value of the AC coefficient of the current node. Inverse independent orthogonal transform is performed on the reconstructed value of the AC coefficient of the current node, to obtain a reconstructed attribute value of the current node. The reconstructed attribute value obtained through inverse independent orthogonal transform is not the reconstructed value of the AC coefficient.

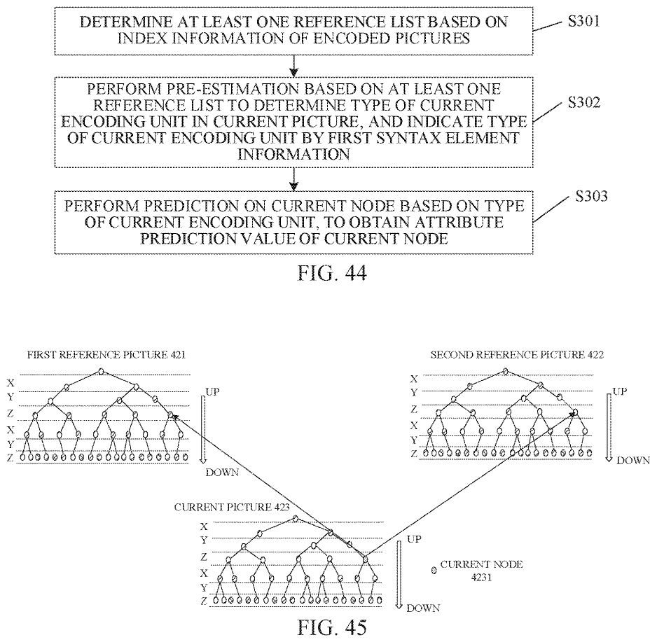

An encoding method is provided in embodiments of the disclosure. FIG. 44 is a schematic flowchart illustrating implementation of a encoding method provided in embodiments of the disclosure. As illustrated in FIG. 44, the encoding method includes the following operations at S301 to S303. At S301, at least one reference list is determined based on index information of encoded pictures.

At S302, pre-estimation is performed based on the at least one reference list to determine a type of a current encoding unit in a current picture, and the type of the current encoding unit is indicated by first syntax element information.

At S303, prediction is performed on a current node based on the type of the current encoding unit, to obtain an attribute prediction value of the current node.

In embodiments of the disclosure, an encoder can determine the at least one reference list based on related information of the encoded pictures. Then, the encoder performs pre-estimation on the current encoding unit by using a different number of reference pictures or no reference picture selected from the at least one reference list, and determines the number of reference index information of a reference picture(s) with the best encoding performance selected from the at least one reference list, and thus can determine the type of the current encoding unit based on the determined number of reference index information.

It can be noted that, the type of the encoding unit may include three types: a first type, a second type, and a third type.

Reference information of reference pictures corresponding to the first type, the second type, and the third type are different. The reference information can be understood as the number of indices of reference index information.

In some embodiments of the disclosure, the type of the current encoding unit is the third type, indicating that the current encoding unit has no reference index information, the type of the current encoding unit is the second type, indicating that the current encoding unit has at most one reference index information, and the type of the current encoding unit is the first type, indicating that the current encoding unit has at most two reference index information.

Exemplarily, in embodiments of the disclosure, an encoding unit of the first type can be represented as B encoding unit, an encoding unit of the second type can be represented as P encoding unit, and an encoding unit of the third type can be represented as I encoding unit. Exemplary definitions thereof are as follows.

I encoding unit: the current encoding unit has no reference index information.

P encoding unit: the current encoding unit has at most only one reference index information.

B encoding unit: the current encoding unit can have at most two reference index information.

In embodiments of the disclosure, since the encoder has determined the type of the current encoding unit, the encoder performs prediction, based on the type of the current encoding unit, on the current node by using reference index information corresponding to the type of the current encoding unit, to obtain the attribute prediction value of the current node.

In embodiments of the disclosure, different types of encoding units correspond to different reference information of reference pictures. Therefore, for an encoding unit of a different type, the encoder can perform encoding processing in a different form on nodes contained in the encoding unit.

In embodiments of the disclosure, the first syntax element information can indicate the type of the current encoding unit, and the first syntax element information is signalled into a bitstream for use by the decoder during decoding.

It can be understood that, during determination of the attribute prediction value of the current node, the type of the current encoding unit is first determined, and then different predictions are performed based on the type of the current encoding, so as to determine the attribute prediction value of the current node. In this way, the encoder can perform targeted and diverse attribute predictions based on different types of encodings, thereby improving the accuracy of inter attribute prediction.

In some embodiments of the disclosure, pre-estimation is performed based on the at least one reference list to determine the type of the current encoding unit as follows. Pre-estimation is performed on the current encoding unit by using two different reference lists selected from the at least one reference list, to determine a first rate-distortion cost with the minimum rate-distortion cost, and pre-estimation is performed on the current encoding unit by using one different reference list selected from the at least one reference list, to determine a second rate-distortion cost with the minimum rate-distortion cost. Pre-estimation is performed on the current encoding unit by using intra prediction, to determine a third rate-distortion cost. The type of the current encoding unit is determined according to the first rate-distortion cost, the second rate-distortion cost, and the third rate-distortion cost.

In some embodiments of the disclosure, the type of the current encoding unit is determined according to the first rate-distortion cost, the second rate-distortion cost, and the third rate-distortion cost as follows. When the minimum one among the first rate-distortion cost, the second rate-distortion cost, and the third rate-distortion cost is the first rate-distortion cost, it is determined that the type of the current encoding unit is a first type. When the minimum one among the first rate-distortion cost, the second rate-distortion cost, and the third rate-distortion cost is the second rate-distortion cost, it is determined that the type of the current encoding unit is a second type. When the minimum one among the first rate-distortion cost, the second rate-distortion cost, and the third rate-distortion cost is the third rate-distortion cost, it is determined that the type of the current encoding unit is a third type.

In embodiments of the disclosure, when the current encoding unit is of the first type, the encoding method may further include the following operations at S3031 to S3033.

At S3031, when the type of the current encoding unit is the first type, a first reference picture and a second reference picture for the current encoding unit are determined based on two reference lists of the at least one reference list.

At S3032, a first collocated node of a parent node of the current node in the first reference picture and a second collocated node of the parent node of the current node in the second reference picture are searched for according to obtained geometry information of the current node.

At S3033, inter attribute prediction is performed on the current node according to the first collocated node and the second collocated node, to obtain the attribute prediction value of the current node.

In embodiments of the disclosure, when the type of the current encoding is the first type, it means that two reference index information can be used for prediction on all nodes in the current encoding. Therefore, the encoder obtains the two reference index information of the current encoding. The encoder can determine, according to the two obtained reference index information, information of both the corresponding first reference picture and the corresponding second reference picture from at least one reference list. Then, the encoder searches for, according to the geometry information of the current node, the first collocated node of the parent node of the current node in the first reference picture and the second collocated node of the parent node of the current node in the second reference picture.

It can be noted that, in embodiments of the disclosure, the encoding method provided in embodiments of the disclosure can be used for all nodes other than a first root node. For a root node without a parent node, prediction can be implemented by directly searching for a collocated node of the root node in the reference picture, which is not limited in embodiments of the disclosure.

In embodiments of the disclosure, the encoder can first determine the parent node of the current node according to the geometry information of the current node.

In embodiments of the disclosure, the first collocated node refers to a node in the first reference picture that has the same geometry information/geometry coordinates as the parent node of the current node, and the second collocated node refers to a node in the second reference picture that has the same geometry information/geometry coordinates as the parent node of the current node. In embodiments of the disclosure, the current picture, the first reference picture, and the second reference picture can be understood as different point cloud pictures. In some embodiments, arrangement structures of point clouds in the current picture, the first reference picture, and the second reference picture are RAHT attribute transform encoding structures. The encoder can construct the RAHT attribute transform encoding structure based on the geometry information of the node, i.e., continuously merging nodes from a voxel level up to a root node of an entire RAHT transform tree. For example, as illustrated in FIG. 45, the first reference picture is 421, the second reference picture is 422, and the current picture is 423. Assuming that the parent node of the current node is 4231, then the first collocated node and the second collocated node are nodes pointed by arrows as illustrated in FIG. 45.

In embodiments of the disclosure, a relationship between the first reference picture, the second reference picture, and the current picture is not limited. The first reference picture and the second reference picture may be two forward pictures of the current picture, or may be two backward pictures of the current picture. Alternatively, the first reference picture may be a forward reference picture of the current picture, and the second reference picture may be a backward reference picture of the current picture.

In embodiments of the disclosure, the encoder performs inter attribute prediction on the current node according to the first collocated node and the second collocated node, to obtain the attribute prediction value of the current node as follows.

Manner 1, when the first collocated node is present in the first reference picture and the second collocated node is present in the second reference picture, the attribute prediction value of the current node is determined according to a reconstructed attribute value of a first child node of the first collocated node and a reconstructed attribute value of a second child node of the second collocated node.

Manner 2, when the first collocated node is absent in the first reference picture and the second collocated node is present in the second reference picture, the attribute prediction value of the current node is determined according to the reconstructed attribute value of the second child node of the second collocated node.

Manner 3, when the first collocated node is present in the first reference picture and the second collocated node is absent in the second reference picture, the attribute prediction value of the current node is determined according to the reconstructed attribute value of the first child node of the first collocated node.

Manner 4, when the first collocated node is absent in the first reference picture and the second collocated node is absent in the second reference picture, the attribute prediction value of the current node is determined according to a reconstructed attribute value of at least one neighbourhood node of the current node in the current picture.

It can be noted that, in embodiments of the disclosure, the parent node of the current node is used for determining the collocated node in the reference picture. However, when it is determined that the collocated node is present, multiple child nodes of the collocated node are determined based on independent orthogonal transform of the collocated node, a prediction node of the current node is determined from the multiple child nodes, and then a reconstructed attribute value of the prediction node is used for determining the attribute prediction value of the current node.

For Manner 1, the reconstructed attribute value of the first child node of the first collocated node and the reconstructed attribute value of the second child node of the second collocated node are weighted according to a first weighting coefficient for the reconstructed attribute value of the first child node of the first collocated node and a second weighting coefficient for the reconstructed attribute value of the second child node of the second collocated node, to obtain the attribute prediction value of the current node.

The first weighting coefficient is equal to a first value, and the second weighting coefficient is equal to a second value.

In some embodiments of the disclosure, the first weighting coefficient is determined according to an interval between a collection time of the current picture and a collection time of the first reference picture, or the first weighting coefficient is determined according to the geometry information of the current node and attribute distribution information of the first child node.

In some embodiments of the disclosure, the second weighting coefficient is determined according to an interval between a collection time of the current picture and a collection time of the second reference picture, or the second weighting coefficient is determined according to the geometry information of the current node and attribute distribution information of the second child node.

In some embodiments of the disclosure, rate-distortion costs of multiple candidate weighting coefficient groups are determined from a coefficient list, where each of the multiple candidate weighting coefficient groups contains a first candidate weighting coefficient for a reconstructed attribute value of the first collocated node and a second candidate weighting coefficient for a reconstructed attribute value of the second collocated node. A candidate weighting coefficient group with the minimum rate-distortion cost is selected from the multiple candidate weighting coefficient groups. A first candidate weighting coefficient in the candidate weighting coefficient group with the minimum rate-distortion cost is determined as the first weighting coefficient, and a second candidate weighting coefficient in the candidate weighting coefficient group with the minimum rate-distortion cost is determined as the second weighting coefficient.

In some embodiments of the disclosure, the first weighting coefficient and the second weighting coefficient are signalled into the bitstream, or a first weighting coefficient index of the first weighting coefficient and a second weighting coefficient index of the second weighting coefficient are signalled into the bitstream.

Exemplarily, in some embodiments, the first weighting coefficient is equal to the first value, and the second weighting coefficient is equal to the second value. That is, the first weighting coefficient and the second weighting coefficient are predefined values, and may be equal or not equal, but a sum of the first weighting coefficient and the second weighting coefficient is equal to 1.

In some other embodiments, the first weighting coefficient can be determined according to the interval between the collection time of the current picture and the collection time of the first reference picture, and/or the second weighting coefficient can be determined according to the interval between the collection time of the current picture and the collection time of the second reference picture. For example, a longer interval leads to a smaller value of a weighting coefficient. Assuming that the interval between the collection time of the current picture and the collection time of the first reference picture is longer than the interval between the collection time of the current picture and the collection time of the second reference picture, then the first weighting coefficient is less than the second weighting coefficient.

In some embodiments, a mapping table between an interval between collection times and a weighting coefficient may be predefined, such that the encoder can determine the first weighting coefficient and the second weighting coefficient by looking up the table based on weighting coefficient indices. Certainly, the weighting coefficient is not limited to being determined based on the table lookup method, and in conclusion, a corresponding weighting coefficient can be determined according to an interval between collection times of two pictures.

In yet some other embodiments, the encoder may determine the first weighting coefficient and the second weighting coefficient as follows. Rate-distortion costs of multiple candidate weighting coefficient groups are determined, where each of the multiple candidate weighting coefficient groups contains a first candidate weighting coefficient for a reconstructed attribute value of the first collocated node and a second candidate weighting coefficient for a reconstructed attribute value of the second collocated node. A candidate weighting coefficient group with the minimum rate-distortion cost is selected from the multiple candidate weighting coefficient groups. A first candidate weighting coefficient in the candidate weighting coefficient group with the minimum rate-distortion cost is determined as the first weighting coefficient, and a second candidate weighting coefficient in the candidate weighting coefficient group with the minimum rate-distortion cost is determined as the second weighting coefficient.

It can be understood that, at an encoding end, since an actual attribute value of the current node is known, the rate-distortion costs of the candidate weighting coefficient groups can be determined. Correspondingly, the method further includes the following. The encoder signals the first weighting coefficient and the second weighting coefficient obtained based on the rate-distortion costs into the bitstream, and the decoder can parse the bitstream to obtain the first weighting coefficient and the second weighting coefficient. The method further includes the following. The encoder determines a first weighting coefficient index of the first weighting coefficient and a second weighting coefficient index of the second weighting coefficient from the coefficient list according to the first weighting coefficient and the second weighting coefficient obtained based on the rate-distortion costs, and then signals the first weighting coefficient index and the second weighting coefficient index into the bitstream. As such, the decoder can parse the bitstream to obtain the first weighting coefficient index and the second weighting coefficient index.

In the foregoing embodiments, the method for determining the attribute prediction value of the current node when both the first collocated node and the second collocated node are present is described. It can be understood that, the first collocated node may be absent in the first reference picture, and/or the second collocated node may be absent in the second reference picture. In this case, the attribute prediction value of the current node cannot be obtained by performing inter attribute prediction on the current node according to the first collocated node and the second collocated node.

For Manner 2, when the first collocated node is absent in the first reference picture and the second collocated node is present in the second reference picture, the attribute prediction value of the current node is equal to the reconstructed attribute value of the second child node of the second collocated node.

For Manner 3, when the first collocated node is present in the first reference picture and the second collocated node is absent in the second reference picture, the attribute prediction value of the current node is equal to the reconstructed attribute value of the first child node of the first collocated node.

In some embodiments of the disclosure, the implementation of Manner 1 or S3033 may further include the following.

At S401, when the first collocated node is present in the first reference picture and the second collocated node is present in the second reference picture, a first difference number of occupied child nodes between the first collocated node and the parent node of the current node is determined according to occupancy information of the first collocated node and occupancy information of the parent node of the current node.

At S402, a second difference number of occupied child nodes between the second collocated node and the parent node of the current node is determined according to occupancy information of the second collocated node and the occupancy information of the parent node of the current node.

At S403, the first weighting coefficient for the reconstructed attribute value of the first child node of the first collocated node and the second weighting coefficient for the reconstructed attribute value of the second child node of the second collocated node are determined according to a relationship between the first difference number and the second difference number.

At S404, the reconstructed attribute value of the first child node of the first collocated node and the reconstructed attribute value of the second child node of the second collocated node are weighted by using the first weighting coefficient and the second weighting coefficient, to determine the attribute prediction value of the current node.

In some embodiments, determining the first weighting coefficient for the reconstructed attribute value of the first child node of the first collocated node and the second weighting coefficient for the reconstructed attribute value of the second child node of the second collocated node according to the relationship between the first difference number and the second difference number includes at least one of the following.
(1) When the first difference number is equal to the second difference number, it is determined that the first weighting coefficient is equal to the second weighting coefficient.
(2) When the first difference number is less than the second difference number, it is determined that the first weighting coefficient is greater than the second weighting coefficient.
(3) When the first difference number is greater than the second difference number, determined that the first weighting coefficient is less than the second weighting coefficient.

Exemplarily, in some embodiments, when the first difference number is less than the second difference number, the attribute prediction value of the current node is equal to the reconstructed attribute value of the first child node of the first collocated node, i.e., the first weighting coefficient is 1, and the second weighting coefficient is 0. When the first difference number is greater than the second difference number, the attribute prediction value of the current node is equal to the reconstructed attribute value of the second child node of the second collocated node, i.e., the first weighting coefficient is 0, and the second weighting coefficient is 1.

It can be noted that, the first child node is a prediction node corresponding to the current node after transformation of the first collocated node, and the second child node is a prediction node corresponding to the current node after transformation of the second collocated node.

It can be understood that, the occupancy information of the first collocated node, the occupancy information of the second collocated node, and the occupancy information of the parent node of the current node each record occupancy statuses of respective child nodes. A smaller difference number of occupied child nodes between the parent node of the current node and a collocated node indicates a stronger geometric correlation between two corresponding f point clouds/two corresponding pictures. Correspondingly, a stronger attribute correlation between two corresponding point clouds/two corresponding pictures indicates a greater temporal redundancy existing therebetween. Therefore, when the first difference number of occupied child nodes between the first collocated node and the parent node of the current node is less than the second difference number of occupied child nodes between the second collocated node and the parent node of the current node, it indicates that there is greater temporal redundancy between the current picture and the first reference picture than between the current picture and the second reference picture. Therefore, in this case, the attribute prediction value of the current node can be determined according to the reconstructed attribute value of the first child node of the first collocated node. For example, the reconstructed attribute value of the first child node of the first collocated node is directly determined as the attribute prediction value of the current node. In this way, compared with determining the attribute prediction value of the current node according to the reconstructed attribute value of the second child node of the second collocated node in this case, temporal redundancy can be better compressed, thereby improving performance of point cloud coding. Similarly, when the first difference number is greater than the second difference number, the attribute prediction value of the current node is determined according to the reconstructed attribute value of the second child node of the second collocated node. In this way, compared with determining the attribute prediction value of the current node according to the reconstructed attribute value of the first child node of the first collocated node, temporal redundancy can be better compressed, thereby improving the performance of point cloud coding.

In embodiments of the disclosure, when the current encoding unit is of the second type, the encoding method may further include the following operations at S3034 to S3036.

At S3034, when the type of the current encoding unit is the second type, a third reference picture for the current encoding unit is determined based on one reference list of the at least one reference list.

At S3035, a third collocated node of a parent node of the current node in the third reference picture is searched for according to obtained geometry information of the current node.

At S3036, inter attribute prediction is performed on the current node according to the third collocated node, to obtain the attribute prediction value of the current node.

In embodiments of the disclosure, when the type of the current encoding unit is the second type, it means that one reference index information can be used for prediction on all nodes in the current encoding unit. Therefore, the encoder can obtain the one reference index information of the current encoding unit. The encoder can determine, according to the one obtained reference index information, information of the corresponding third reference picture from the at least one reference list. Then, the encoder searches for the third collocated node of the parent node of the current node in the third reference picture according to the geometry information of the current node.

It can be noted that, in embodiments of the disclosure, the encoding method provided in embodiments of the disclosure can be used for all nodes other than a first root node. For a root node without a parent node, prediction can be implemented by directly searching for a collocated node of the root node in the reference picture, which is not limited in embodiments of the disclosure.

In embodiments of the disclosure, the encoder can first determine the parent node of the current node according to the geometry information of the current node.

In embodiments of the disclosure, the third collocated node refers to a node in the third reference picture that has the same geometry information/geometry coordinates as the parent node of the current node. In embodiments of the disclosure, the current picture and the third reference picture can be understood as different point cloud pictures. In some embodiments, arrangement structures of point clouds of the current picture and the third reference picture are RAHT attribute transform encoding structures.

In embodiments of the disclosure, the third reference picture is a forward reference picture of the current picture, or the third reference picture is a backward reference picture of the current picture, which is not limited in embodiments of the disclosure.

In embodiments of the disclosure, the encoder performs inter attribute prediction on the current node according to the third collocated node, to obtain the attribute prediction value of the current node as follows.
(1) When the third collocated node is present in the third reference picture, the attribute prediction value of the current node is determined according to a reconstructed attribute value of a third child node of the third collocated node, or
(2) When the third collocated node is absent in the third reference picture, the attribute prediction value of the current node is determined according to a reconstructed attribute value of at least one neighbourhood node of the current node in the current picture.

Exemplarily, when the third collocated node is present in the third reference picture, the reconstructed attribute value of the third child node of the third collocated node is equal to the attribute prediction value of the current node.

In embodiments of the disclosure, when the current encoding unit is of the third type, the encoding method may further include the following. When the type of the current encoding unit is the third type, the attribute prediction value of the current node is determined according to the reconstructed attribute value of the at least one neighbourhood node of the current node in the current picture.

In some embodiments of the disclosure, two reference index information corresponding to a first reference picture and a second reference picture are signalled into the bitstream, or one reference index information corresponding to the third reference picture is signalled into the bitstream, where the reference index information includes reference list index information or reference picture index information.

It can be noted that, the reference index information may be a reference list index, or may directly be a reference picture index. However, compared with the reference picture index, the transmission of the reference list index requires fewer codewords.

In some embodiments of the disclosure, the reference index information needs to be determined by using a reference list. In embodiments of the disclosure, a process of establishing a reference list is provided.

In some embodiments of the disclosure, the at least one reference list is determined based on the index information of the encoded pictures as follows. At least one first reference list is determined based on index information of encoded pictures, where the at least one first reference list indicates a mapping relationship from reference picture indices to storage positions.

In some embodiments of the disclosure, the at least one first reference list includes two first reference lists. The first reference picture and the second reference picture for the current encoding unit are determined based on the two reference lists of the at least one reference list as follows. A first reference picture index and a second reference picture index are determined from the two first reference lists. The first reference picture and the second reference picture are determined based on the first reference picture index and the second reference picture index, respectively.

In some embodiments of the disclosure, the at least one first reference list includes one first reference list. The third reference picture for the current encoding unit is determined based on the one reference list of the at least one reference list as follows. A third reference picture index is determined from the one first reference list. The third reference picture is determined based on the third reference picture index.

In some embodiments of the disclosure, the at least one reference list is determined based on the index information of the encoded pictures as follows. At least one second reference list is determined based on index information of encoded pictures, where the at least one second reference list indicates a mapping relationship from reference pictures to storage positions.

In some embodiments of the disclosure, the at least one second reference list includes two second reference lists. The first reference picture and the second reference picture for the current encoding unit are determined based on the two reference lists of the at least one reference list as follows. The first reference picture and the second reference picture are determined from the two second reference lists, respectively.

In some embodiments of the disclosure, the at least one second reference list includes one second reference list. The third reference picture for the current encoding unit is determined based on the one reference list of the at least one reference list as follows. The third reference picture is determined from the one second reference list.

In some embodiments of the disclosure, the encoding unit is any one of a picture level, a tile level, a slice level, or an RAHT encoding layer level.

In embodiments of the disclosure, the encoder can construct at least one reference list, and the at least one reference list can be classified into a first reference list and a second reference list based on different mapping relationships. The construction manner of the reference list is not limited in embodiments of the disclosure.

In some embodiments of the disclosure, a current picture index of the current picture is determined. The current picture index is indicated by second syntax element information, and the second syntax element information is signalled into a bitstream by carrying the second syntax element information in a syntax layer of the current encoding unit.

It can be noted that, in embodiments of the disclosure, a decoding order and a playback order of the current sequence may be inconsistent with each other. Therefore, it is necessary to transmit the current picture index of the current picture where the current encoding unit is located to a decoder during encoding, such that a decoded sequence can be determined through re-arrangement according to respective picture indices when the decoding is completed.

In some embodiments of the disclosure, the attribute prediction value of the current node is a prediction value of an AC coefficient of the current node. An original value of the AC coefficient of the current node is determined. A residual value of the AC coefficient of the current node is determined according to the prediction value of the AC coefficient and the original value of the AC coefficient. A quantized residual value of the AC coefficient is signalled into the bitstream.

Exemplarily, in some embodiments, the attribute prediction value of the current node is the prediction value of the AC coefficient of the current node, and an attribute residual value of the current node is the residual value of the AC coefficient of the current node. The encoder can determine the residual value of the AC coefficient of the current node according to the prediction value of the AC coefficient of the current node and the original value of the AC coefficient of the current node, and then signals the quantized residual value of the AC coefficient into the bitstream.

It can be noted that, in embodiments of the disclosure, the method for determining the attribute prediction value of the current node in the encoding method is the same as the method for determining the attribute prediction value of the current node in the decoding method. Therefore, for technical details not disclosed in embodiments of the encoding method, reference may be made to the description of embodiments of the decoding method in the disclosure.

The following will illustrate an exemplary application of embodiments of the disclosure in a practical scenario.

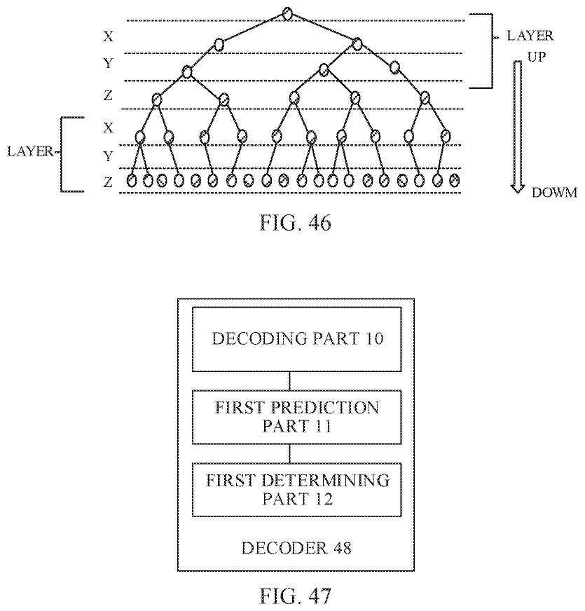

In embodiments of the disclosure, an RAHT attribute encoding layer is first defined. An RAHT attribute transform coding order is to sequentially subdivide from a root node down to a voxel level (1×1×1), thereby completing attribute encoding and attribute reconstruction of the entire point cloud. In some embodiments, as illustrated in FIG. 46, a layer obtained by performing downsampling once in a Z direction, a Y direction, and an X direction is defined as an RAHT transform layer, i.e., layer. Secondly, a scheme for bidirectional predictive encoding is introduced based on the RAHT attribute encoding layer. A specific algorithm is as illustrated in FIG. 45.

First, if a current encoding unit belongs to a P/B encoding unit, when attributes of nodes in the current layer are encoded/decoded, the number of current nodes to be encoded/decoded and positions of respective nodes can be obtained. Secondly, for each node to be encoded/decoded (i.e., a current node), a total of 19 neighbourhood nodes spatially adjacent to the current node to be encoded/decoded are searched by using a position of the current node to be encoded/decoded, and a corresponding intra prediction value is obtained based on reconstructed attribute values of the 19 neighbourhood nodes. A collocated node of a parent node of the current node to be encoded is searched for in a reference picture based on the spatial position of the current node to be encoded. A specific algorithm at an encoding end is described in the following operations at 1 to 5.
1. Search a buffer of a forward reference picture by using the position of the current node to be encoded, to determine whether a collocated node of the parent node of the current node to be encoded is present in a prediction layer corresponding to the reference picture. If such collocated node is present, then assume that a prediction value of a prediction node in the forward reference picture is predVal1. If the current encoding unit belongs to a P encoding unit and the collocated node of the parent node of the current node is present, then an AC attribute prediction value of the current node is predVal1. If such collocated node is absent, then the AC attribute prediction value of the current node is an intra AC prediction value.
2. If the current encoding unit belongs to a B encoding unit, then whether a collocated node of the parent node of the current node is present in a backward reference picture is determined based on the same algorithm. If such collocated node is present, then assume that a prediction value of a prediction node in the backward reference picture is predVal2, and a final attribute prediction value of the AC coefficient of the current node predVal is:

$$predVal = w 1 * predVal 1 + w 2 * predVal 2$$

In the above, w1 is a prediction weight of a forward reference picture (a first weighting coefficient), and w2 is a prediction weight of a backward reference picture (a second weighting coefficient). w1 and w2 are determined according to slot distances between a current encoding picture and the reference pictures. The position of the current node to be encoded can be understood as geometry information of the current node, the forward reference picture can be understood as a first reference picture, the backward reference picture can be understood as a second reference picture, predVal1 can be understood as a reconstructed value of an AC coefficient/a reconstructed attribute value of an AC coefficient of a first child node of a first collocated node, predVal2 can be understood as a reconstructed value of an AC coefficient/a reconstructed attribute value of an AC coefficient of a second child node of a second collocated node, and the attribute prediction value of the AC coefficient can also be referred to as a prediction value of the AC coefficient.
3. For a B encoding unit, if the collocated node in the forward reference picture is present but the collocated node in the backward reference picture is absent, then the attribute prediction value of the AC coefficient of the current node predVal is:

$$predVal = predVal 1$$

4. For a B encoding unit, if the collocated node in the backward reference picture is present but the collocated node in the forward reference picture is present, then the attribute prediction value of the AC coefficient of the current node predVal is:

$$predVal = predVal 2$$

5. For a B encoding unit, if both the collocated node of the current node in the forward reference picture and the collocated node of the current node in the backward reference picture are absent, then the attribute prediction value of the AC coefficient of the current node is an intra prediction value.

A specific algorithm at a decoding end is described in the following operations at 1 to 4.
1. First, which type of decoding unit (I/P/B) a current decoding unit belongs to is determined.
2. For a P/B decoding unit, a reference picture(s) is obtained from a reference list by using reference picture information/reference list index information of the current decoding unit.
3. Search a buffer of a forward reference picture by using the position of the current node to be decoded, to determine whether a collocated node of a parent node of a current node to be decoded is present in a prediction layer corresponding to the reference picture. If such collocated node is present, then assume that a prediction value of a prediction node in the forward reference picture is predVal1. If the current decoding unit belongs to a P decoding unit and the collocated node of the parent node of the current node is present, then an attribute prediction value of the current node is predVal1. If such collocated node is absent, then the attribute prediction value of the current node is an intra prediction value.
4. If the current decoding unit belongs to a B decoding unit, then whether a collocated node of the parent node of the current node is present in a backward reference picture is determined based on the same algorithm. If such collocated node is present, then assume that a prediction value of a prediction node in the backward reference picture is predVal2, and a final attribute prediction value of the AC coefficient of the current node predVal is:

$$predVal = w 1 * predVal 1 + w 2 * predVal 2$$

In the above, w1 is a prediction weight of a forward reference picture, and w2 is a prediction weight of a backward reference picture.
5. For a B decoding unit, if the collocated node in the forward reference picture is present but the collocated node in the backward reference picture is absent, then the attribute prediction value of the AC coefficient of the current node is:

$$predVal = predVal 1$$

6. For a B decoding unit, if the collocated node in the backward reference picture is present but the collocated node in the forward reference picture is present, then the attribute prediction value of the AC coefficient of the current node is:

$$predVal = predVal 2$$

7. For a B decoding unit, if both the collocated node of the current node in the forward reference picture and the collocated node of the current node in the backward reference picture are absent, then the attribute prediction value of the AC coefficient of the current node is an intra prediction value.

Similar to the algorithm at the encoding end, prediction values of AC coefficients of N child nodes of the current node to be decoded are obtained. Attribute prediction residuals of the AC coefficients of these different child nodes are obtained from the bitstream. The prediction residuals are dequantized to obtain reconstructed values of the prediction residuals. The reconstructed values of the prediction residuals are added to the prediction values to reconstruct and obtain reconstructed attribute values of the AC coefficients of the current child nodes. Finally, attribute values of nodes are obtained based on inverse RAHT attribute transform.

In the above scheme, for each node to be encoded, a bidirectional predictive encoding algorithm is introduced. When both the collocated node in the forward reference picture and the collocated node in the backward reference picture are present, the prediction weight of the forward/backward reference picture is obtained based on a slot interval between the forward/backward reference picture and the current picture to be encoded. In addition to considering a slot relationship of a sequence set, distribution of attributes of AC coefficients of the nodes to be encoded can also be considered. In this scheme, the prediction weight of the forward reference picture and the prediction weight of the backward reference picture are optimized. Specifically, for an attribute of each layer to be encoded, the encoding end obtains an optimal prediction weight value of the current layer to be encoded by using a rate-distortion optimization algorithm, and then passes the prediction weight value to the decoding end. The decoding end obtains a reconstructed attribute value of a node to be decoded through reconstruction by using a corresponding prediction weight and an attribute prediction value of an adjacent reference, thereby further improving the efficiency of point cloud attribute encoding/decoding.

In embodiments of the disclosure, during RAHT inter prediction on the attribute, if attribute prediction can be performed on the current layer to be encoded, the bidirectional predictive encoding algorithm is introduced based on the RAHT attribute encoding structure. For each node to be encoded, corresponding collocated nodes are obtained in the forward reference picture and the backward reference picture according to the spatial position of the node to be encoded, respectively. Then, the attribute prediction value of the AC coefficient of the current node to be encoded is obtained by using the collocated nodes. Based on such an algorithm, the attributes of the AC coefficients of both the forward reference picture and the backward reference picture can be comprehensively considered, thereby better removing slot redundancy between adjacent forward and backward pictures, and thus further improving the efficiency of point cloud attribute encoding. As illustrated in Table 2, the efficiency of attribute encoding is demonstrated. As can be seen from Table 2, after the RAHT bidirectional inter prediction encoding algorithm is introduced, for sequences with inter prediction encoding employed on attributes, BPP of attribute encoding is reduced by about 1.75%, significantly improving the efficiency of point cloud attribute encoding.

TABLE 2

| Frame-Idx | anchor | proposal | bpp |
|---|---|---|---|
| 0 | 21376 | 21126 | 98.8% |
| 1 | 18313 | 18061 | 98.6% |
| 2 | 17933 | 17581 | 98.0% |
| 3 | 17745 | 17125 | 96.5% |
| 4 | 18151 | 18486 | 101.8% |
| 5 | 17902 | 17190 | 96.0% |
| 6 | 17500 | 17063 | 97.5% |
| 7 | 18072 | 17867 | 98.8% |

In embodiments of the disclosure, when RAHT prediction encoding is performed on the attribute, inter prediction encoding is performed on the attribute of each node, and the RAHT bidirectional predictive encoding structure is introduced. For each node to be encoded, corresponding collocated nodes are obtained in the forward reference picture and the backward reference picture according to the spatial position of the node to be encoded, respectively. Then, inter prediction encoding is performed on the attribute of the current node to be encoded according to different situations of the forward reference picture and the backward reference picture. Finally, the decoding end obtains the attribute prediction value of the corresponding node based on the same algorithm, and obtains the reconstructed attribute value of the current node to be decoded by using the attribute prediction value and the attribute prediction residual of the corresponding node. In embodiments of the disclosure, the focus is on introducing a bidirectional inter prediction encoding algorithm when attribute encoding or decoding is performed on each node of each RAHT encoding. Redundancy of attributes between adjacent pictures can be further removed by using reconstructed attribute values of a forward reference node and a backward reference node. This algorithm does not limit a prediction weight of the forward reference node and a prediction weight of the backward reference node. For example, inter prediction weights of different prediction nodes can be determined according to slot intervals corresponding to the forward reference picture and the backward reference picture, or the weights of the forward reference node and the backward reference node for the current node can be adaptively obtained according to the spatial position of each node and the attribute distribution of the prediction node.

(1) The attribute bidirectional inter prediction mode can be further modified in embodiments of the disclosure.

In the above scheme, the forward reference node and the backward reference node are obtained by using the node to be encoded, and then an inter attribute prediction value of the current node to be encoded is obtained according to certain conditions. In embodiments of the disclosure, an inter attribute prediction value of the prediction node is further optimized. The details are as follows.

Assume that occupancy information of the parent node of the current node to be encoded is occupancy. A corresponding prediction node (a collocated node) of the parent node of the current node to be encoded is obtained in the forward reference picture according to the spatial position of the current node to be encoded. Assume that occupancy information of the prediction node is prevOccupancy. A corresponding prediction node is obtained in the backward reference picture based on the same algorithm. Assume that a reconstructed value of an AC coefficient of a prediction child node stored in the forward reference picture is predVal1, occupancy information of the prediction node is backOccupancy, and a reconstructed value of an AC coefficient of a prediction child node stored in the backward reference picture is predVal2. Then, the prediction value of the current node is as follows.
1. If both prediction nodes are present, assuming that a difference number between the occupancy information of the parent node of the current node to be encoded and the occupancy information of the forward prediction node is N1 (i.e., a first difference number), and a difference number between the occupancy information of the backward reference picture and the occupancy information of the parent node of the current node to be encoded is N2 (i.e., a second difference number), then:
1) When N1 is less than N2, the attribute prediction value of the AC coefficient of the current node predVal is:

$$predVal = predVal 1$$

2) When N1 is greater than N2, the attribute prediction value of the AC coefficient of the current node predVal is:

$$predVal = predVal 2$$

3) When N1 is equal to N2, the attribute prediction value of the AC coefficient of the current node predVal is:

$$predVal = w 1 * predVal 1 + w 2 * predVal 2$$

In the above, w1 is the prediction weight of the forward reference picture, and w2 is the prediction weight of the backward reference picture.
2. Otherwise, if the collocated node in the forward reference picture is present, the attribute prediction value of the AC coefficient of the current node predVal is:

$$predVal = predVal 1$$

3. Otherwise, if the collocated node in the backward reference picture is present, the attribute prediction value of the AC coefficient of the current node predVal is:

$$predVal = predVal 2$$

4. Otherwise, if the collocated node of the current node in the backward reference picture is absent, the attribute prediction value of the AC coefficient of the current node is an intra prediction value.

It can be noted that, although various operations of the method of the disclosure are described in a particular order in the drawings, this does not require or imply that the operations must be performed in the particular order, or that all of the operations illustrated must be performed to achieve a desired result. Additionally or alternatively, some operations may be omitted, multiple operations may be combined into one operation for performing, and/or one operation may be decomposed into multiple operations for performing. Alternatively, operations in different embodiments may be combined into a new technical solution.

A decoder is provided in embodiments of the disclosure. FIG. 47 is a schematic structural diagram of a decoder according to embodiments of the disclosure. As illustrated in FIG. 47, a decoder 48 includes a decoding part 10 and a first prediction part 11. The decoding part 10 is configured to parse a bitstream to determine first syntax element information of a current decoding unit in a current picture, where the first syntax element information indicates a type of the current decoding unit, and reference information of reference pictures corresponding to different types of decoding units are different. The first prediction part 11 is configured to perform prediction on a current node based on the type of the current decoding unit indicated by the first syntax element information, to obtain an attribute prediction value of the current node.

In some embodiments of the disclosure, the first prediction part 11 is further configured to, when the type of the current decoding unit indicated by the first syntax element information is a first type, parse and determine two reference index information of the current decoding unit. The first prediction part 11 is further configured to determine a first reference picture and a second reference picture based on the two reference index information. The first prediction part 11 is further configured to search for, according to obtained geometry information of the current node, a first collocated node of a parent node of the current node in the first reference picture and a second collocated node of the parent node of the current node in the second reference picture. The first prediction part 11 is further configured to perform inter attribute prediction on the current node according to the first collocated node and the second collocated node, to obtain the attribute prediction value of the current node.

In some embodiments of the disclosure, the first prediction part 11 is further configured to, when the type of the current decoding unit indicated by the first syntax element information is a second type, parse and determine one reference index information of the current decoding unit. The first prediction part 11 is further configured to determine a third reference picture based on the one reference index information. The first prediction part 11 is further configured to search for a third collocated node of a parent node of the current node in the third reference picture according to obtained geometry information of the current node. The first prediction part 11 is further configured to perform inter attribute prediction on the current node according to the third collocated node, to obtain the attribute prediction value of the current node.

In some embodiments of the disclosure, the first prediction part 11 is further configured to, when the type of the current decoding unit indicated by the first syntax element information is a third type, determine the attribute prediction value of the current node according to a reconstructed attribute value of at least one neighbourhood node of the current node in the current picture.

In some embodiments of the disclosure, the first syntax element information indicates the third type, indicating that the current decoding unit has no reference index information. The first syntax element information indicates the second type, indicating that the current decoding unit has at most one reference index information. The first syntax element information indicates the first type, indicating that the current decoding unit has at most two reference index information.

In some embodiments of the disclosure, the decoder 48 further includes a first determining part 12. The first determining part 12 is configured to determine a current picture index of the current picture. After the current picture is decoded, the first determining part 12 is configured to continue to decode a next picture according to a decoding order until a current sequence is decoded, and determining picture indices of respective pictures. The first determining part 12 is configured to arrange decoded respective pictures based on the picture indices of the respective pictures, to obtain a decoded sequence.

In some embodiments of the disclosure, the decoding part 10 is further configured to parse the bitstream to determine second syntax element information of the current decoding unit, where the second syntax element information indicates the current picture index.

In some embodiments of the disclosure, the decoder 48 further includes a first determining part 12. The first determining part 12 is further configured to determine at least one first reference list based on index information of decoded pictures, where the at least one first reference list indicates a mapping relationship from reference picture indices to storage positions.

In some embodiments of the disclosure, the at least one first reference list includes two first reference lists, and reference index information includes reference list index information. The first prediction part 11 is further configured to determine a first reference picture index and a second reference picture index from the two first reference lists according to respective reference list index information. The first prediction part 11 is further configured to determine the first reference picture and the second reference picture based on the first reference picture index and the second reference picture index, respectively.

In some embodiments of the disclosure, the at least one first reference list includes one first reference list, and reference index information includes reference list index information. The first prediction part 11 is further configured to determine a third reference picture index from the one first reference list according to one reference list index information. The first prediction part 11 is further configured to determine the third reference picture based on the third reference picture index.

In some embodiments of the disclosure, the decoder 48 further includes a first determining part 12. The first determining part 12 is configured to determine at least one second reference list based on index information of decoded pictures, where the at least one second reference list indicates a mapping relationship from reference pictures to storage positions.

In some embodiments of the disclosure, the at least one second reference list includes two second reference lists, and reference index information includes reference picture index information. The first prediction part 11 is further configured to determine the first reference picture and the second reference picture from the two second reference lists according to respective reference picture index information.

In some embodiments of the disclosure, the at least one second reference list includes one second reference list, and reference index information includes reference picture index information. The first prediction part 11 is further configured to determine the third reference picture from the one second reference list according to one reference picture index information.

In some embodiments of the disclosure, the decoding unit is any one of a picture level, a tile level, a slice level, or an RAHT decoding layer level.

In some embodiments of the disclosure, the first prediction part 11 is further configured to, when the first collocated node is present in the first reference picture and the second collocated node is present in the second reference picture, determine the attribute prediction value of the current node according to a reconstructed attribute value of a first child node of the first collocated node and a reconstructed attribute value of a second child node of the second collocated node.

In some embodiments of the disclosure, the first prediction part 11 is further configured to, when the first collocated node is present in the first reference picture and the second collocated node is present in the second reference picture, determine a first difference number of occupied child nodes between the first collocated node and the parent node of the current node according to occupancy information of the first collocated node and occupancy information of the parent node of the current node, and determine a second difference number of occupied child nodes between the second collocated node and the parent node of the current node according to occupancy information of the second collocated node and the occupancy information of the parent node of the current node. The first prediction part 11 is further configured to determine a first weighting coefficient for a reconstructed attribute value of a first child node of the first collocated node and a second weighting coefficient for a reconstructed attribute value of a second child node of the second collocated node according to a relationship between the first difference number and the second difference number. The first prediction part 11 is further configured to weight the reconstructed attribute value of the first child node of the first collocated node and the reconstructed attribute value of the second child node of the second collocated node by using the first weighting coefficient and the second weighting coefficient, to determine the attribute prediction value of the current node.

In some embodiments of the disclosure, the first prediction part 11 is further configured to, when the first difference number is equal to the second difference number, determine that the first weighting coefficient is equal to the second weighting coefficient.

In some embodiments of the disclosure, the first prediction part 11 is further configured to, when the first difference number is less than the second difference number, determine that the first weighting coefficient is greater than the second weighting coefficient.

In some embodiments of the disclosure, the first prediction part 11 is further configured to, when the first difference number is greater than the second difference number, determine that the first weighting coefficient is less than the second weighting coefficient.

In some embodiments of the disclosure, the first prediction part 11 is further configured to, when the first collocated node is absent in the first reference picture and the second collocated node is present in the second reference picture, determine the attribute prediction value of the current node according to a reconstructed attribute value of a second child node of the second collocated node.

In some embodiments of the disclosure, the first prediction part 11 is further configured to operate as follows. When the first collocated node is absent in the first reference picture and the second collocated node is present in the second reference picture, the attribute prediction value of the current node is equal to the reconstructed attribute value of the second child node of the second collocated node.

In some embodiments of the disclosure, the first prediction part 11 is further configured to, when the first collocated node is present in the first reference picture and the second collocated node is absent in the second reference picture, determine the attribute prediction value of the current node according to a reconstructed attribute value of a first child node of the first collocated node.

In some embodiments of the disclosure, the first prediction part 11 is further configured to operate as follows. When the first collocated node is present in the first reference picture and the second collocated node is absent in the second reference picture, the attribute prediction value of the current node is equal to the reconstructed attribute value of the first child node of the first collocated node.

In some embodiments of the disclosure, the first prediction part 11 is further configured to, when the first collocated node is absent in the first reference picture and the second collocated node is absent in the second reference picture, determine the attribute prediction value of the current node according to a reconstructed attribute value of at least one neighbourhood node of the current node in the current picture.

In some embodiments of the disclosure, the first prediction part 11 is further configured to weight the reconstructed attribute value of the first child node of the first collocated node and the reconstructed attribute value of the second child node of the second collocated node according to a first weighting coefficient for the reconstructed attribute value of the first child node of the first collocated node and a second weighting coefficient for the reconstructed attribute value of the second child node of the second collocated node, to obtain the attribute prediction value of the current node.

In some embodiments of the disclosure, the first weighting coefficient is equal to a first value, and the second weighting coefficient is equal to a second value.

In some embodiments of the disclosure, the first determining part 12 is configured to determine the first weighting coefficient according to an interval between a collection time of the current picture and a collection time of the first reference picture. Alternatively, the first determining part 12 is configured to determine the first weighting coefficient according to the geometry information of the current node and attribute distribution information of the first child node.

In some embodiments of the disclosure, the first determining part 12 is configured to determine the second weighting coefficient according to an interval between a collection time of the current picture and a collection time of the second reference picture. Alternatively, the first determining part 12 is configured to determine the second weighting coefficient according to the geometry information of the current node and attribute distribution information of the second child node.

In some embodiments of the disclosure, the decoding part 10 is further configured to parse the bitstream to obtain the first weighting coefficient and the second weighting coefficient.

In some embodiments of the disclosure, the decoding part 10 is further configured to parse the bitstream to obtain a first weighting coefficient index and a second weighting coefficient index. The first determining part 12 is configured to determine the first weighting coefficient and the second weighting coefficient from a coefficient list based on the first weighting coefficient index and the second weighting coefficient index.

In some embodiments of the disclosure, the attribute prediction value of the current node is a prediction value of an AC coefficient of the current node. The decoding part 10 is further configured to parse the bitstream to obtain a residual value of the AC coefficient of the current node. The first determining part 12 is configured to determine a reconstructed value of the AC coefficient of the current node according to the residual value of the AC coefficient and the prediction value of the AC coefficient of the current node. The first prediction part 11 is further configured to perform inverse independent orthogonal transform on the reconstructed value of the AC coefficient of the current node, to obtain a reconstructed attribute value of the current node.

In some embodiments of the disclosure, the first prediction part 11 is further configured to, when the third collocated node is present in the third reference picture, determine the attribute prediction value of the current node according to a reconstructed attribute value of a third child node of the third collocated node. Alternatively, the first prediction part 11 is further configured to, when the third collocated node is absent in the third reference picture, determine the attribute prediction value of the current node according to a reconstructed attribute value of at least one neighbourhood node of the current node in the current picture.

The descriptions of the decoder embodiments are similar to the descriptions of the encoding/decoding method embodiments, and the decoder embodiments have similar beneficial effects as the encoding/decoding method embodiments. For technical details not disclosed in the decoder embodiments of the disclosure, reference may be made to the descriptions of the encoding/decoding method embodiments of the disclosure.

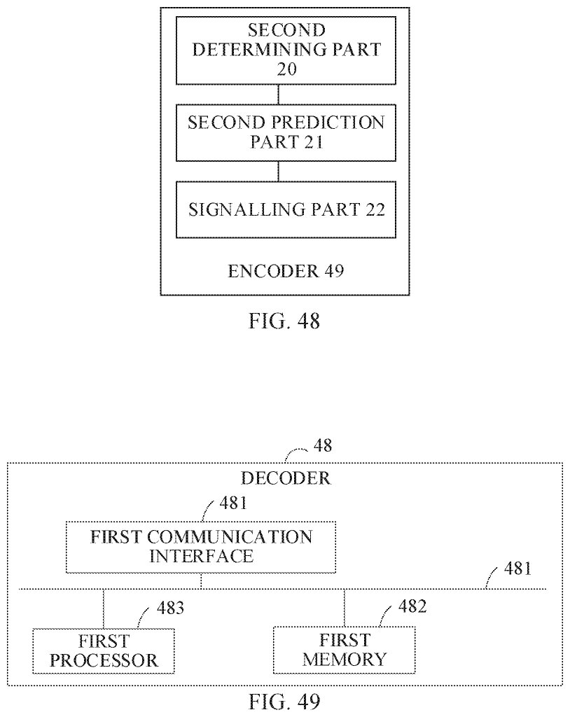

An encoder is provided in embodiments of the disclosure. FIG. 48 is a schematic structural diagram of an encoder according to embodiments of the disclosure. As illustrated in FIG. 48, an encoder 49 includes a second determining part 20 and a second prediction part 21. The second determining part 20 is configured to determine at least one reference list based on index information of encoded pictures, and perform pre-estimation based on the at least one reference list to determine a type of a current encoding unit in a current picture, and indicate the type of the current encoding unit by first syntax element information. The second prediction part 21 is configured to perform prediction on a current node based on the type of the current encoding unit, to obtain an attribute prediction value of the current node.

In some embodiments of the disclosure, the second prediction part 21 is further configured to perform pre-estimation on the current encoding unit by using two different reference lists selected from the at least one reference list, to determine a first rate-distortion cost with the minimum rate-distortion cost, and perform pre-estimation on the current encoding unit by using one different reference list selected from the at least one reference list, to determine a second rate-distortion cost with the minimum rate-distortion cost. The second prediction part 21 is further configured to perform pre-estimation on the current encoding unit by using intra prediction, to determine a third rate-distortion cost. The second prediction part 21 is further configured to determine the type of the current encoding unit according to the first rate-distortion cost, the second rate-distortion cost, and the third rate-distortion cost.

In some embodiments of the disclosure, the second prediction part 21 is further configured to, when the minimum one among the first rate-distortion cost, the second rate-distortion cost, and the third rate-distortion cost is the first rate-distortion cost, determine that the type of the current encoding unit is a first type. The second prediction part 21 is further configured to, when the minimum one among the first rate-distortion cost, the second rate-distortion cost, and the third rate-distortion cost is the second rate-distortion cost, determine that the type of the current encoding unit is a second type. The second prediction part 21 is further configured to, when the minimum one among the first rate-distortion cost, the second rate-distortion cost, and the third rate-distortion cost is the third rate-distortion cost, determine that the type of the current encoding unit is a third type.

In some embodiments of the disclosure, the second prediction part 21 is further configured to, when the type of the current encoding unit is the first type, determine a first reference picture and a second reference picture for the current encoding unit based on two reference lists of the at least one reference list. The second prediction part 21 is further configured to search for, according to obtained geometry information of the current node, a first collocated node of a parent node of the current node in the first reference picture and a second collocated node of the parent node of the current node in the second reference picture. The second prediction part 21 is further configured to perform inter attribute prediction on the current node according to the first collocated node and the second collocated node, to obtain the attribute prediction value of the current node.

In some embodiments of the disclosure, the second prediction part 21 is further configured to, when the type of the current encoding unit is the second type, determine a third reference picture for the current encoding unit based on one reference list of the at least one reference list. The second prediction part 21 is further configured to search for a third collocated node of a parent node of the current node in the third reference picture according to obtained geometry information of the current node. The second prediction part 21 is further configured to perform inter attribute prediction on the current node according to the third collocated node, to obtain the attribute prediction value of the current node.

In some embodiments of the disclosure, the second prediction part 21 is further configured to, when the type of the current encoding unit is the third type, determine the attribute prediction value of the current node according to a reconstructed attribute value of at least one neighbourhood node of the current node in the current picture.

In some embodiments of the disclosure, the encoder 49 further includes a signalling part 22. The signalling part 22 is configured to signal two reference index information corresponding to a first reference picture and a second reference picture into a bitstream. Alternatively, the signalling part 22 is configured to signal one reference index information corresponding to the third reference picture into the bitstream. The reference index information includes reference list index information or reference picture index information.

In some embodiments of the disclosure, the type of the current encoding unit is the third type, indicating that the current encoding unit has no reference index information, the type of the current encoding unit is the second type, indicating that the current encoding unit has at most one reference index information, and the type of the current encoding unit is the first type, indicating that the current encoding unit has at most two reference index information.

In some embodiments of the disclosure, the encoder 49 further includes a signalling part 22. The second determining part 20 is further configured to determine a current picture index of the current picture. The signalling part 22 is configured to indicate the current picture index by second syntax element information, and signal the second syntax element information into the bitstream by carrying the second syntax element information in a syntax layer of the current encoding unit.

In some embodiments of the disclosure, the second determining part 20 is further configured to determine at least one first reference list based on index information of encoded pictures, where the at least one first reference list indicates a mapping relationship from reference picture indices to storage positions.

In some embodiments of the disclosure, the at least one first reference list includes two first reference lists. The second prediction part 21 is further configured to determine a first reference picture index and a second reference picture index from the two first reference lists. The second prediction part 21 is further configured to determine the first reference picture and the second reference picture based on the first reference picture index and the second reference picture index, respectively.

In some embodiments of the disclosure, the at least one first reference list includes one first reference list. The second prediction part 21 is further configured to determine a third reference picture index from the one first reference list. The second prediction part 21 is further configured to determine the third reference picture based on the third reference picture index.

In some embodiments of the disclosure, the second determining part 20 is further configured to determine at least one second reference list based on index information of encoded pictures, where the at least one second reference list indicates a mapping relationship from reference pictures to storage positions.

In some embodiments of the disclosure, the at least one second reference list includes two second reference lists. The second prediction part 21 is further configured to determine the first reference picture and the second reference picture from the two second reference lists, respectively.

In some embodiments of the disclosure, the at least one second reference list includes one second reference list. The second prediction part 21 is further configured to determine the third reference picture from the one second reference list.

In some embodiments of the disclosure, the encoding unit is any one of a picture level, a tile level, a slice level, or an RAHT encoding layer level.

In some embodiments of the disclosure, the second prediction part 21 is further configured to, when the first collocated node is present in the first reference picture and the second collocated node is present in the second reference picture, determine the attribute prediction value of the current node according to a reconstructed attribute value of a first child node of the first collocated node and a reconstructed attribute value of a second child node of the second collocated node.

In some embodiments of the disclosure, the second prediction part 21 is further configured to, when the first collocated node is present in the first reference picture and the second collocated node is present in the second reference picture, determine a first difference number of occupied child nodes between the first collocated node and the parent node of the current node according to occupancy information of the first collocated node and occupancy information of the parent node of the current node, and determine a second difference number of occupied child nodes between the second collocated node and the parent node of the current node according to occupancy information of the second collocated node and the occupancy information of the parent node of the current node. The second prediction part 21 is further configured to determine a first weighting coefficient for a reconstructed attribute value of a first child node of the first collocated node and a second weighting coefficient for a reconstructed attribute value of a second child node of the second collocated node according to a relationship between the first difference number and the second difference number. The second prediction part 21 is further configured to weight the reconstructed attribute value of the first child node of the first collocated node and the reconstructed attribute value of the second child node of the second collocated node by using the first weighting coefficient and the second weighting coefficient, to determine the attribute prediction value of the current node.

In some embodiments of the disclosure, the second prediction part 21 is further configured to, when the first difference number is equal to the second difference number, determine that the first weighting coefficient is equal to the second weighting coefficient.

In some embodiments of the disclosure, the second prediction part 21 is further configured to, when the first difference number is less than the second difference number, determine that the first weighting coefficient is greater than the second weighting coefficient.

In some embodiments of the disclosure, the second prediction part 21 is further configured to, when the first difference number is greater than the second difference number, determine that the first weighting coefficient is less than the second weighting coefficient.

In some embodiments of the disclosure, the second prediction part 21 is further configured to, when the first collocated node is absent in the first reference picture and the second collocated node is present in the second reference picture, determine the attribute prediction value of the current node according to a reconstructed attribute value of a second child node of the second collocated node.

In some embodiments of the disclosure, the second prediction part 21 is further configured to operate as follows. When the first collocated node is absent in the first reference picture and the second collocated node is present in the second reference picture, the attribute prediction value of the current node is equal to the reconstructed attribute value of the second child node of the second collocated node.

In some embodiments of the disclosure, the second prediction part 21 is further configured to, when the first collocated node is present in the first reference picture and the second collocated node is absent in the second reference picture, determine the attribute prediction value of the current node according to a reconstructed attribute value of a first child node of the first collocated node.

In some embodiments of the disclosure, the second prediction part 21 is further configured to operate as follows. When the first collocated node is present in the first reference picture and the second collocated node is absent in the second reference picture, the attribute prediction value of the current node is equal to the reconstructed attribute value of the first child node of the first collocated node.

In some embodiments of the disclosure, the second prediction part 21 is further configured to, when the first collocated node is absent in the first reference picture and the second collocated node is absent in the second reference picture, determine the attribute prediction value of the current node according to a reconstructed attribute value of at least one neighbourhood node of the current node in the current picture.

In some embodiments of the disclosure, the second prediction part 21 is further configured to weight the reconstructed attribute value of the first child node of the first collocated node and the reconstructed attribute value of the second child node of the second collocated node according to a first weighting coefficient for the reconstructed attribute value of the first child node of the first collocated node and a second weighting coefficient for the reconstructed attribute value of the second child node of the second collocated node, to obtain the attribute prediction value of the current node.

In some embodiments of the disclosure, the first weighting coefficient is equal to a first value, and the second weighting coefficient is equal to a second value.

In some embodiments of the disclosure, the second determining part 20 is further configured to determine the first weighting coefficient according to an interval between a collection time of the current picture and a collection time of the first reference picture. Alternatively, the second determining part 20 is further configured to determine the first weighting coefficient according to the geometry information of the current node and attribute distribution information of the first child node.

In some embodiments of the disclosure, the second determining part 20 is further configured to determine the second weighting coefficient according to an interval between a collection time of the current picture and a collection time of the second reference picture. Alternatively, the second determining part 20 is further configured to determine the second weighting coefficient according to the geometry information of the current node and attribute distribution information of the second child node.

In some embodiments of the disclosure, the second determining part 20 is further configured to determine rate-distortion costs of multiple candidate weighting coefficient groups from a coefficient list, where each of the multiple candidate weighting coefficient groups contains a first candidate weighting coefficient for a reconstructed attribute value of the first collocated node and a second candidate weighting coefficient for a reconstructed attribute value of the second collocated node. The second determining part 20 is further configured to select a candidate weighting coefficient group with the minimum rate-distortion cost from the multiple candidate weighting coefficient groups. The second determining part 20 is further configured to determine a first candidate weighting coefficient in the candidate weighting coefficient group with the minimum rate-distortion cost as the first weighting coefficient, and determine a second candidate weighting coefficient in the candidate weighting coefficient group with the minimum rate-distortion cost as the second weighting coefficient.

In some embodiments of the disclosure, the encoder 49 further includes a signalling part 22. The signalling part 22 is configured to signal the first weighting coefficient and the second weighting coefficient into the bitstream. Alternatively, the signalling part 22 is configured to signal a first weighting coefficient index of the first weighting coefficient and a second weighting coefficient index of the second weighting coefficient into the bitstream.

In some embodiments of the disclosure, the attribute prediction value of the current node is a prediction value of an AC coefficient of the current node. The encoder 49 further includes a signalling part 22. The second determining part 20 is further configured to determine an original value of the AC coefficient of the current node, and determine a residual value of the AC coefficient of the current node according to the prediction value of the AC coefficient and the original value of the AC coefficient. The signalling part 22 is configured to signal a quantized residual value of the AC coefficient into the bitstream.

In some embodiments of the disclosure, the second prediction part 21 is further configured to, when the third collocated node is present in the third reference picture, determine the attribute prediction value of the current node according to a reconstructed attribute value of a third child node of the third collocated node. Alternatively, the second prediction part 21 is further configured to, when the third collocated node is absent in the third reference picture, determine the attribute prediction value of the current node according to a reconstructed attribute value of at least one neighbourhood node of the current node in the current picture.

In some embodiments of the disclosure, the encoder 49 further includes a signalling part 22. The signalling part 22 is configured to signal the first syntax element information into the bitstream.

The descriptions of the encoder embodiments are similar to the descriptions of the encoding method embodiments, and the encoder embodiments have a similar beneficial effect to the encoding method embodiments. For technical details not described in the encoder embodiments of the disclosure, reference may be made to the descriptions of the encoding method embodiments of the disclosure.

It may be noted that, in the encoder/decoder in embodiments of the disclosure, division of the modules is only schematic and is only logic function division, and other division manners may be adopted during practical implementation. In addition, functional units in various embodiments of the disclosure may be integrated into a processing unit, or each of the units may be physically separated, or two or more units may be integrated into a unit. The above integrated unit may be implemented in the form of not only a hardware but also a software functional unit. The above integrated unit may also be implemented in the form of a combination of the software and the hardware.

It may be noted that, in embodiments of the disclosure, if the methods are implemented in the form of a software functional module and sold or used as an independent product, they may also be stored in a computer-readable storage medium. Based on such an understanding, the technical solutions according to embodiments of the disclosure in essence or the part contributing to the related art can be embodied in the form of a software product, and the computer software product is stored in a storage medium, which includes several instructions such that an electronic device implements all or part of the method according to respective embodiments of the disclosure. The storage medium includes various media capable of storing a program code, such as a USB disk, a mobile hard drive disk, a Read-Only Memory (ROM), a magnetic disk, or an optical disk. In this way, embodiments of the disclosure are not limited to any specific combinations of hardware and software.

A computer-readable storage medium is provided in embodiments of the disclosure. The computer-readable storage medium configured to store a computer program which, when executed by a first processor, implements the decoding method embodiments of the disclosure, or when executed by a second processor, implements the encoding method in embodiments of the disclosure.

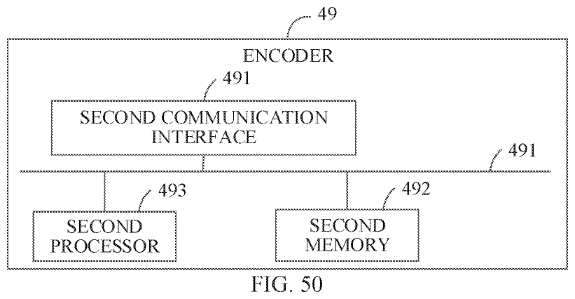

A decoder is provided in embodiments of the disclosure. As illustrated in FIG. 49, the decoder 48 includes a first communication interface 481, a first memory 482, and a first processor 483. The various components are coupled together via a first bus system 484. It may be understood that, the first bus system 484 is configured to enable connection and communication between these components. The first bus system 484 includes a power bus, a control bus, and a status signal bus in addition to a data bus. For the sake of clarity, however, the various buses are labelled as first bus system 484 in FIG. 49. The first communication interface 481 is configured to receive and transmit signals during information transmission and reception with other external network elements. The first memory 482 is configured to store a computer program executable by the first processor 483. The first processor 483 is configured to perform the encoding method in embodiments of the disclosure when executing the computer program.

It will be appreciated that the first memory 482 in embodiments of the disclosure may be a transitory memory or non-transitory memory, or may include both transitory and non-transitory memory. In particular, the non-transitory memory may be an ROM, a programmable ROM (PROM), an erasable PROM (EPROM), an electrically EPROM (EEPROM), or a flash memory. The transitory memory may be an RAM, which is used as an external cache. By way of illustration, but not limitation, many forms of RAM are available, such as a static RAM (SRAM), a dynamic RAM (DRAM), a synchronous DRAM (SDRAM), a double data rate synchronous random access memory (DDRSDRAM), an enhanced SDRAM (ESDRAM), a synchlink DRAM (SLDRAM), and a direct Rambus RAM (DRRAM). The first memory 482 of the system and method described in this disclosure is intended to include, but is not limited to, these and any other suitable types of memory.

The first processor 483 may be an integrated circuit chip with signal processing capabilities. During implementation, the operations in the above method may be accomplished by integrated logic circuitry in the hardware of the first processor 483 or by instructions in the form of software. The first processor 483 described above may be a general-purpose processor, a digital signal processor (DSP), an application-specific integrated circuit (ASIC), a field programmable gate array (FPGA), or other programmable logic device, discrete gate or transistor logic device, or discrete hardware component. The various methods, steps, and logic block diagrams disclosed in embodiments of the disclosure may be implemented or performed. The general-purpose processor may be a microprocessor, or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers, and other storage media mature in the art. The storage medium is located in the first memory 482, and the first processor 483 reads the information in the first memory 482 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASICs, DSPs, DSP devices (DSPD), programmable logic devices (PLD), an FPGA, a general-purpose processor, controller, microcontroller, microprocessor, or other electronic units for performing the functions described in this disclosure, or a combination thereof. For software implementations, the technology described in this disclosure may be implemented by means of modules (e.g., procedures, functions, etc.) that perform the functions described in this disclosure. The software code may be stored in a memory and executed by a processor. The memory may be implemented in the processor or outside the processor.

Optionally, as another embodiment, the first processor 483 is further configured to perform any encoding method described above when executing the computer program.

An encoder is provided in embodiments of the disclosure. As illustrated in FIG. 50, the encoder 49 includes a second communication interface 491, a second memory 492, and a second processor 493. The various components are coupled together via a second bus system 494. It may be understood that, the second bus system 494 is configured to enable connection and communication between these components. The second bus system 494 includes a power bus, a control bus, and a status signal bus in addition to a data bus. For the sake of clarity, however, the various buses are labelled as second bus system 494 in FIG. 50. The second communication interface 491 is configured to receive and transmit signals during information transmission and reception with other external network elements. The second memory 492 is configured to store a computer program executable by the second processor 493. The second processor 493 is configured to perform the encoding method in embodiments of the disclosure when executing the computer program.

It can be understood that, the second memory 492 has similar hardware functions to the first memory 482, and the second processor 493 has similar hardware functions to the first processor 483, which are not repeated herein.

A bitstream is further provided in embodiments of the disclosure. The bitstream is obtained according to the encoding method. The bitstream is generated by performing bit encoding on information to be encoded, where the information to be encoded at least includes: first syntax element information, second syntax element information, a current picture index, reference index information, a first weighting coefficient, a second weighting coefficient, a first weighting coefficient index, a second weighting coefficient index, and a quantized residual value of an alternating current (AC) coefficient.

An electronic device is provided in embodiments of the disclosure. The electronic device includes a processor and a computer-readable storage medium. The processor is adapted to execute a computer program. The computer-readable storage medium is configured to store the computer program which, when executed by the processor, implements the encoding method and/or the decoding method in embodiments of the disclosure. The electronic device may be various types of devices with video encoding and/or video decoding capabilities. For example, the electronic device is a mobile phone, a tablet computer, a laptop computer, a personal computer, a television, a projection device, or a monitoring device, etc.

It is to be noted that, the description of the storage medium and device embodiments is similar to the description of the method embodiments, and the storage medium and device embodiments have a similar beneficial effect as the method embodiments. For technical details not described in the storage medium and device embodiments of the disclosure, reference may be made to the description of the method embodiments of the disclosure.

It can be understood that, references to “one embodiment” or “an embodiment” or “some embodiments” throughout the specification mean that particular features, structures, or characteristics related to embodiments are included in at least one embodiment of the disclosure. Thus, the words “in one embodiment” or “in an embodiment” or “in some embodiments” appearing throughout the specification do not necessarily refer to the same embodiment. Furthermore, these particular features, structures, or characteristics may be incorporated in one or more embodiments in any suitable manner. It can be understood that in various embodiments of the disclosure, the sequence number(s) of the above processes do not imply the sequence(s) of execution, and the sequence of execution of each process can be determined according to the functions and internal logic thereof, and cannot constitute any limitation on the implementation process of embodiments of the disclosure. The embodiment numbers of the disclosure are for the purpose of description only and do not represent the advantages or disadvantages of embodiments. The above description of the various embodiments tends to emphasize differences between the various embodiments, and the similarities thereof may be referred to each other, and will not be repeated herein for the sake of brevity.

The term “and/or” represents only an association relationship describing associated objects and represents that three relationships may exist. For example, object A and/or object B may represent three conditions: i.e., independent existence of object A, existence of both object A and object B, and independent existence of object B.

It is to be noted that, in the disclosure, the terms “include”, “comprise”, “contain” or any other variation thereof, are intended to cover a non-exclusive inclusion, such that a process, method, article, or device that includes a list of elements includes not only those elements but also other elements not expressly listed, or also includes elements inherent to such process, method, article, or device. Without more limitations, an element is defined by the statement “including a . . . ” that does not rule out the possibility that there are additional identical elements in a process, method, article, or apparatus that includes the element.

In several embodiments provided in the disclosure, it is to be understood that, the disclosed devices and method may be implemented in other modes. Embodiments described above are only schematic, and for example, division of the modules is only a logical function division, and other division manners may be adopted during practical implementation. For example, multiple modules or components may be combined or integrated into another system, or some characteristics may be neglected or not executed. In addition, the displayed or discussed mutual couplings or direct couplings or communication connections between the components may be implemented by using some interfaces. The indirect couplings or communication connections between the devices or modules may be implemented in electronic, mechanical, or other forms.

The modules described as separate components may be or may not be physically separated, and the components displayed as modules may be or may not be physical modules, and may be located in one place or may be distributed over multiple network units. Some or all of the modules may be selected according to actual needs to achieve the objectives of the solutions of embodiments of the disclosure.

In addition, all the functional modules in various embodiments of the disclosure may be integrated in one processing unit, or each module may be separately used as one unit, or two or more modules may be integrated in one unit. The above integrated modules may be implemented in the form of hardware or hardware plus software functional units.

A person of ordinary skill in the art may understand that all or part of the steps of the above method embodiments may be implemented by a program instructing related hardware, the above programs may be stored in a computer-readable storage medium, and when executed, the programs perform the operations of the above method embodiments. The above storage medium includes various media that may store program codes, such as a removable storage device, a ROM, a magnetic disk, or an optical disc. Alternatively, if an integrated module according to embodiments of the disclosure is implemented in the form of a software functional module and sold or used as an independent product, it may also be stored in a computer-readable storage medium. Based on such an understanding, the technical solutions according to embodiments of the disclosure in essence or the part contributing to the related art can be embodied in the form of a software product, and the computer software product is stored in a storage medium, which includes several instructions such that an electronic device implements all or part of the method according to respective embodiments of the disclosure. The storage medium includes various media capable of storing a program code, such as a mobile storage device, a ROM, a magnetic disk, or an optical disk.

The methods disclosed in the several method embodiments provided in this disclosure may be combined in any way to obtain new method embodiments without conflict. The features disclosed in the several product embodiments provided in this disclosure may be combined in any way to obtain new product embodiments without conflict. The features disclosed in several methods or apparatus embodiments provided in this disclosure may be combined in any way to obtain new method embodiments or apparatus embodiments without conflict.

The foregoing is only a specific implementation of the disclosure, but the scope of protection of the disclosure is not limited thereto, and any variation or substitution readily conceivable by any person skilled in the art within the technical scope disclosed in the disclosure shall be covered by the scope of protection of the disclosure. Accordingly, the scope of protection of this disclosure shall be governed by the scope of protection of the stated claims.

What is claimed is:

1. A decoding method, applied to a decoder and comprising:
parsing a bitstream to determine first syntax element information of a current decoding unit in a current picture, wherein the first syntax element information indicates a type of the current decoding unit, and reference information of reference pictures corresponding to different types of decoding units are different; and
performing prediction on a current node based on the type of the current decoding unit indicated by the first syntax element information, to obtain an attribute prediction value of the current node.

2. The method of claim 1, wherein performing prediction on the current node based on the type of the current decoding unit indicated by the first syntax element information, to obtain the attribute prediction value of the current node comprises:
when the type of the current decoding unit indicated by the first syntax element information is a first type, parsing and determining two reference index information of the current decoding unit;
determining a first reference picture and a second reference picture based on the two reference index information;
searching for, according to obtained geometry information of the current node, a first collocated node of a parent node of the current node in the first reference picture and a second collocated node of the parent node of the current node in the second reference picture; and
performing inter attribute prediction on the current node according to the first collocated node and the second collocated node, to obtain the attribute prediction value of the current node.

3. The method of claim 1, wherein performing prediction on the current node based on the type of the current decoding unit indicated by the first syntax element information, to obtain the attribute prediction value of the current node comprises:
when the type of the current decoding unit indicated by the first syntax element information is a second type, parsing and determining one reference index information of the current decoding unit;
determining a third reference picture based on the one reference index information;
searching for a third collocated node of a parent node of the current node in the third reference picture according to obtained geometry information of the current node; and
performing inter attribute prediction on the current node according to the third collocated node, to obtain the attribute prediction value of the current node.

4. The method of claim 1, wherein performing prediction on the current node based on the type of the current decoding unit indicated by the first syntax element information, to obtain the attribute prediction value of the current node comprises:
when the type of the current decoding unit indicated by the first syntax element information is a third type, determining the attribute prediction value of the current node according to a reconstructed attribute value of at least one neighbourhood node of the current node in the current picture.

5. The method of claim 1, wherein
the first syntax element information indicates a third type, indicating that the current decoding unit has no reference index information;
the first syntax element information indicates a second type, indicating that the current decoding unit has at most one reference index information; and
the first syntax element information indicates a first type, indicating that the current decoding unit has at most two reference index information.

6. The method of claim 2, further comprising:
determining at least one first reference list based on index information of decoded pictures, wherein the at least one first reference list indicates a mapping relationship from reference picture indices to storage positions.

7. The method of claim 6, wherein
the at least one first reference list comprises two first reference lists, and reference index information comprises reference list index information; and
determining the first reference picture and the second reference picture based on the two reference index information comprises:
determining a first reference picture index and a second reference picture index from the two first reference lists according to respective reference list index information; and
determining the first reference picture and the second reference picture based on the first reference picture index and the second reference picture index, respectively.

8. The method of claim 6, wherein
the at least one first reference list comprises one first reference list, and reference index information comprises reference list index information; and
determining the third reference picture based on the one reference index information comprises:
determining a third reference picture index from the one first reference list according to one reference list index information; and
determining the third reference picture based on the third reference picture index.

9. The method of claim 2, wherein performing inter attribute prediction on the current node according to the first collocated node and the second collocated node, to obtain the attribute prediction value of the current node comprises:
when the first collocated node is present in the first reference picture and the second collocated node is present in the second reference picture, determining the attribute prediction value of the current node according to a reconstructed attribute value of a first child node of the first collocated node and a reconstructed attribute value of a second child node of the second collocated node.

10. The method of claim 2, wherein performing inter attribute prediction on the current node according to the first collocated node and the second collocated node, to obtain the attribute prediction value of the current node comprises:
when the first collocated node is present in the first reference picture and the second collocated node is present in the second reference picture,
determining a first difference number of occupied child nodes between the first collocated node and the parent node of the current node according to occupancy information of the first collocated node and occupancy information of the parent node of the current node; and
determining a second difference number of occupied child nodes between the second collocated node and the parent node of the current node according to occupancy information of the second collocated node and the occupancy information of the parent node of the current node;
determining a first weighting coefficient for a reconstructed attribute value of a first child node of the first collocated node and a second weighting coefficient for a reconstructed attribute value of a second child node of the second collocated node according to a relationship between the first difference number and the second difference number; and
weighting the reconstructed attribute value of the first child node of the first collocated node and the reconstructed attribute value of the second child node of the second collocated node by using the first weighting coefficient and the second weighting coefficient, to determine the attribute prediction value of the current node.

11. The method of claim 2, wherein performing inter attribute prediction on the current node according to the first collocated node and the second collocated node, to obtain the attribute prediction value of the current node comprises:
when the first collocated node is absent in the first reference picture and the second collocated node is present in the second reference picture, determining the attribute prediction value of the current node according to a reconstructed attribute value of a second child node of the second collocated node.

12. The method of claim 11, wherein when the first collocated node is absent in the first reference picture and the second collocated node is present in the second reference picture, determining the attribute prediction value of the current node according to the reconstructed attribute value of the second child node of the second collocated node comprises:
when the first collocated node is absent in the first reference picture and the second collocated node is present in the second reference picture, the attribute prediction value of the current node is equal to the reconstructed attribute value of the second child node of the second collocated node.

13. The method of claim 2, wherein performing inter attribute prediction on the current node according to the first collocated node and the second collocated node, to obtain the attribute prediction value of the current node comprises:
when the first collocated node is present in the first reference picture and the second collocated node is absent in the second reference picture, determining the attribute prediction value of the current node according to a reconstructed attribute value of a first child node of the first collocated node.

14. The method of claim 13, wherein when the first collocated node is present in the first reference picture and the second collocated node is absent in the second reference picture, determining the attribute prediction value of the current node according to the reconstructed attribute value of the first child node of the first collocated node comprises:
when the first collocated node is present in the first reference picture and the second collocated node is absent in the second reference picture, the attribute prediction value of the current node is equal to the reconstructed attribute value of the first child node of the first collocated node.

15. The method of claim 2, wherein performing inter attribute prediction on the current node according to the first collocated node and the second collocated node, to obtain the attribute prediction value of the current node comprises:
when the first collocated node is absent in the first reference picture and the second collocated node is absent in the second reference picture, determining the attribute prediction value of the current node according to a reconstructed attribute value of at least one neighbourhood node of the current node in the current picture.

16. The method of claim 9, wherein determining the attribute prediction value of the current node according to the reconstructed attribute value of the first child node of the first collocated node and the reconstructed attribute value of the second child node of the second collocated node comprises:
weighting the reconstructed attribute value of the first child node of the first collocated node and the reconstructed attribute value of the second child node of the second collocated node according to a first weighting coefficient for the reconstructed attribute value of the first child node of the first collocated node and a second weighting coefficient for the reconstructed attribute value of the second child node of the second collocated node, to obtain the attribute prediction value of the current node.

17. The method of claim 3, wherein performing inter attribute prediction on the current node according to the third collocated node, to obtain the attribute prediction value of the current node comprises:
when the third collocated node is present in the third reference picture, determining the attribute prediction value of the current node according to a reconstructed attribute value of a third child node of the third collocated node; or
when the third collocated node is absent in the third reference picture, determining the attribute prediction value of the current node according to a reconstructed attribute value of at least one neighbourhood node of the current node in the current picture.

18. An encoding method, applied to an encoder and comprising:
determining at least one reference list based on index information of encoded pictures;
performing pre-estimation based on the at least one reference list to determine a type of a current encoding unit in a current picture, and indicating the type of the current encoding unit by first syntax element information; and
performing prediction on a current node based on the type of the current encoding unit, to obtain an attribute prediction value of the current node.

19. A decoder, comprising:
a memory configured to store a computer program; and
a processor configured to execute the computer program to cause the decoder to:
parse a bitstream to determine first syntax element information of a current decoding unit in a current picture, wherein the first syntax element information indicates a type of the current decoding unit, and reference information of reference pictures corresponding to different types of decoding units are different; and
perform prediction on a current node based on the type of the current decoding unit indicated by the first syntax element information, to obtain an attribute prediction value of the current node.

20. A non-transitory computer-readable storage medium storing a computer program and a bitstream, wherein when executed by a processor, the computer program causes the processor to perform the method of claim 18 to generated the bitstream.
